(19) United States
(12) Patent Application Publication
(10) Pub. No.: US 2026/0303678 A1
(43) Pub. Date: Oct. 1, 2026

(54) SYSTEMS AND METHODS FOR MINIMAL VIDEO IMPACT RECEIVER NETWORK SWITCHING DURING ULTRA-LOW LATENCY CLOUD STREAMING

(71) Applicant: Adeia Guides Inc., San Jose, CA (US)

(72) Inventors: Christopher Phillips, Hartwell, GA (US); Tao Chen, Palo Alto, CA (US)

(21) Appl. No.: 19/092,970

(22) Filed: Mar. 27, 2025

(51) Int. Cl. H04L 65/752; H04L 65/65; H04L 65/80

(52) U.S. Cl. CPC H04L 65/752; H04L 65/65; H04L 65/80

(57) ABSTRACT

Systems and methods are described herein for a receiver device transitioning between networks during ultra-low latency streaming with minimal user experience impact. Such systems and methods avoid dropping packets of streamed content and do not require expensive and time-consuming retransmission techniques or instantaneous decoder refresh repair. The disclosed techniques may receive packets of a content stream via a first network and first receiver instance. The disclosed techniques may additionally identify an indication to switch to a second network and receive packets of the content streams via both a first network and a second network. The disclosed techniques may further identify that the received packets across both the first network and the second network are synchronized, terminate execution of the first receiver instance, and continue to receive packets of the content stream via only the second network.

### BACKGROUND

This disclosure is related to systems and methods for streaming and receiving ultra-low latency content. In particular, the disclosure relates, in part, to switching between networks over which ultra-low latency content may be delivered.

### SUMMARY

Technological advancements in audiovisual content delivery have enabled the delivery of ultra-low latency content operating with minimal to no buffer at the content receiver. In some examples, ultra-low latency content delivery techniques are applied to downlink transmission from a cloud service to a client device for interactive remote rendering in cloud gaming, augmented reality (AR) and virtual reality (VR) remote rendering, video meeting remote rendering in video conferencing, or remote control downlink for remote control of a vehicle. In some examples, ultra-low latency content delivery techniques are applied to uplink transmission from a client device to a cloud service for extended reality (XR) simultaneous localization and mapping (SLAM) and remote rendered interactivity, robotics SLAM, encoded video participant uplink in video conferencing, or audiovisual encoding uplink for remote control of a vehicle. However, the minimal buffer or lack thereof of such ultra-low latency content delivery techniques creates challenges for accurate bitrate estimation during scene changes and rapid picture-to-picture changes within the content being delivered.

Moreover, such ultra-low latency content delivery techniques are highly sensitive to network conditions, particularly network bandwidth, congestion, jitter, and packet loss. In some examples, it is desirable for a sender device to switch from delivering the ultra-low latency content over a first network to delivering the same ultra-low latency content over a second network with better network conditions. In such examples, during the process of switching networks, one or more packets of the content may be delayed or dropped. Upon detection of a dropped packet, the receiver device may request retransmission of the dropped packet. In high latency environments, a large buffer enables the receiver device to provide the content to the user without significant interruption. However, in ultra-low latency environments, the minimal buffer or lack thereof results in the transmission of a retransmission request and receipt of the retransmitted packet causing significant interruptions in the content being provided to the user. Moreover, in some examples, the dropped packet includes a frame (e.g., intra-coded frame (I-frame) or predicted frame (P-frame)) to which one or more future frames (e.g., P-frames) depend. Dropping such packets results in the receiver device losing the reference for proper decoding of the one or more future frames. For example, dropping a packet (e.g., corresponding to an I-frame) results in the receiver device being unable to decode future frames (e.g., P-frames depending on the I-frame). In such examples, recovery of the content delivery may not be achieved simply through retransmission of the dropped packet. In some examples, recovering from the dropped packet relies upon generation of expensive instantaneous decoder refresh (IDR) frames to repair the content being delivered. In some examples, generating the IDR frame results in a frame that is too large to be sent in time to a receiver device, resulting in the inability to decode future frames.

Accordingly, approaches to maintaining UX quality of ultra-low latency content during scene changes and packet loss scenarios include independently encoding tiles and/or slices or constraining motion within the slices and/or tiles to compensate for scene changes. Such approaches also include delivery of sets of tiles and/or slices over a period of frames to compensate for scene changes. Such approaches additionally include providing specialized repair of tiles and/or slices affected by packet loss to prevent irrecoverable scenarios. However, such approaches describe techniques for recovering from packet loss (e.g., and reduction of picture size during scene changes) and do not provide a solution for avoiding packet loss, particularly during transitions between networks. Approaches that avoid packet loss entirely are preferred over approaches for packet loss recovery that often introduce delays, disruptions, and increase processing overhead.

In some approaches, a sender device leverages feedback from the receiver device to determine an optimal time to switch content delivery between networks (e.g., from Wi-Fi to cellular, from cellular to Wi-Fi). Such approaches minimize the UX impact of network switching for transmission control protocol (TCP)/internet protocol (IP) delivered content. In one approach for over the top (OTT) adaptive bitrate streaming (ABR), segments of content are delivered over a network based on calculating bitrate based on an encoded bitrate, segment size, and segment download time. In this approach, the ABR receiver identifies a bandwidth change and gives up the current download to move to a lower bitrate download, relying on the contents of an ABR buffer to enable continuous delivery of the content to the user without interruptions or pauses. However, such approaches do not guarantee that packet loss will not occur for ultra-low latency streaming over true streaming protocols, including real-time transport protocol (RTP), and other streaming protocols built on top of RTP, including web real-time communications (WebRTC) and self-clocked rate adaptation for multimedia (SCReAM). In some examples of ultra-low latency content using RTP, WebRTC, and/or SCReAM, transitioning from a first network (e.g., Wi-Fi network) to a second network (e.g., cellular network) results in irrecoverable packet loss due to minimal transmission delay, insufficient time for retransmission, data time sensitivity, limited buffer size, loss of a reference frame (e.g., I-frame), and the like.

In other approaches, a QUIC (Quick UDP Internet Connections) protocol is leveraged to migrate between Wi-Fi and cellular networks through a stateless session transfer. In such approaches, multiple independent lanes (e.g., data streams acting as channels) of a user datagram protocol (UDP) connection replace a shared single TCP connection, enabling separate retransmission parameters and data retransmission along each lane of the UDP connection. Consequently, such approaches enable packet recovery for packet loss in a single lane of the UDP connection to occur simultaneously to packet delivery in the other lanes, minimizing slowing or blocking of content delivery during packet recovery. However, such approaches rely upon packet loss masking mechanisms in RTP and SCReAM that are based on packet retransmit requests (e.g., real-time transport control protocol (RTCP) retransmit requests). In ultra-low latency content delivery, packet retransmission is not feasible due to the minimal to no buffer present on the receiver device. An approach is desired to avoid packet loss during network migration rather than optimize or mask packet recovery in response to detected packet loss.

Accordingly, to help address such problems, example systems and methods are provided herein, wherein a receiver device switches from receiving content over a first network to receiving the same content over a second network with no or minimal packet loss to minimize the need for IDR frames. In some embodiments, the enclosed systems and methods switch the network over which the content is received with no packet loss and no IDR frames are generated. In some embodiments, the receiver device receives one or more packets of the content from a sender device, where the sender device is running a cloud service with an ultra-low latency video source. In some embodiments, the receiver device is running a client application intended to provide for display the content based on the one or more packets received from the ultra-low latency video source of the cloud service. For example, the receiver device may be associated with or correspond to any one of: hardware devices, software systems, virtual devices, application programming interfaces (APIs), software development kits (SDKs), cloud-based systems, or the like. Further, for example, the sender device may be associated with or correspond to any one of: hardware devices, software systems, virtual devices, application programming interfaces (APIs), software development kits (SDKs), cloud-based systems, or the like.

In some embodiments, the receiver device receives, from the sender device, a first one or more packets of a content stream by a first receiver instance executing on the receiver device for processing data (e.g., of a portion of the content stream) received via a first network of a first network type. For example, the first network type is a Wi-Fi network type and the first receiver instance is associated with a Wi-Fi driver and/or Wi-Fi modem of the receiver device. Further, for example, the first receiver instance includes a first UDP socket of the receiver device, a first transmission receiver, and a first packet buffer (e.g., with a size of one packet).

In some embodiments, the receiver device identifies an indication to attempt to switch from receiving the content stream via the first network to receiving the content stream via a second network of a second network type. In some embodiments, based at least in part on the identifying the indication, the receiver device instantiates a second receiver instance on the receiver device for processing data received via the second network. For example, the second network type is a cellular network type and the second receiver instance is associated with a cellular driver and/or cellular modem of the receiver device. Further, for example, the second receiver instance includes a second UDP socket of the receiver device, a second transmission receiver, and a second packet buffer (e.g., with a size of one packet). In some embodiments, identifying the indication to attempt to switch from receiving the content stream via the first network to receiving the content stream via the second network is based at least in part on at least one of the following: detecting that a transmission quality of the first network has decreased; identifying that a status of the first one or more packets indicates a late arrival; identifying one or more dropped packets of the content stream; analyzing at least one of jitter, bandwidth, or latency of the first one or more packets; combinations of the same; or the like.

In some embodiments, the receiver device receives from the sender device a second one or more packets of the content stream by the first receiver instance and a third one or more packets of the content stream by the second receiver instance. In some embodiments, the second one or more packets and the third one or more packets represent the same data of a portion of the content stream. In some embodiments, the sender device determines a first stream quality (e.g., bitrate, resolution, any suitable quantitative measure of quality, or any combination thereof) for transmission of the content stream to the receiver device via the first network and a second stream quality (e.g., bitrate, resolution, any suitable quantitative measure of quality, or any combination thereof) for transmission of the content stream to the receiver device via the second network. In some embodiments, the sender device transmits the second one or more packets of the content stream and the third one or more packets of the content stream in a lower of the first stream quality (e.g., bitrate, resolution, any suitable quantitative measure of quality, or any combination thereof) and the second stream quality (e.g., bitrate, resolution, any suitable quantitative measure of quality, or any combination thereof). In some embodiments, the sender device determines the second one or more packets and the third one or more packets by identifying one or more RTP packets of the content stream from a RTP packet priority queue, wrapping each of the one or more RTP packets in a first UDP wrapper to generate the second one or more packets, and/or wrapping each of the one or more RTP packets in a second UDP wrapper to generate the third one or more packets.

In some embodiments, the receiver device, based at least in part on determining that the second one or more packets received by the first receiver instance are synchronized with the third one or more packets received by the second receiver instance terminates execution of the first receiver instance on the receiver device. In some embodiments, the receiver device identifies that the second one or more packets have been received in the first packet buffer at a first time of arrival and that the third one or more packets have been received in the second packet buffer at a second time of arrival. In some embodiments, the sender device determines that the second one or more packets received by the first receiver instance are synchronized with the third one or more packets received by the second receiver instance based at least in part on analyzing both the first time of arrival and the second time of arrival. In some embodiments, the receiver device receives a fourth one or more packets of the content stream by the second receiver instance.

In some embodiments, the sender device performs at least one of the following: storing a first RTCP packet received via the first network in a first data store on the sender device; identifying a connection with the receiver device via the second network; based at least in part on identifying the connection, instantiating a second data store on the sender device; storing a second RTCP packet on the sender device; combinations of the same; or the like. For example, the sender device determines stream metadata, including quality, bitrate, bandwidth, or the like based on the stored RTCP packet. In some embodiments, the sender device identifies that the connection with the receiver device via the first network has been terminated (e.g., by the receiver device) and based at least in part on identifying that the connection has been terminated, terminates the first data store on the sender device. In some embodiments, the sender device encodes the data for the second one or more packets of the content stream and the third one or more packets of the content stream by resampling at least one of reference pictures of the content stream or non-reference pictures of the content stream.

In some embodiments, the second one or more packets and the third one or more packets comprise data encoded by an encoder associated with the sender device based on the data of the portion of the content stream, and the receiver device decodes either the second one or more packets or the third one or more packets via a decoder of the receiver device based at least in part on an order in which the second one or more packets and the third one or more packets were received by the receiver device. For example, the receiver device only decodes the third one or more packets based on the third one or more packets being received by the receiver device (e.g., and/or identified in the second packet buffer) prior to the second one or more packets being received by the receiver device (e.g., and/or identified in the first packet buffer). In some embodiments, the sender device transmits the second one or more packets of the content stream and the third one or more packets of the content stream by refraining from transmitting a first enhancement layer data for the portion of the content stream via the first network or refraining from transmitting a second enhancement layer data for the portion of the content stream via the second network.

Additionally, to help address such problems, example systems and methods are provided herein, wherein a sender device switches from delivering content over a first network to delivering the same content over a second network with minimal packet loss. In some embodiments, the sender device transmits one or more packets of the content from a sender device, where the sender device is running a client application with an ultra-low latency video source. In some embodiments, the receiver device is running a cloud service intending to receive the one or more packets from the ultra-low latency video source of the client application.

In some embodiments, the sender device transmits a first one or more packets of a content stream via a first connection to a first receiver instance executing on a receiver device for processing data received via a first network of a first network type. For example, the first network type is a Wi-Fi network type and the first one or more packets are sent using a Wi-Fi driver and/or Wi-Fi modem of the sender device. Moreover, for example, the first one or more packets are sent over a first UDP socket of the sender device that is associated with the Wi-Fi driver and/or Wi-Fi modem of the sender device. Further, for example, the first receiver instance includes a first UDP socket of the receiver device, a first transmission receiver, and a first packet buffer (e.g., with a size of one packet). In some embodiments, the sender device determines a first stream quality (e.g., bitrate, resolution, any suitable quantitative measure of quality, or any combination thereof) for transmission of the content stream to the receiver device via the first network based on one or more acknowledged packets (e.g., RTCP packets) for the first one or more packets of the content stream.

In some embodiments, the sender device determines to attempt to switch from transmitting the content stream via the first network to transmitting the content stream via the second network of a second network type. In some embodiments, the sender device transmits a connection request to the receiver device. For example, the connection request includes an identifier of the sender device on the second network. In some embodiments, the receiver device instantiates a second receiver instance on the receiver device for processing data received via the second network based at least in part on the connection request. In some embodiments, a second connection is established between the second receiver instance and the sender device via the second network based on the identifier. For example, the second network type is a cellular network type and the second one or more packets are sent using a cellular driver and/or cellular modem of the receiver device. Moreover, for example, the second one or more packets are sent over a second UDP socket of the sender device that is associated with the cellular driver and/or cellular modem of the sender device. Further, for example, the second receiver instance includes a second UDP socket of the receiver device, a second transmission receiver, and a second packet buffer (e.g., with a size of one packet). In some embodiments, determining to attempt to switch from transmitting the content stream via the first network to transmitting the content stream via the second network is based at least in part on at least one of the following: detecting that a transmission quality of the first network has decreased; identifying that a status of the first one or more packets indicates a late arrival; identifying one or more dropped packets of the content stream; analyzing at least one of jitter, bandwidth, or latency of the first one or more packets; combinations of the same; or the like.

In some embodiments, the sender device determines a second stream quality for transmission of the content stream to the receiver device via the second network. In some embodiments, the sender device transmits a second one or more packets of the content stream to the first receiver instance and a third one or more packets of the content stream to the second receiver instance. In some embodiments, the second one or more packets and the third one or more packets represent the same data of a portion of the content stream. In some embodiments, the sender device transmits the second one or more packets of the content stream and the third one or more packets of the content stream in a lower of the first stream quality (e.g., bitrate, resolution, any suitable quantitative measure of quality, or any combination thereof) and the second stream quality (e.g., bitrate, resolution, any suitable quantitative measure of quality, or any combination thereof). In some embodiments, the sender device determines the second one or more packets and the third one or more packets by identifying one or more RTP packets of the content stream from a RTP packet priority queue, wrapping each of the one or more RTP packets in a first UDP wrapper to generate the second one or more packets, and/or wrapping each of the one or more RTP packets in a second UDP wrapper to generate the third one or more packets. In some embodiments, the sender device transmits the second one or more packets via the first UDP port of the sender device (e.g., corresponding to the first UDP wrapper) and the third one or more packets via the second UDP port of the sender device (e.g., corresponding to the second UDP wrapper).

In some embodiments, the sender device, based at least in part on identifying an indication that the second one or more packets received by the first receiver instance are synchronized with the third one or more packets received by the second receiver instance terminates the first connection with the receiver device via the first network. In some embodiments, the receiver device terminates execution of the first receiver instance on the receiver device based on the first connection being terminated. In some embodiments, the sender device receives a first one or more RTCP packets from the receiver device associated with the first one or more packets and a second one or more RTCP packets from the receiver device comprising the indication that the second one or more packets received by the first receiver instance are synchronized with the third one or more packets received by the second receiver instance. In some embodiments, the sender device determines the first stream quality (e.g., bitrate, resolution, any suitable quantitative measure of quality, or any combination thereof) for transmission of the content stream to the receiver device via the first network based on analysis of the first one or more RTCP packets. In some embodiments, the sender device transmits a fourth one or more packets of the content stream to the second receiver instance.

In some embodiments, the sender device performs at least one of the following: storing a first RTCP packet received via the first network in a first data store on the sender device; identifying a connection with the receiver device via the second network; based at least in part on identifying the connection, instantiating a second data store on the sender device; storing a second RTCP packet on the sender device; combinations of the same; or the like. For example, the RTCP packet indicates stream metadata, including quality, bitrate, bandwidth, or the like. In some embodiments, the sender device identifies that the connection with the receiver device via the first network (e.g., the first connection) has been terminated (e.g., by the receiver device) and based at least in part on identifying that the connection has been terminated, terminates the first data store on the sender device. In some embodiments, the sender device encodes the data for the second one or more packets of the content stream and the third one or more packets of the content stream by resampling at least one of reference pictures of the content stream or non-reference pictures of the content stream.

In some embodiments, the second one or more packets and the third one or more packets comprise data encoded by an encoder associated with the sender device based on the data of the portion of the content stream, and the receiver device decodes either the second one or more packets or the third one or more packets via a decoder of the receiver device based at least in part on an order in which the second one or more packets and the third one or more packets were received by the receiver device. For example, the receiver device only decodes the third one or more packets based on the third one or more packets being received by the receiver device (e.g., and/or identified in the second packet buffer) prior to the second one or more packets being received by the receiver device (e.g., and/or identified in the first packet buffer). In some embodiments, the sender device transmits the second one or more packets of the content stream and the third one or more packets of the content stream by refraining from transmitting a first enhancement layer data for the portion of the content stream via the first network or refraining from transmitting a second enhancement layer data for the portion of the content stream via the second network.

In some embodiments, the sender device and/or the receiver device are dynamic roles. In some embodiments, the sender device is also a receiver device. For example, the ultra-low latency content delivery system is a videoconferencing system including a server device and client device. In one example, the server device is the sender device and the client device is the receiver device for content (e.g., video content of other users in a meeting) delivered by the videoconferencing service of the server to the videoconferencing client application of the client device. In this example, the server device may also be a receiver device and the client device may also be the sender device for content (e.g., video content of the user of the client device) delivered by the videoconferencing client application of the client device to the videoconferencing service of the server.

The example systems and methods described herein help to overcome the deficiencies in existing solutions. The systems and methods described herein provides for a dual transmission period, wherein packets for the same portion of content are delivered across both networks, ensuring that delivery of the packets is synchronized across both networks prior to terminating the connection with the first network and reducing the likelihood of packet loss during the network switching process. Such systems and methods also provide for the sender transmitting packets of the content in the lower of the stream bitrates for each network, further improving the reliability of packet delivery during the network switching process. Consequently, such systems and methods do not rely on packet retransmission for repairing content in response to packet loss as other approaches do and instead minimize the triggering of expensive and disruptive recovery methods like IDR frame-based (or IDR tile-based) video stream repair. The systems and methods described herein also provide for identification of scenarios in which to initiate the network switching, including based on network conditions and packet transmission/reception. The systems and methods described herein achieve robust ultra-low latency content delivery with minimal packet buffers and is compatible with RTP, WebRTC, and SCReAM streaming protocols.

### BRIEF DESCRIPTION OF DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic example of a receiver device performing network migration without packet loss, in accordance with embodiments of the disclosure;

FIG. 2 is a schematic example of a sender device performing network migration without packet loss, in accordance with embodiments of this disclosure;

FIG. 3A is a schematic example of an ultra-low latency content delivery system for 311 performing receiver-directed network migration with a Wi-Fi Management Application (WMA), in accordance with embodiments of the disclosure;

FIG. 3B is a schematic example of an ultra-low latency content delivery system for performing receiver-directed network migration without a Wi-Fi Management Application (WMA), in accordance with embodiments of the disclosure;

FIG. 4A is a schematic example of an ultra-low latency content delivery system for performing sender-directed network migration with a Wi-Fi Management Application (WMA), in accordance with embodiments of the disclosure;

FIG. 4B is a schematic example of an ultra-low latency content delivery system for performing sender-directed network migration without a Wi-Fi Management Application (WMA), in accordance with embodiments of the disclosure;

FIG. 5 is a flowchart of an illustrative process for managing multiple network connections with a client device, in accordance with some embodiments of this disclosure;

FIG. 6 is a flowchart of an illustrative process for starting up a Wi-Fi or mobile receiver instance upon startup of an ultra-low latency video session, in accordance with some embodiments of this disclosure;

FIG. 7 is a flowchart of illustrative processes for the packet sender and demultiplexer functions, in accordance with some embodiments of this disclosure;

FIG. 8 is a flowchart of illustrative processes for a connection manager working with a Wi-Fi management application, in accordance with some embodiments of this disclosure;

FIG. 9 is a flowchart of illustrative processes for a packet sender working without a Wi-Fi management application, in accordance with some embodiments of this disclosure;

FIG. 10 is a flowchart of illustrative processes for a connection manager determining a network switch based on multiple metrics, in accordance with some embodiments of this disclosure;

FIG. 11 is a flowchart of illustrative processes for startup and packet transmission for a dual network sender, in accordance with some embodiments of this disclosure;

FIG. 12 is a flowchart of illustrative processes of a dual network sender network congestion controller for addition and removal of connections, in accordance with some embodiments of this disclosure;

FIG. 13 is a flowchart of illustrative processes of a dual sender connection manage working with a Wi-Fi management application, in accordance with some embodiments of this disclosure;

FIG. 14 is a flowchart of illustrative processes for cloud ultra-low latency cloud dual network receiver connection, in accordance with some embodiments of this disclosure;

FIG. 15 is a flowchart of illustrative processes for a packet sender running in a cloud service, in accordance with some embodiments of this disclosure;

FIG. 16 is a flowchart of illustrative processes for cloud ultra-low latency dual network receiver disconnection, in accordance with some embodiments of this disclosure;

FIG. 17 is a flowchart of illustrative processes for a dual network sender connection manager operating with a Wi-Fi management application, in accordance with some embodiments of this disclosure;

FIG. 18 is a diagram of an illustrative ultra-low latency content delivery system, in accordance with some embodiments of this disclosure;

FIG. 19 is a schematic of an example computing device of the ultra-low latency content delivery system, in accordance with some embodiments of this disclosure;

FIG. 20 is a flowchart of a detailed illustrative process for receiver-directed network switching with minimal packet loss, in accordance with some embodiments of this disclosure;

FIG. 21 is a flowchart of a detailed illustrative process for sender-directed network switching with minimal packet loss, in accordance with some embodiments of this disclosure; and

FIG. 22 is a schematic example of using scalable encoding to accommodate transitions between networks, in accordance with some embodiments of this disclosure.

### DETAILED DESCRIPTION

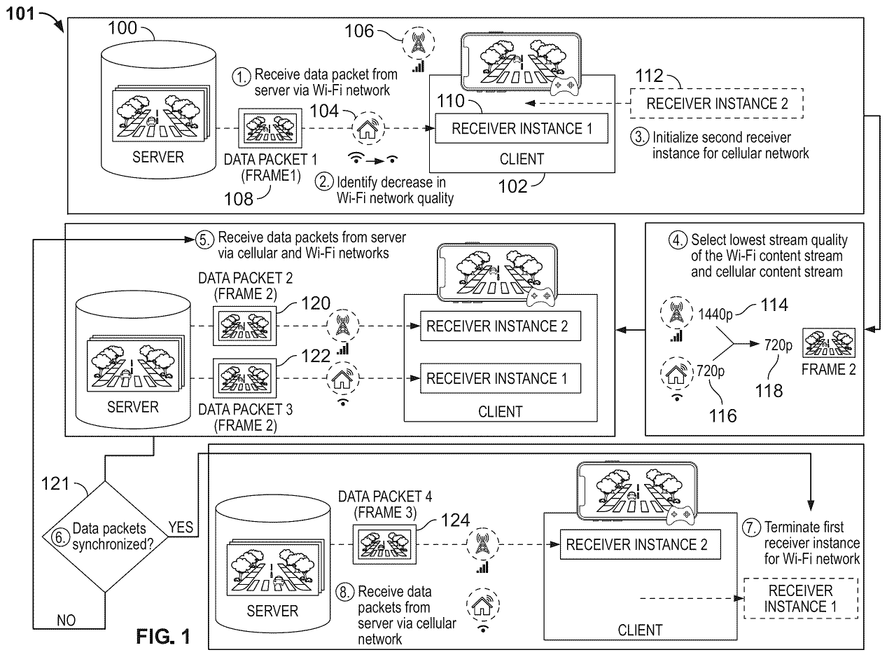

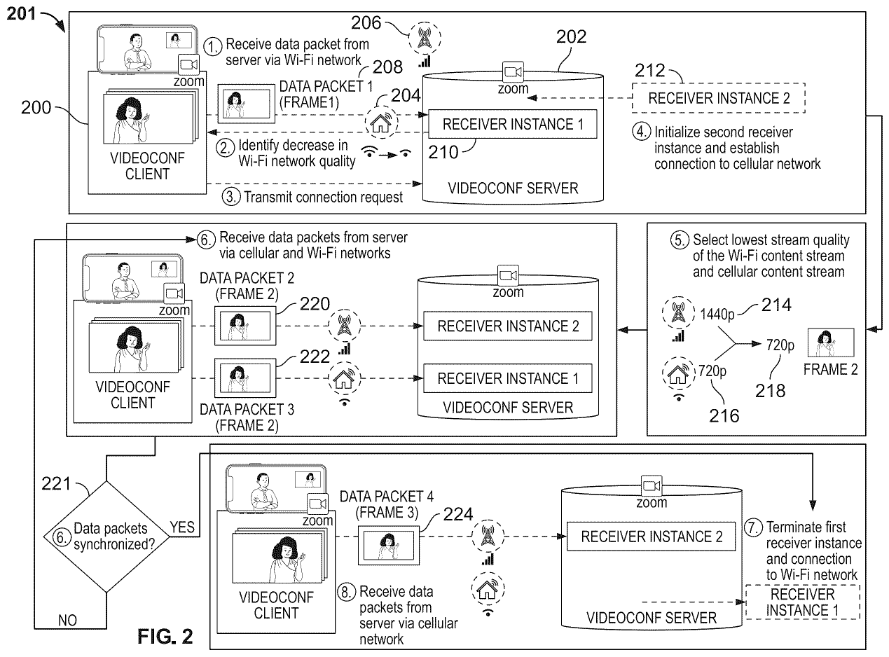

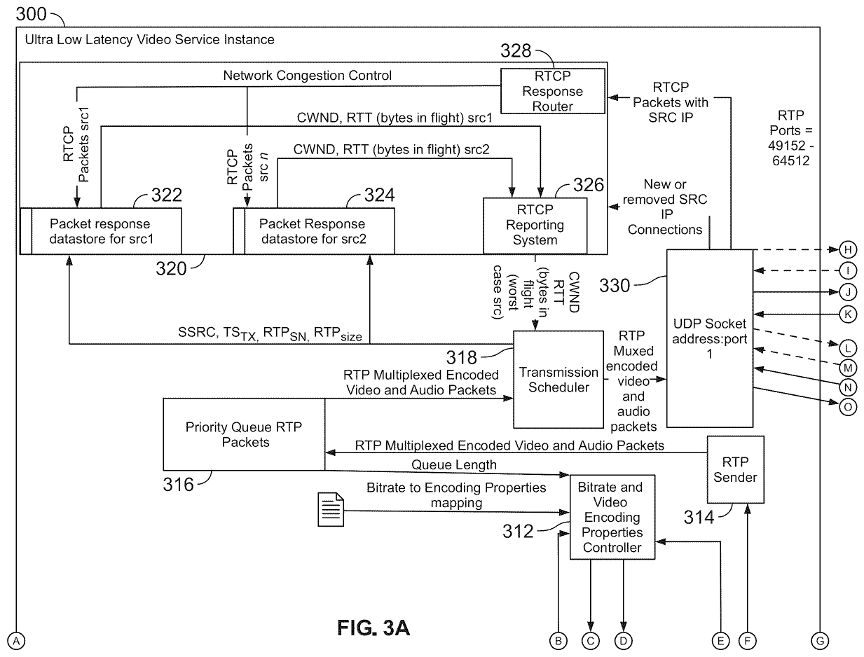

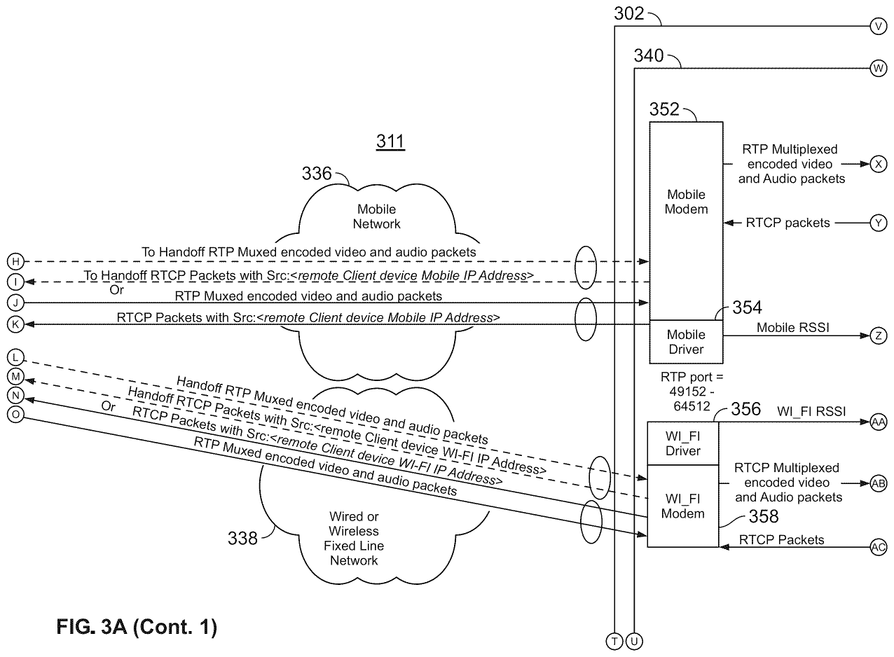

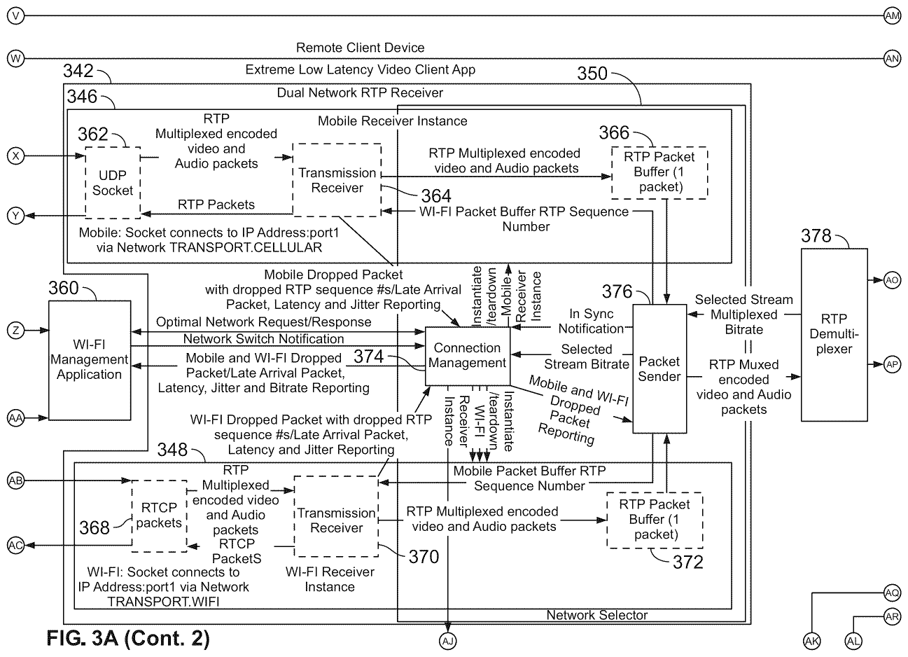

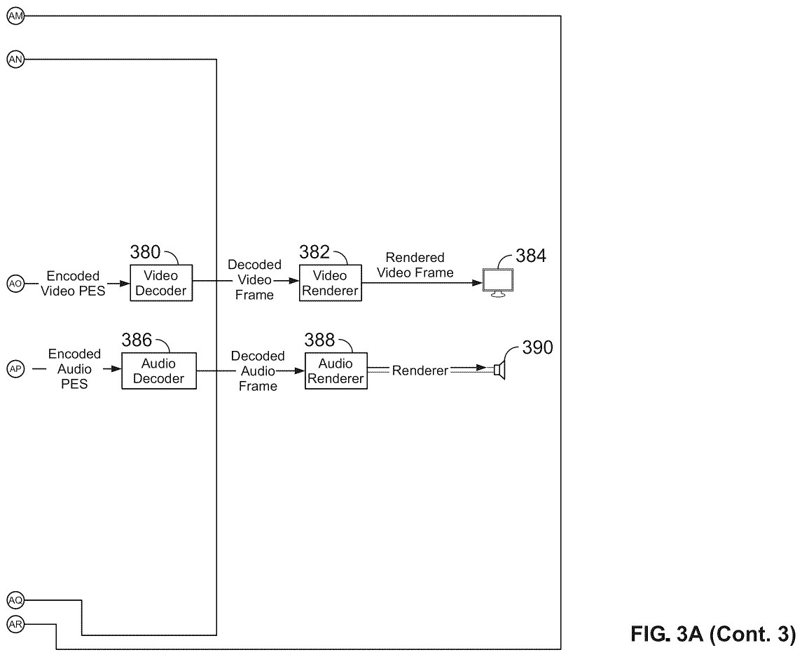

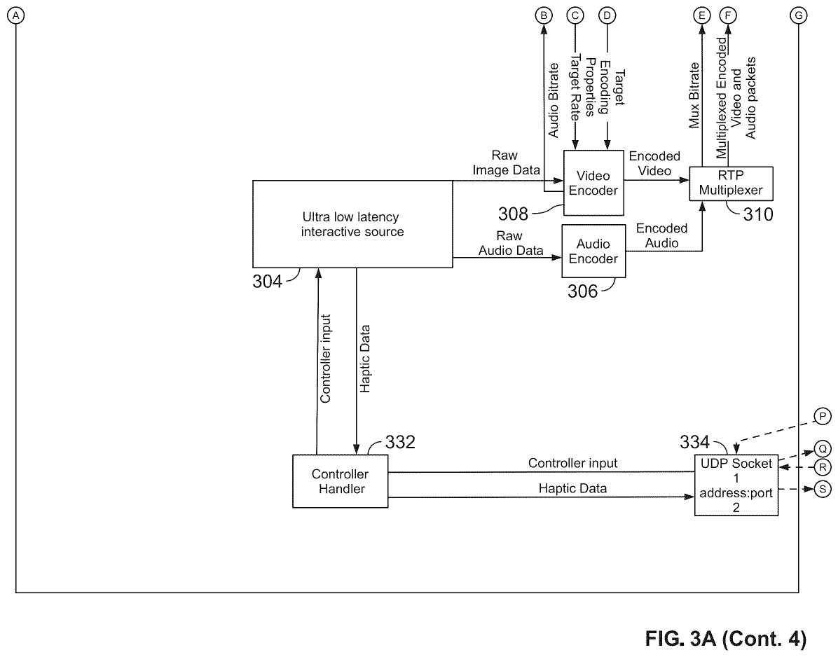

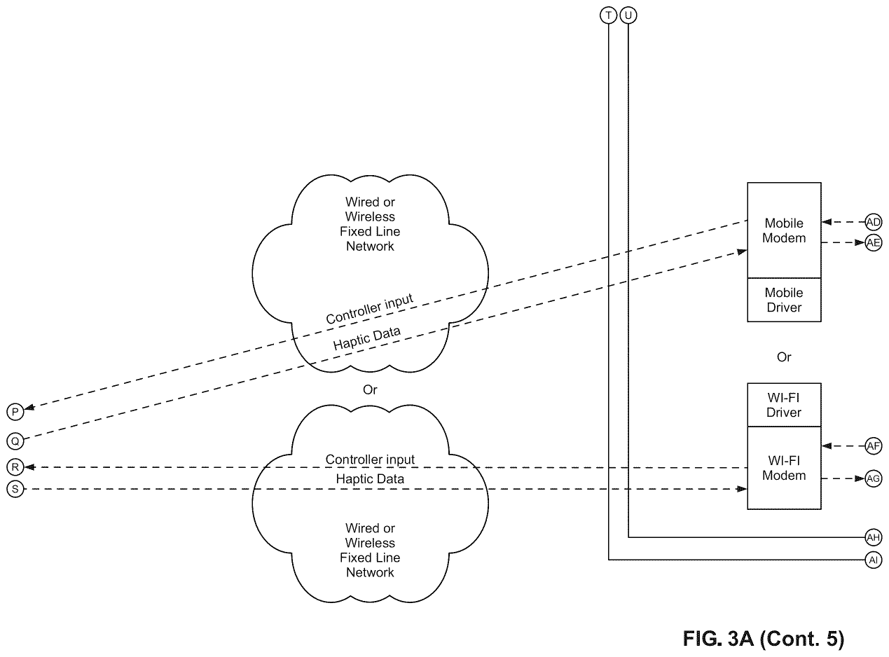

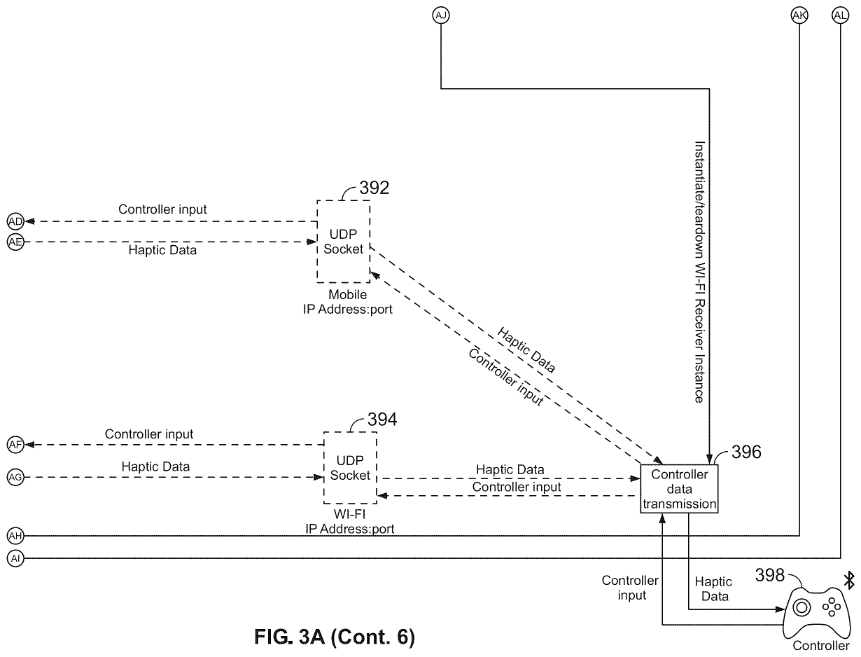

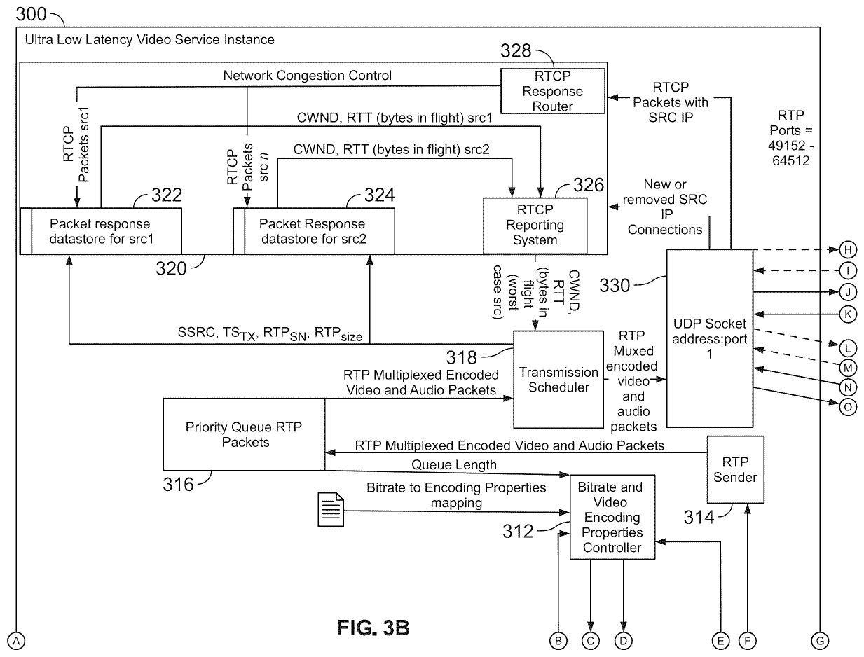

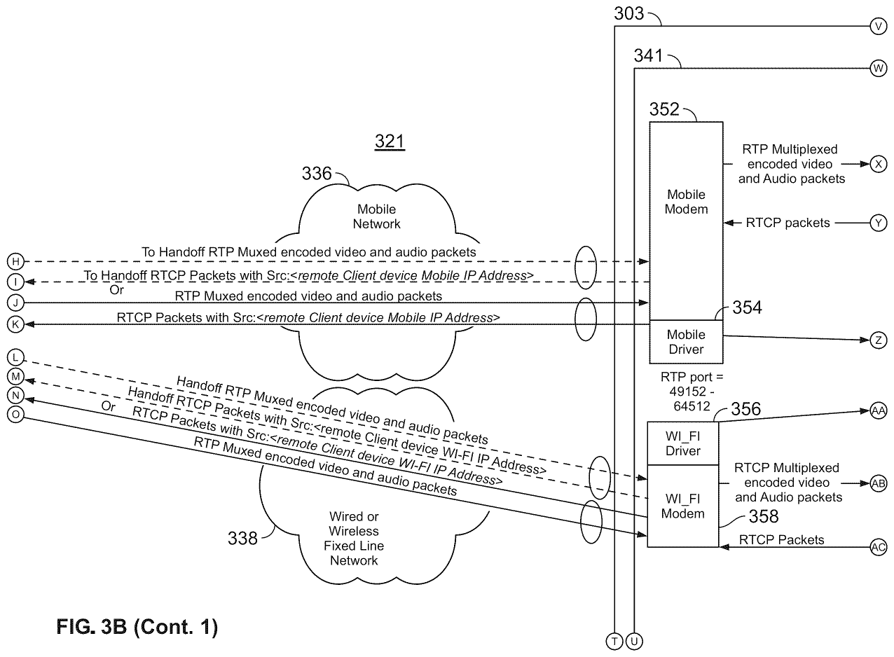

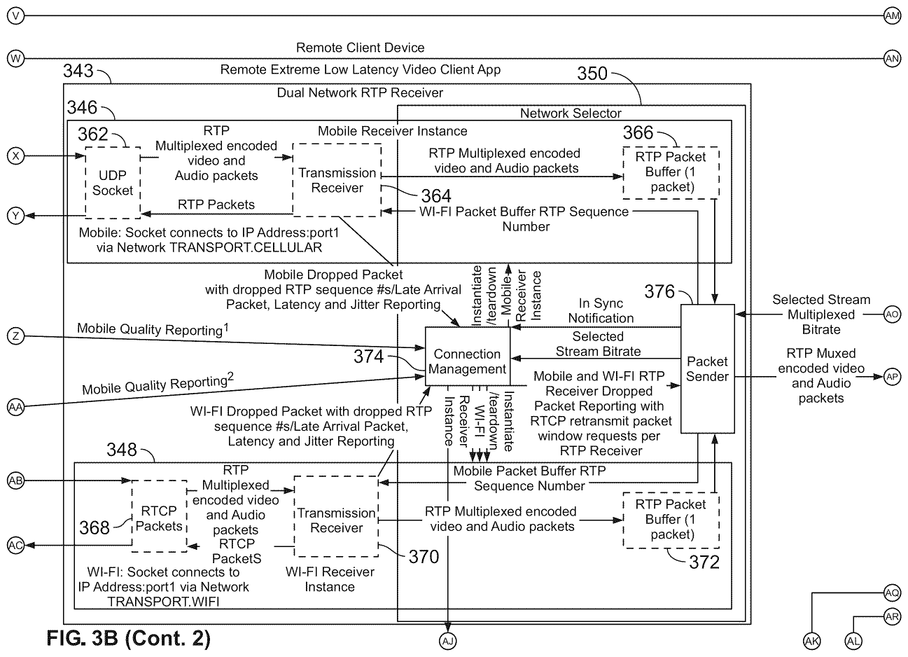

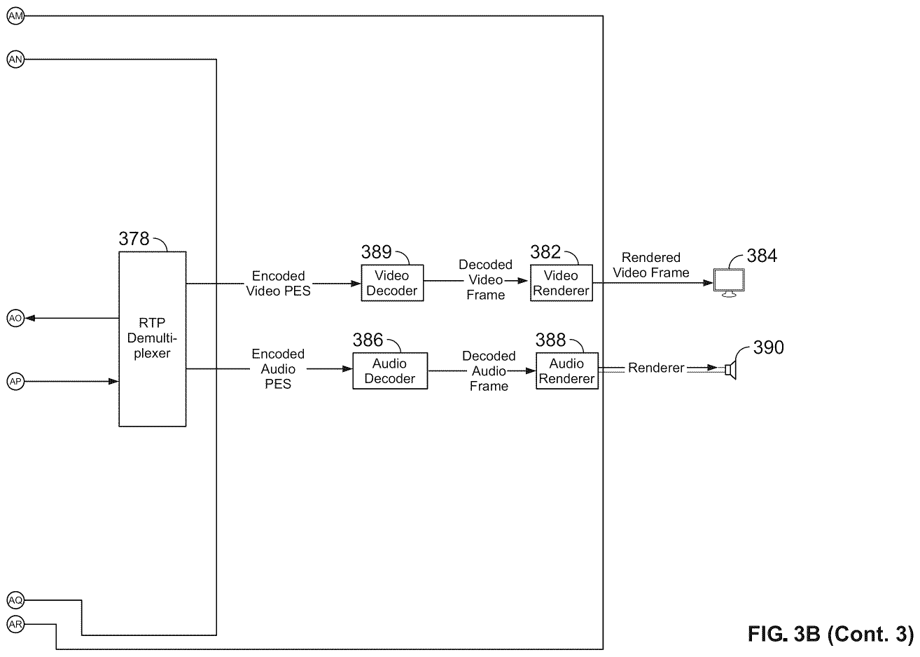

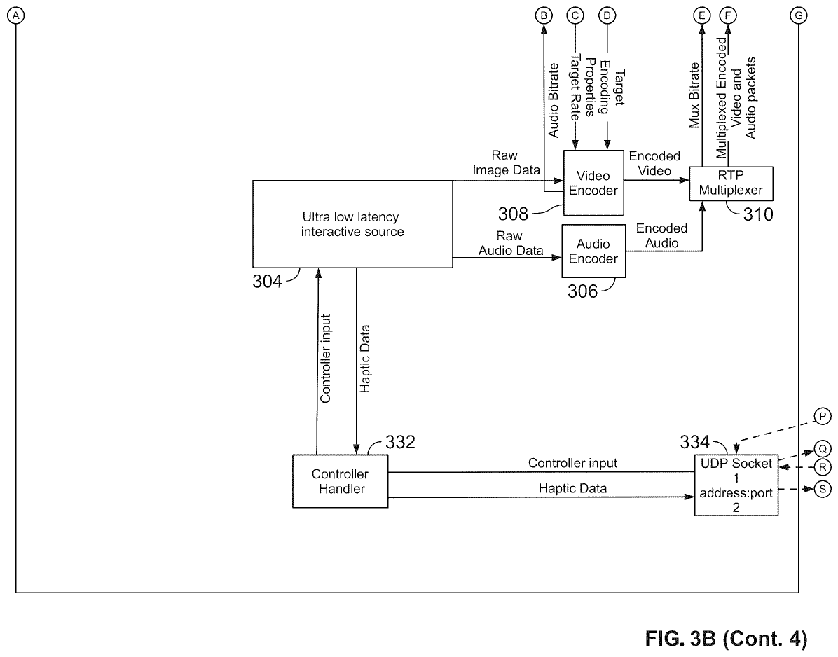

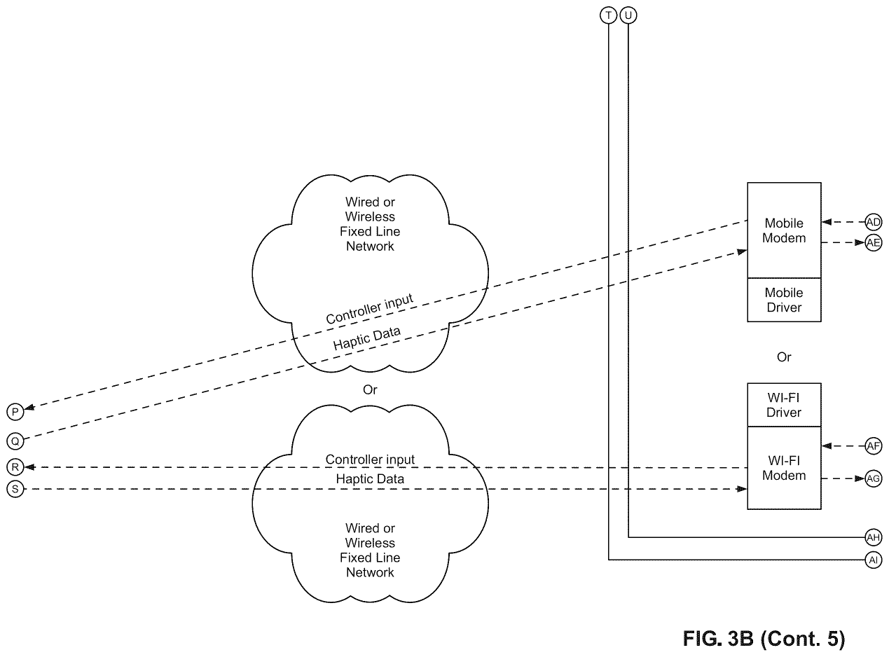

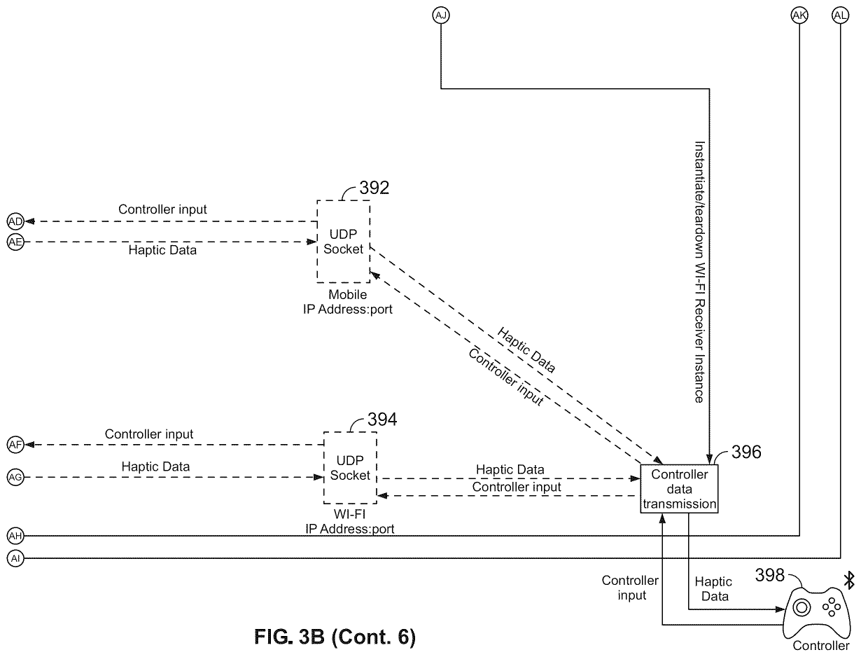

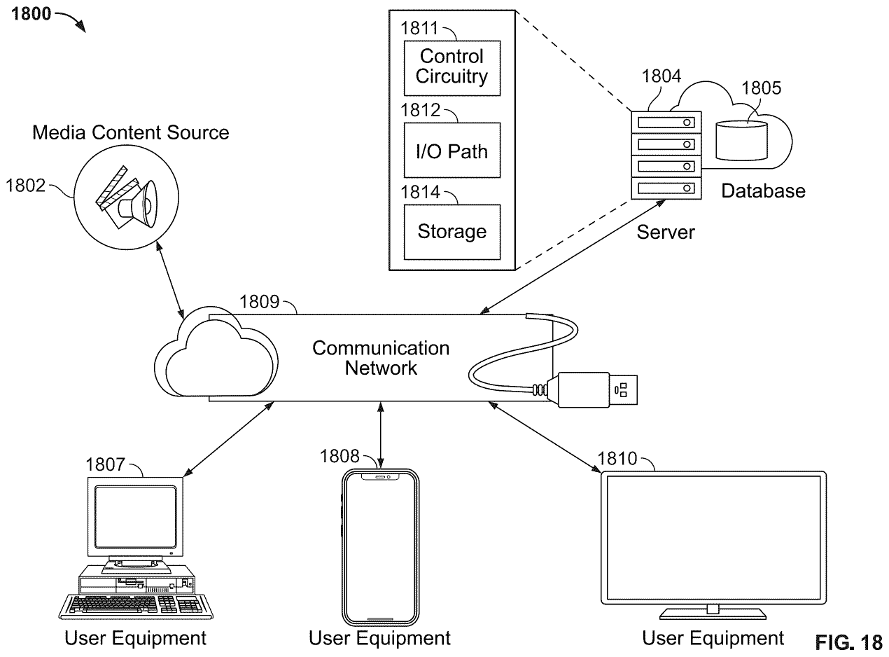

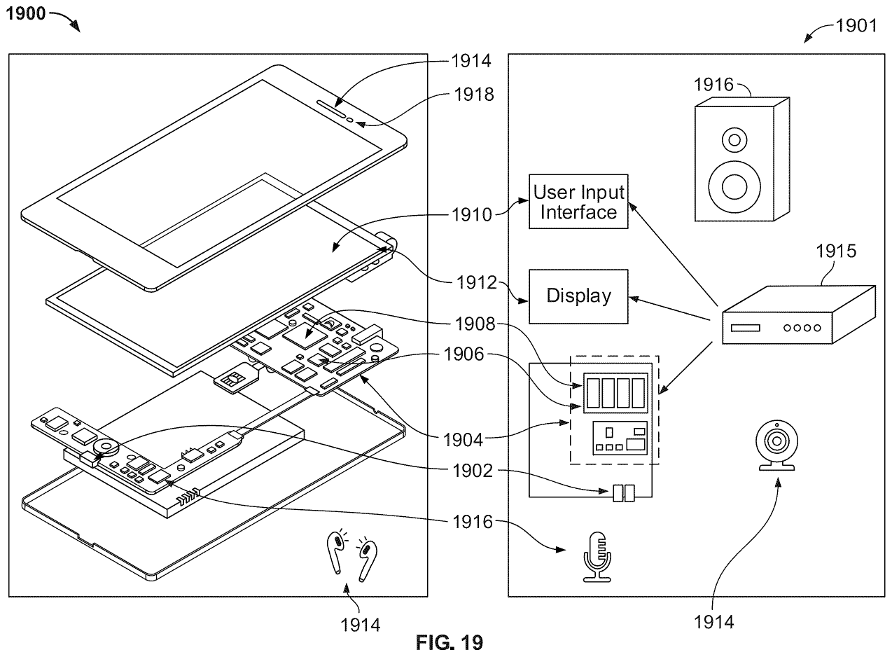

FIG. 1 shows an illustrative system 101 for performing network migration without packet loss by a receiver device, in accordance with embodiments of the disclosure. In some embodiments, an ultra-low latency content delivery system 101 comprises or corresponds to a receiver device receiving content from a sender device. For example, an ultra-low latency content delivery system 101 delivers content with sub-second delays (e.g., with latencies in the range of a few milliseconds to hundreds of milliseconds). In some embodiments, the receiver device comprises or corresponds to a client device 102 (e.g., operating a client application, client device 302 and 303 of FIG. 3A-3B, computing devices 1807, 1808, and 1810 of FIG. 18, computing device 1900 and 1901 of FIG. 19).

In some embodiments, the sender device comprises or corresponds to a server 100 (e.g., server device 300 of FIGS. 3A-3B, server 1804 of FIG. 18). For example, the server 100 operates a cloud gaming service delivering frames (e.g., in data packet 1 108, data packet 2 120, data packet 3 122, and data packet 4 124) of a video game to a cloud gaming client application operating on the client device 102. The ultra-low latency content delivery system 101 may be distributed across any of one or more client devices, remote server devices, or other suitable computing devices, in communication over any suitable number and/or types of networks. For example, the devices of the ultra-low latency content delivery system 101 are in communication over at least one of the following network types: Wi-Fi network types (e.g., associated with Wi-Fi network 104); cellular network types (e.g., associated with cellular network 106); wired and/or wireless fixed line network types; combinations of the same; or the like. The ultra-low latency content delivery system 101 may be configured to perform the functionalities (or any suitable portion of the functionalities) described herein. The ultra-low latency content delivery system may comprise or employ any suitable number of displays or devices, or any other suitable software and/or hardware components; or any combination thereof to perform such functionalities.

In some embodiments, the server device 100 operates a service (e.g., the cloud gaming service) consisting of instructions stored in a non-transitory memory that when executed causes certain effects. In some embodiments, the steps (e.g., performed by the server device 100) described herein are performed by an operating system (OS) of the server device 100 and/or the service operating on the server device 100. In some embodiments, the OS directly performs such steps, causes the service or a remote application to perform such steps, and/or triggers an API call to perform such steps. In some embodiments, the service directly performs such steps, causes the OS or a remote application to perform such steps, and/or triggers an API call to perform such steps. In some embodiments, the service has a distributed computing architecture, and is localized across multiple server devices (e.g., remote servers) and/or client devices. For example, the service includes or is associated with a content source, where the content comprises or corresponds to at least one of the following: audio content, video content, XR content, interactive gaming content, vehicle remote control content, videoconferencing content, robotics SLAM content, combinations of the same, or the like.

In some embodiments, the service processes the content from the content source by performing at least one of the following: encoding one or more frames of the content; multiplexing one or more frames of the content; generating packets (e.g., RTP packets) from one or more frames of the content; wrapping one or more frames of the content in a header (e.g., UDP header); combinations of the same; or the like. Further, for example, the service may be an OTT service and/or cloud gaming service. In some embodiments, the service communicates with remote servers to retrieve and/or encode the content from a content source that is not located within the server device 100. The service may comprise or correspond to a single sender instance (e.g., sender software application) associated with a single UDP socket (e.g., with multiple addresses for different networks) or multiple UDP sockets. For example, a single UDP socket of the sender software application may correspond to multiple physical UDP sockets, drivers (e.g., Wi-Fi drivers, cellular drivers), and/or modems (e.g., Wi-Fi modems, cellular modems) within the hardware of the server device 100.

In some embodiments, the client application (e.g., the cloud gaming client application) consists of instructions stored in a non-transitory memory that when executed causes certain effects. In some embodiments, the steps (e.g., performed by the client device 102) described herein are performed by an operating system (OS) of the client device 102 and/or the client application operating on the client device 102. In some embodiments, the OS directly performs such steps, causes the client application or a remote application to perform such steps, and/or triggers an application programming interface (API) call to perform such steps. In some embodiments, the client application directly performs such steps, causes the OS or a remote application to perform such steps, and/or triggers an API call to perform such steps. In some embodiments, the client application has a distributed computing architecture, and is localized across multiple server devices (e.g., remote servers) and/or client devices.

In some embodiments, the client application on the client device 102 is a stand-alone application, or is incorporated as part of any suitable application or system, e.g., a cloud gaming application, a videoconferencing application, a vehicle remote control application, an XR (e.g., XR gaming, XR SLAM, or the like) application, a robotics SLAM application, a content creation and/or content editing application; a web browsing application; a social media application; a content provider application; a 2D application; a supplemental content provider; a content acquisition, recognition and/or processing application; a machine learning model or AI system; or any other suitable application or system; or any combination thereof. In some embodiments, the client application may be installed at or otherwise provided to a client device 101, may be provided via an API, or may be provided as an add-on application to another platform or application. In some embodiments, software tools (e.g., one or more SDKs) may be provided to any suitable party, to enable the party to implement the functionalities described herein. In some embodiments, the client device 102 and/or the client application processes the received content by performing at least one of the following: decoding one or more frames of the content; demultiplexing one or more frames of the content; isolating one or more frames of the content from received packets (e.g., RTP packets); removing headers (e.g., UDP headers) from one or more frames of the content; combinations of the same; or the like. In some embodiments, the client application provides a user interface for interfacing with the content.

XR may be understood as VR, AR, or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

As shown in FIG. 1, the ultra-low latency content delivery system 101 may enable content to be received at client device 102. In some embodiments, client device 102 is a mobile device (e.g., a smartphone or tablet) capable of connection to multiple networks. For example, client device 102 includes a Wi-Fi modem and/or Wi-Fi driver for communication over Wi-Fi network types and a cellular modem and/or cellular driver for communication over cellular network types. In some embodiments, client device 102 comprises or corresponds to a laptop computer, a personal computer, a desktop computer, a smart watch or a wearable device, smart glasses, a stereoscopic display, a wearable camera, XR glasses, XR goggles, a near-eye display device, a remote control cockpit, or any other suitable user equipment or computing device, or any combination thereof.

In some embodiments, one or more receiver instances are instantiated on the client device 102. For example, a receiver instance comprises or corresponds to a software receiver application or system that processes signals received over a particular network type. In some embodiments, the receiver instance includes at least one of the following: a UDP socket, a transmission receiver application, or a packet buffer (e.g., a RTP packet buffer). Further, for example a first receiver instance 110 of the client device 102 may be used to receive data packets (e.g., data packet 1 108) over a first network (e.g., Wi-Fi network 104) while a second receiver instance 112 may be used to receive data packets (e.g., data packet 2 120, data packet 4 124) over a second network (e.g., cellular network 106). In some embodiments, data packets may be received by the client device 102 by multiple receiver instances (e.g., both first receiver instance 110 and second receiver instance 112). The client device 102 may instantiate or terminate receiver instances at any time.

In some embodiments, the server device 100 identifies a content stream to be delivered to the client device 102. In one example, the content stream is from a video game depicting an interactive scene. In some embodiments, the server device 100 identifies a first frame of the content stream, generates a first data packet 108 for the first frame, and transmits the first data packet via a first network (e.g., Wi-Fi network 104) to a first receiver instance 110 of the client device 102. For example, the server device 100 transmits the first data packet via at least one of the following content delivery protocols: RTP; WebRTC; SCReAM; real-time streaming protocol (RTSP); secure reliable transport (SRT); QUIC; combinations of the same; or the like. Further, for example, the server device 100 employs ABR streaming techniques (e.g., modified ABR streaming technique with bitrate determined by the sender device) alongside any of the aforementioned streaming protocols to ensure smooth video delivery. In one example, at the time of delivery of the first data packet 108 to the first receiver instance 110, the client device 102 only comprises the first receiver instance 110 and not a second receiver instance 112.

In some embodiments, the client device 102 identifies a decrease in the network quality of the first network. For example, the network strength of the Wi-Fi network 104 at the client device 102 has decreased due to an increase in distance from a router of the Wi-Fi network 104. In some embodiments, the client device 102 instantiates a second receiver instance 112 for delivery of the content over a second network (e.g., cellular network 106). Further for example, the client device 102 establishes a connection to the server device 100 via the cellular network 106. Additionally, or alternatively, the client device 102 may instantiate the second receiver instance based on at least one of the following: analysis of changes in stream quality of the first network; identification of events during packet transmission (e.g., the first packet arrives late or is dropped); analysis of jitter, bandwidth, or latency of the received first packet; receiving an indication to switch networks; combinations of the same; or the like. For example, the client device 102 instantiates the second receiver instance based on determining that the latency has exceeded a threshold value for longer than a configured period or determining that the jitter has exceeded a dynamic threshold. In some embodiments, the client device 102 determines to instantiate the second receiver instance 112 based on an indication from a Wi-Fi management application of the client device 102 to switch networks. For example, the Wi-Fi management application sends the indication to a connection manager of the client device 102 based on connection quality feedback and/or information associated with dropped or late arrival packets.

In some embodiments, the server device 100 identifies a first stream quality 114 (e.g., bitrate, resolution, any suitable quantitative measure of quality, or any combination thereof) for the first network 116 (e.g., associated with a 2560×1440 pixel resolution) and a second stream quality 116 (e.g., bitrate, resolution, any suitable quantitative measure of quality, or any combination thereof) for the second network 106 (e.g., associated with a 1280×720 pixel resolution). In some embodiments, the server device 100 identifies the first stream quality 114 and second stream quality 116 based on identifying multiple connections to the server device 100 for the same content stream. In one example, the server device 100 stores network performance information (e.g., information derived from RTCP packets including bandwidth, bitrate, latency, jitter, or the like) for the first network in a first datastore of the server device 100 and network performance information for the second network in a second datastore of the server device 100. In this example, the server device 100 may obtain the network performance information for each network from the datastores to determine a stream quality for each network. In some embodiments, the server device 100 selects the lower of the stream quality for the first network (e.g., Wi-Fi stream quality 116) and the stream quality for the second network (e.g., cellular stream quality 114) to be the stream quality 118 for the second data packet 120 and/or the third data packet 122 (e.g., both corresponding to a second frame of the content). For example, the server device 100 selects the Wi-Fi stream quality 116 (e.g., bitrate associated with a 1280×720 pixel resolution) to be the stream quality 118 (e.g., bitrate, resolution, any quantitative measure of quality, or combination thereof) for the second data packet 120 and/or the third data packet 122. In one example, the server device 100 determines a bitrate change is required and makes a bitrate change request to an encoder of the client device 100 based on the determined bitrate change. In this example, the encoder changes the resolution and/or framerate for encoding the content without generating an IDR. In this example, the codec (e.g., associated with the encoding) is VVC and the client device 100 may leverage reference picture resampling to avoid generating the IDR.

In some embodiments, the client device 102 receives from the server device 100 the content simultaneously via both networks (e.g., and receiver instances). In some embodiments, the client device 102 receives the second data packet 120 (e.g., via the second network) by the second receiver instance 112 and the third data packet 122 (e.g., via the first network) by the first receiver instance 110. In some embodiments, the second data packet 120 and the third data packet 122 include an encoding of the same portion of the content (e.g., the second frame of the content). In one example, the client device 102 may receive the second data packet 120 prior to receiving the third data packet 122. In another example, the client device 102 may receive the second data packet 120 after receiving the third data packet 122. In a further example, the client device 102 may receive the second data packet 120 at the same time as it receives the third data packet 122.

In some embodiments, the client device 102, while receiving content via both networks, proceeds to decision block 121. In some embodiments, the client device 102 determines, at decision block 121, whether data packets (e.g., the third data packet 122) received by the first network (e.g., and first receiver instance 110) are synchronized with data packets (e.g., the second data packet 120) received by the second network (e.g., and second receiver instance 112). In some embodiments, the client device 102 determines synchronization of packets based on a time of arrival of packets to both receiver instances. In one example, the client device 102 determines that packets have been dropped or have arrived late from the second network (e.g., cellular network 106) (e.g., indicating the packets are not synchronized) and may determine to continue receiving data packets from both networks and/or to terminate the network switch by returning to receiving data packets from only the first network. In another example, the client device 102 determines that packets have arrived late or have been dropped from the first network and not the second network (e.g., indicating the packets are not synchronized). In this example, the client device 102 may determine to continue receiving data packets from both networks and/or to complete the network switch by receiving data packets from only the second network. In another example, the client device 102 determines that no packets have arrived late or have been dropped from either network (e.g., indicating the packets are synchronized) and completes the network switch.

In some embodiments, the client device 102 completes the network switch by terminating the first receiver instance 110. In some embodiments, the client device 102 receives a fourth data packet 124 from the server device 100 via the second network (e.g., cellular network 106) by the second receiver instance 112. In one example, the client device 102 no longer receives the content via the first network. In this example, the server device 100 may terminate the first data store corresponding to the first network based on identifying that the connection with the client device 102 over the first network has been lost. In some embodiments, following completion of the network switch, the client device 102 receives content via the second network and may determine to switch back to the first network or any other network (e.g., wired fixed line network, other cellular network, other Wi-Fi network, or the like).

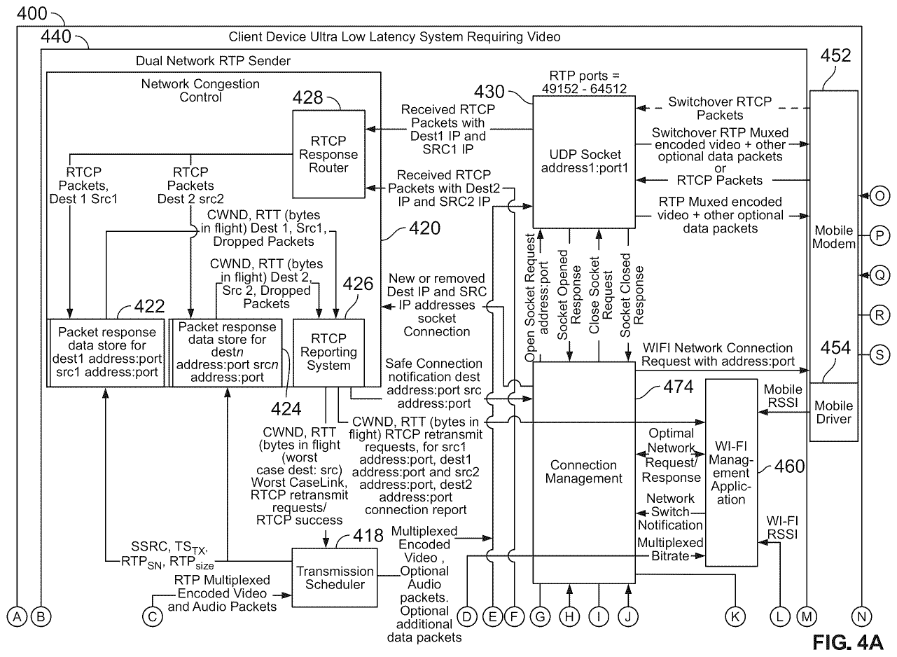

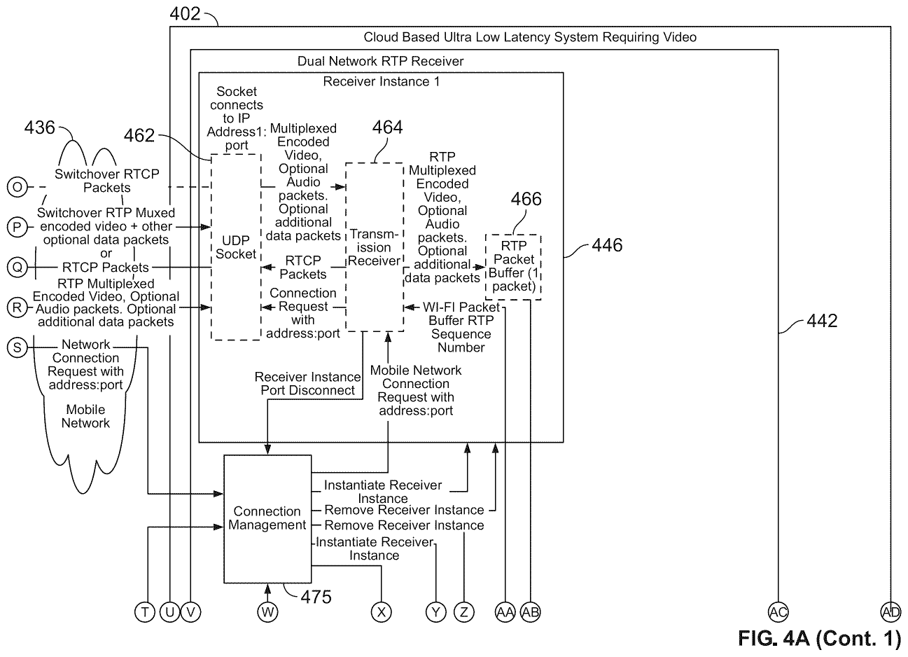

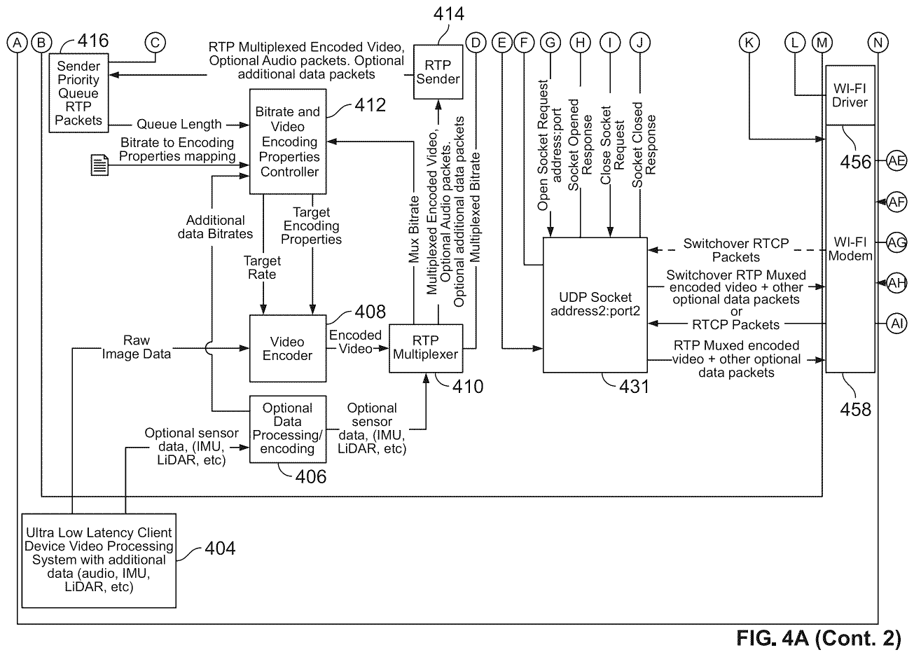

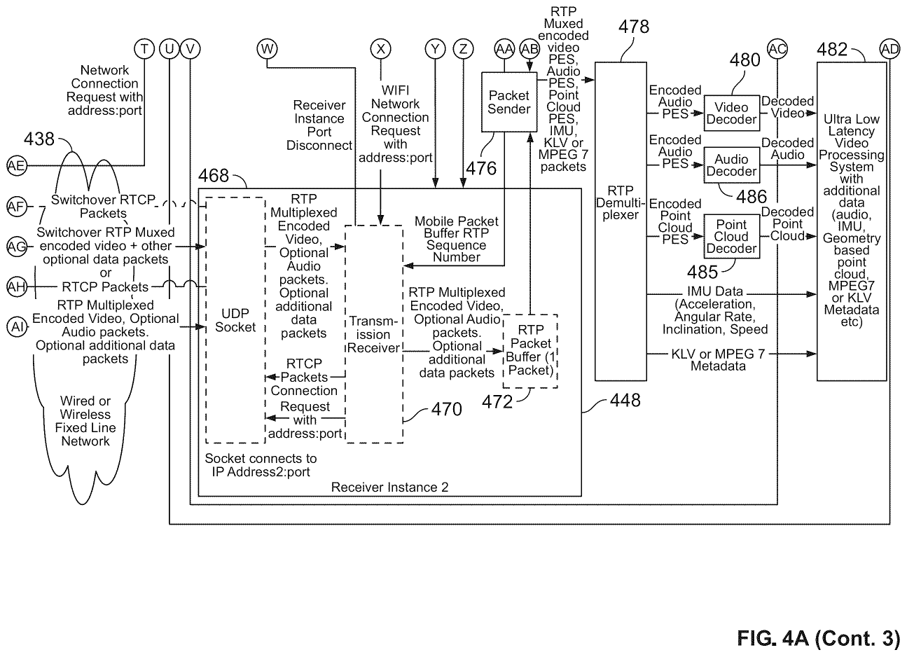

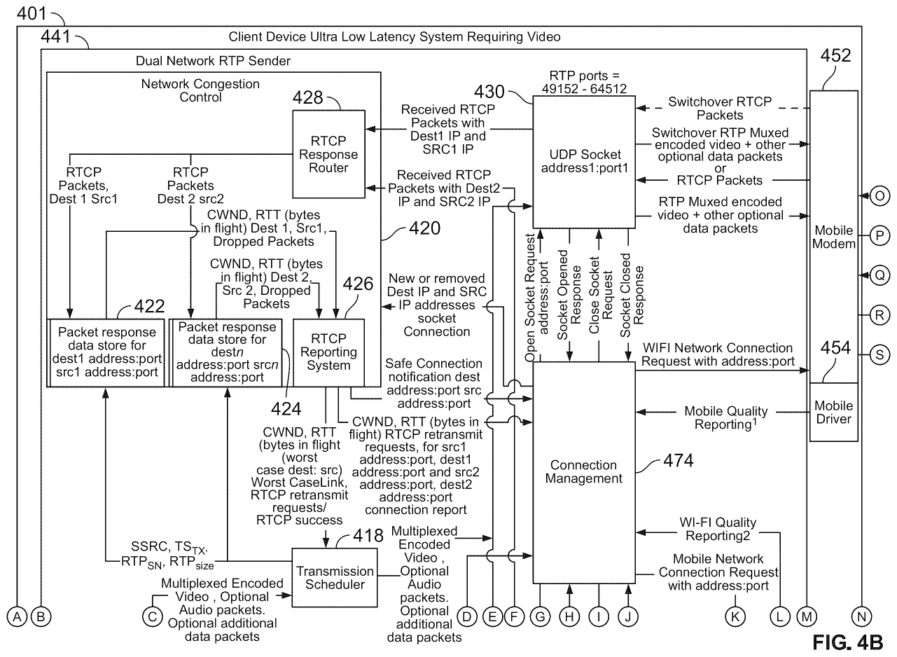

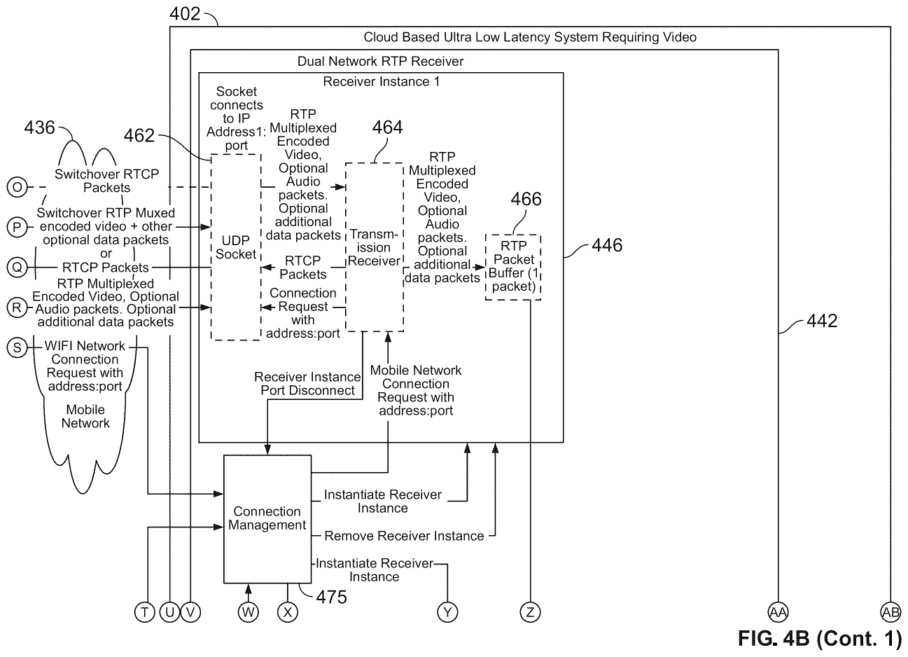

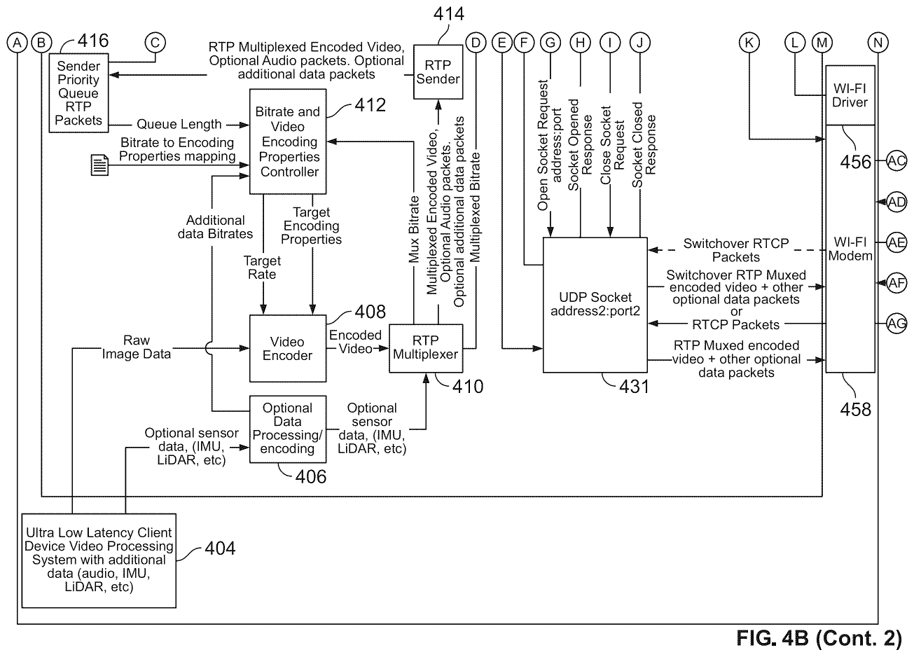

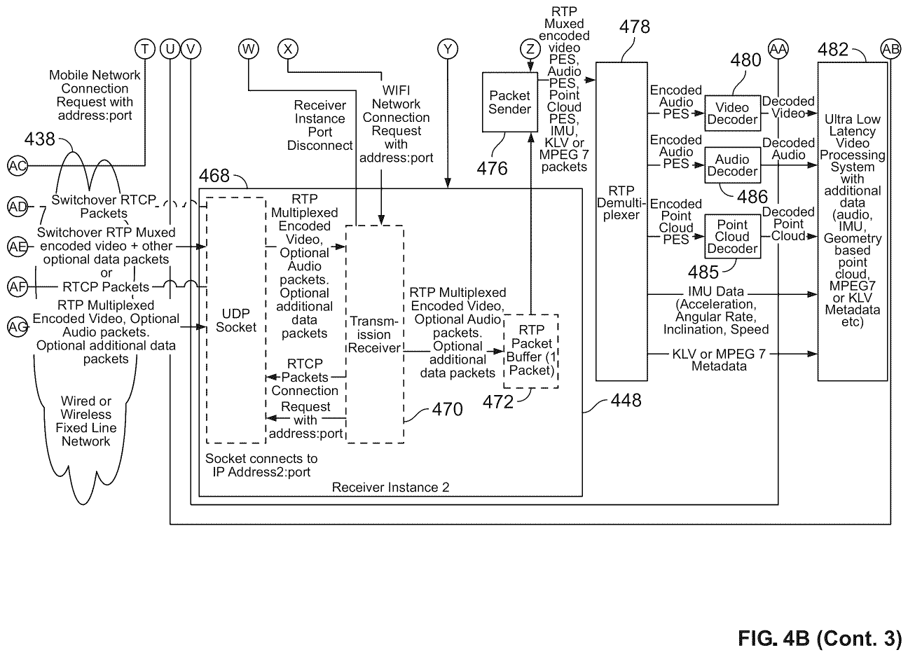

FIG. 2 shows an illustrative system 201 for performing network migration without packet loss by a sender device, in accordance with embodiments of the disclosure. In some embodiments, an ultra-low latency content delivery system 201 comprises or corresponds to a sender device transmitting content to a sender device. In some embodiments, the sender device comprises or corresponds to a client device 200 (e.g., operating a client application, client device 400 and 401 of FIG. 4A-4B, computing devices 1807, 1808, and 1810 of FIG. 18, computing device 1900 and 1901 of FIG. 19). In some embodiments, the receiver device comprises or corresponds to a server 202 (e.g., videoconferencing server 202, server device 402 of FIG. 4A-4B, server 1804 of FIG. 18). For example, the server 202 operates a service (e.g., videoconferencing service) receiving frames (e.g., in data packet 1 208, data packet 2 220, data packet 3 222, and data packet 4 224) of a videoconferencing visual asset from a videoconferencing client application operating on the client device 200. The ultra-low latency content delivery system 201 may be distributed across any of one or more client devices, remote server devices, or other suitable computing devices, in communication over any suitable number and/or types of networks. For example, the devices of the ultra-low latency content delivery system 201 are in communication over at least one of the following network types: Wi-Fi network types (e.g., associated with Wi-Fi network 204); cellular network types (e.g., associated with cellular network 206); wired and/or wireless fixed line network types; combinations of the same; or the like. The ultra-low latency content delivery system 201 may be configured to perform the functionalities (or any suitable portion of the functionalities) described herein. The ultra-low latency content delivery system 201 may comprise or employ any suitable number of displays or devices, or any other suitable software and/or hardware components; or any combination thereof to perform such functionalities.

In some embodiments, the client application (e.g., the videoconferencing client application) consists of instructions stored in a non-transitory memory that when executed causes certain effects. In some embodiments, the steps (e.g., performed by the client device 200) described herein are performed by an operating system (OS) of the client device 200 and/or the client application operating on the client device 200. In some embodiments, the OS directly performs such steps, causes the client application or a remote application to perform such steps, and/or triggers an application programming interface (API) call to perform such steps. In some embodiments, the client application directly performs such steps, causes the OS or a remote application to perform such steps, and/or triggers an API call to perform such steps. In some embodiments, the client application has a distributed computing architecture, and is localized across multiple server devices (e.g., remote servers) and/or client devices.

In some embodiments, the client application on the client device 200 is a stand-alone application, or is incorporated as part of any suitable application or system, e.g., a videoconferencing application, a cloud gaming application, a vehicle remote control application, an XR (e.g., XR gaming, XR SLAM, or the like) application, a robotics SLAM application, a content creation and/or content editing application; a web browsing application; a social media application; a content provider application; a 2D application; a supplemental content provider; a content acquisition, recognition and/or processing application; a machine learning model or AI system; or any other suitable application or system; or any combination thereof. In some embodiments, the client application may be installed at or otherwise provided to a client device 200, may be provided via an API, or may be provided as an add-on application to another platform or application. In some embodiments, software tools (e.g., one or more SDKs) may be provided to any suitable party, to enable the party to implement the functionalities described herein. In some embodiments, the client device 200 and/or the client application processes the content for transmission by performing at least one of the following: encoding one or more frames of the content; multiplexing one or more frames of the content; generating packets (e.g., RTP packets) from one or more frames of the content; wrapping one or more frames of the content with headers (e.g., UDP headers); combinations of the same; or the like. In some embodiments, the client application provides a user interface for interfacing with the content.

In some embodiments, the server device 202 operates a service (e.g., the cloud gaming service) consisting of instructions stored in a non-transitory memory that when executed causes certain effects. In some embodiments, the steps (e.g., performed by the server device 202) described herein are performed by an operating system (OS) of the server device 202 and/or the service operating on the server device 202. In some embodiments, the OS directly performs such steps, causes the service or a remote application to perform such steps, and/or triggers an application programming interface (API) call to perform such steps. In some embodiments, the service directly performs such steps, causes the OS or a remote application to perform such steps, and/or triggers an API call to perform such steps. In some embodiments, the service has a distributed computing architecture, and is localized across multiple server devices (e.g., remote servers) and/or client devices. For example, the service includes or is associated with a content source, where the content comprises or corresponds to a at least one of the following: audio content, video content, XR content, interactive gaming content, vehicle remote control content, videoconferencing content, robotics SLAM content, combinations of the same, or the like.

In some embodiments, the service processes the received content by performing at least one of the following: decoding one or more frames of the content; demultiplexing one or more frames of the content; isolating one or more frames of the content from received packets (e.g., RTP packets); removing a header (e.g., UDP header) from one or more frames of the content; combinations of the same; or the like. Further, for example, the service may be a videoconferencing service, an OTT service and/or cloud gaming service. In some embodiments, the service communicates with remote servers to retrieve and/or encode the content from a content source that is not located within the server device 202. The service may comprise or correspond to a single sender instance (e.g., sender software application) associated with a single UDP socket (e.g., with multiple addresses for different networks) or multiple UDP sockets. For example, a single UDP socket of the sender software application may correspond to multiple physical UDP sockets, drivers (e.g., Wi-Fi drivers, cellular drivers), and/or modems (e.g., Wi-Fi modems, cellular modems) within the hardware of the server device 202.

As shown in FIG. 2, the ultra-low latency content delivery system 201 may enable content to be received at client device 200. In some embodiments, client device 200 is a mobile device (e.g., a smartphone or tablet) capable of connection to multiple networks. For example, client device 200 includes a Wi-Fi modem and/or Wi-Fi driver for communication over Wi-Fi network types and a cellular modem and/or cellular driver for communication over cellular network types. In some embodiments, client device 200 comprises or corresponds to a laptop computer, a personal computer, a desktop computer, a smart watch or a wearable device, smart glasses, a stereoscopic display, a wearable camera, XR glasses, XR goggles, a near-eye display device, a remote vehicle cockpit, or any other suitable user equipment or computing device, or any combination thereof.

In some embodiments, one or more receiver instances are instantiated on the server device 202. For example, a receiver instance comprises or corresponds to a software receiver application or system that processes signals received over a particular network type. In some embodiments, the receiver instance includes at least one of the following: a UDP socket, a transmission receiver application, or a packet buffer (e.g., a RTP packet buffer). Further, for example a first receiver instance 210 of the server device 202 may be used to receive data packets (e.g., data packet 1 208) over a first network (e.g., Wi-Fi network 204) while a second receiver instance 212 may be used to receive data packets (e.g., data packet 2 220, data packet 4 224) over a second network (e.g., cellular network 206). In some embodiments, data packets may be transmitted by the client device 200 to multiple receiver instances (e.g., both first receiver instance 210 and second receiver instance 212) of the server device 202. The server device 202 may instantiate or terminate receiver instances at any time.

In some embodiments, the client device 200 identifies a content to be delivered to the server device 202. In one example, the content is a visual asset of a videoconferencing call depicting a user of the client device 200. In some embodiments, the client device 200 identifies a first frame of the content, generates a first data packet 208 for the first frame, and transmits the first data packet 208 via a first network (e.g., Wi-Fi network 204) to a first receiver instance 210 of the server device 202. For example, the client device 200 transmits the first data packet 208 via at least one of the following content delivery protocols: RTP; WebRTC; SCReAM; RTSP; SRT; QUIC; combinations of the same; or the like. Further, for example, the client device 200 employs ABR streaming techniques (e.g., modified ABR streaming techniques with bitrate determined by the sender device) alongside any of the aforementioned streaming protocols to ensure smooth video delivery. In one example, at the time of delivery of the first data packet 208 to the first receiver instance 210, the server device 202 only comprises the first receiver instance 210 and not a second receiver instance 212.

In some embodiments, the server device 200 identifies a decrease in the network quality of the first network. For example, the network strength of the Wi-Fi network 204 at the client device 200 has decreased due to an increase in distance from a router of the Wi-Fi network 204. In some embodiments, the client device 200 transmits a connection request for the second network to the server device 202. For example, the connection request includes an identifier for the client device 200 on the second network (e.g., cellular network 206). In some embodiments, the server device 202 instantiates a second receiver instance 212 for delivery of the content over the second network (e.g., cellular network 206). Further for example, the server device 202 establishes a connection with the client device 200 via the cellular network 206. Further, for example, the server device 202 establishes the connection based on the identifier of the connection request. Additionally, or alternatively, the client device 200 may transmit the connection request based on at least one of the following: analysis of changes in stream quality of the first network; identification of events during packet transmission (e.g., the first packet 208 arrives late or is dropped); analysis of jitter, bandwidth, or latency of the received first packet 208; receiving an indication to switch networks; combinations of the same; or the like. For example, the client device 200 transmits the connection request based on determining that the latency has exceeded a threshold value for longer than a configured period or determining that the jitter has exceeded a dynamic threshold. In some embodiments, the client device 200 determines to transmit the connection request based on an indication from a Wi-Fi management application of the client device 200 to switch networks. For example, the Wi-Fi management application sends the indication to a connection manager of the client device 102 based on connection quality feedback information (e.g., received from network drivers).

In some embodiments, the client device 200 identifies a first stream quality 214 (e.g., bitrate, resolution, any quantitative measure of quality, or any combination thereof) for the first network (e.g., associated with a 2560×1440 pixel resolution) and a second stream quality 216 (e.g., bitrate, resolution, any quantitative measure of quality, or any combination thereof) for the second network (e.g., associated with a 1280×720 pixel resolution). In some embodiments, the client device 200 identifies the first stream quality 214 and second stream quality 216 based on identifying multiple connections to the client device 200 for the same content stream. In one example, the client device 200 stores network performance information (e.g., RTCP packet information including bandwidth, bitrate, latency, or the like) for the first network in a first datastore of the client device 200 and network performance information for the second network in a second datastore of the client device 200. In this example, the client device 200 may obtain the network performance information for each network from the datastores to determine a stream quality for each network. In some embodiments, the client device 200 selects the lower of the stream quality for the first network (e.g., Wi-Fi stream quality 216) and the stream quality for the second network (e.g., cellular stream quality 214) to be the stream quality 218 for the second data packet 220 and/or the third data packet 222 (e.g., both corresponding to a second frame of the content). For example, the client device 200 selects the Wi-Fi stream quality 216 (e.g., a first bitrate associated with a 1280×720 pixel resolution) to be the stream quality 218 (e.g., bitrate, resolution, any quantitative measure of quality, or combination thereof) for the second data packet 220 and/or the third data packet 222. In one example, the client device 200 determines a bitrate change is required and makes a bitrate change request to an encoder of the client device 200 based on the determined bitrate change. In this example, the encoder changes the resolution and/or framerate for encoding the content without generating an IDR. In this example, the codec (e.g., associated with the encoding) is VVC and the client device 200 may leverage reference picture resampling to avoid generating the IDR.

In some embodiments, the client device 200 transmits to the server device 202 the content simultaneously via both networks (e.g., and receiver instances). In some embodiments, the client device 200 transmits the second data packet 220 (e.g., via the second network) by the second receiver instance 212 and the third data packet 222 (e.g., via the first network) by the first receiver instance 210. In some embodiments, the second data packet 220 and the third data packet 222 include an encoding of the same portion of the content (e.g., the second frame of the content). In one example, the client device 200 transmits the second data packet 220 prior to transmitting the third data packet 222. In another example, the client device 200 transmits the second data packet 220 after transmitting the third data packet 222. In a further example, the client device 200 transmits the second data packet 220 at the same time as it transmits the third data packet 222.

In some embodiments, the client device 200, while transmitting content via both networks, proceeds to decision block 221. In some embodiments, the client device 200 determines, at decision block 221, whether data packets (e.g., the third data packet 222) received by the first network (e.g., and first receiver instance 210) are synchronized with data packets (e.g., the second data packet 220) received by the second network (e.g., and second receiver instance 212). In some embodiments, the client device 200 determines whether the packets are synchronized based on RTCP packets received from the server device 202 associated with the second data packet 220 and/or the third data packet 222. In one example, the client device 200 determines that the packets are synchronized based on identifying an acknowledgement (e.g., in the RTCP packets) for at least one of the second data packet 220 or the third data packet 222. In another example, the client device 200 determines that the packets are synchronized only when an acknowledgement (e.g., in the RTCP packets) are identified for both the second data packet 220 and the third data packet 222. In a further example, the client device 200 determines whether the packets are synchronized based on an identified time of arrival, congestion window (CWND) size, and/or round trip time (RTT) (e.g., in the RTCP packets) associated with the second data packet 220 and/or the third data packet 222. For example, the client device 200 determines that the packets are not synchronized based on determining that a RTT of a RTCP packet associated with the second packet 220 delivered over the second network exceeds a threshold value. In some embodiments, the client device 200, based on determining the packets are synchronized, proceeds to terminating the connection between the client device 200 and server device 202 over the first network (e.g., Wi-Fi network 204). In some embodiments, the server device 202, based on determining that the connection between the client device 200 over the first network has been terminated, terminates the first receiver instance 210. In some embodiments, the client device 200, based on determining the packets are not synchronized continues to transmit data packets via both networks (e.g., and continues to check for synchronization of data packets). In some embodiments, the client device 200, based on determining the packets are not synchronized and that packets have arrived late or have been dropped over the second network, determines to terminate the network switch process and return to transmitting packets only via the first network.

In some embodiments, the client device 200 transmits a fourth data packet 224 to the second receiver instance 212 of the server device 202 via the second network (e.g., cellular network 206). In one example, the client device 200 no longer transmits the content via the first network. In this example, the server device 202 may terminate the first data store corresponding to the first network based on identifying that the connection with the client device 200 over the first network has been lost. In some embodiments, following completion of the network switch, the client device 200 transmits content via the second network and may determine to switch back to the first network or any other network (e.g., wired fixed line network, other cellular network, other Wi-Fi network, or the like).

In some embodiments, the server device (e.g., server device 100 of FIG. 1 and server device 202 of FIG. 2) acts as both a sender device and a receiver device and performs any of the steps described herein. In some embodiments, the client device (e.g., client device 102 of FIG. 1 and client device 200 of FIG. 2) acts as both a sender device and a receiver device and performs any of the steps described herein. For example, the server device receives videoconferencing call content from a first client device over a first network and switches to receiving the videoconferencing call content over a second network by performing any of the steps described in association with FIG. 2. Additionally, or alternatively, the server device sends the received videoconferencing call content to a second client device over a third network and switches to sending the videoconferencing call content over a fourth network by performing any of the steps described in association with FIG. 1. In one example, the server device simultaneously performs a network switch for receiving content from a client device and a network switch for transmitting content to the client device.

FIG. 3A is a schematic example of an ultra-low latency content delivery system for 311 performing receiver-directed network migration with a Wi-Fi Management Application (WMA), in accordance with embodiments of the disclosure.

As shown in FIG. 3A, in some embodiments, the steps described herein may be performed in connection with a modified SCReAM architecture. For example, the ultra-low latency content delivery system 311 includes a single sender device (e.g. server device 100 of FIG. 1, server 1804 of FIG. 18) transmitting both audio and video packets. Further, for example, a service 300 running on the sender device supports multiple network connections (e.g., via mobile network 336 and/or wired/wireless fixed line network 338) from the same UDP (e.g., and/or RTP) socket and/or port (e.g., UDP socket 1 address port 1 330). Moreover, for example, the service 300 includes a network congestion controller 320 that includes packet response data stores (e.g., packet response data store 1 322, packet response data store 2 324), which stores data for each of the client device 302 network connections (e.g., storing the last transmitted RTP packet information for each network connection). In one example, the service 300 includes one data store for each IP address of a connection with the client device 302 (e.g., client device 102 of FIG. 1, computing devices 1807, 1808, and 1810 of FIG. 18, computing device 1900 and 1901 of FIG. 19). Moreover, for example, the service 300 determines when a connection with the client device 302 is initiated or terminated by the UDP socket 330 and may send a message to the network congestion controller 320 to instantiate or terminate a corresponding packet response data store for that IP address. In one example, the packet response data store 1 322 corresponds to the mobile network 336, the UDP socket 330 determines that the connection with the client device 302 via the mobile network 336 has been terminated, and sends a message to the network congestion controller 320 to terminate packet response data store 1 322.

In some embodiments, the network congestion controller 320 includes an RTCP response router 328 and RTCP reporting system 326. For example, when an RTCP packet is received by the service 300 for a transmitted RTP packet, the RTCP packet will be placed into a packet response data store (e.g., packet response data store 1 322 or packet response datastore 324) based on a source IP address of the RTCP packet (e.g., and/or corresponding RTP packet). In some embodiments, the corresponding packet response data store (e.g., packet response datastore 1 322 or packet response datastore 2 324) reports a CWND and/or RTT (e.g., or bytes in flight) to the RTCP reporting system 326. In some embodiments, the RTCP reporting system 326 waits until there is a CWND and/or RTT (e.g., or bytes in flight) associated with each of the packet response datastores before sending a worst case source IP address message (e.g., with a lowest network quality) from the two IP addresses corresponding to the two packet response datastores to the transmission scheduler 318. In some embodiments, the transmission scheduler 318 receives the worst case source IP address message and retrieves a RTP packet from the RTP packet priority queue 316 to the transmission scheduler 318 and sends the retrieved RTP packet over the UDP socket 330 over both networks to both receiver instances (e.g., mobile receiver instance 346 and Wi-Fi receiver instance 348) of the client device 302. In some embodiments, both receiver instances receive the same quality encoding based on the worst case client (e.g., reported by RTCP reporting system 326. In some embodiments, the RTP packet priority queue 316 reports a queue length to the bitrate and video encoding properties controller 312. In some embodiments, the bitrate and video encoding properties controller 312 adjusts the bandwidth, resolution, and/or framerate of the encoding based on the queue length and/or the worst case connection (e.g., over the network with the lowest network quality).

In some embodiments, the service 300 encodes the content based on one or more encoding parameters of remote rendering bitrates (e.g., for codecs). For example, the ultra-low latency encoding is based on a resolution and/or framerate determined from a bitrate to encoding properties mapping. In some embodiments, when the bitrate changes based on network conditions, the bitrate and video encoding properties controller 312 adjusts the video encoder 308 to a resolution and framerate based on a codec type (e.g., high-efficiency video coding (HEVC), VVC, advanced video coding (AVC), VP9, AV1, or any other moving pictures expert group (MPEG) or non-MPEG codecs) for the service 300 and the current bitrate. In some embodiments, to avoid inserting an IDR frame or I-frame when the video resolution changes, the service 300 performs reference picture resampling RPR (e.g., for a VVC codec type). For example, during a network transition, the bandwidth may decrease then increase over time, creating a scenario where RPR provides the greatest value. Further, for example, RPR causes a temporary reduction of resolution (e.g., and bitrate) without requiring encoding an IDR frame. Moreover, for example, the network transition is expected and predictable, providing the service 300 additional control of triggering the RPR, e.g., in video compression. In some embodiments, when using HEVC and/or AVC codec types, the service 300 performs video pre-processing (e.g., using low-pass filtering to reduce high frequencies and signal complexities) to avoid inserting IDR frames. For example, the service 300 performs the video pre-processing based on observing reduced bitrate of a network connection, which may trigger a change in resolution or reduction in signal complexity for video compression.

In some embodiments, the service 300 includes at least one of the following components: ultra-low latency interactive source 304, video encoder 308, audio encoder 306, RTP multiplexer 310, bitrate and video encoding properties controller 312, RTP sender 314, RTP packet priority queue 316, transmission scheduler 318, network congestion controller 320, a first UDP socket address port 330, a controller handler 332, a second UDP socket address port 334, combinations of the same, or the like. For example, the ultra-low latency interactive source 304 sends raw image data to the video encoder 308 and raw audio data to the audio encoder 306. Further, for example, the video encoder 308 sends encoded video to the RTP multiplexer 310. Also, for example, the audio encoder 306 sends encoded audio to the RTP multiplexer 310 and an audio bitrate to the bitrate and video encoding properties controller 312. Moreover, for example, the RTP multiplexer 310 sends a multiplexed bitrate to the bitrate and video encoding properties controller 312 and RTP multiplexed encoded video and audio packets (e.g., including a RTP header and RTP payload) to the RTP sender 314. Additionally, for example, the bitrate and video encoding properties control 312 sends target encoding properties and a target bitrate to the video encoder 308. In some embodiments, the bitrate and video encoding properties controller 312 receives a bitrate to encoding properties mapping. Even further, for example, the RTP sender 314 sends RTP multiplexed encoded video and audio packets to the RTP packet priority queue 316. Moreover, for example, the transmission scheduler 318 sends RTP multiplexed encoded video and audio packets (e.g., retrieved from the RTP packet priority queue 316) to the first UDP socket address port 330. Also, for example, the ultra-low latency interactive source 304 receives controller input data from and sends haptic data to controller handler 332. Even further, for example, the controller handler 332 receives controller input data from and sends haptic data to the second UDP socket address port 334.

In some embodiments, the network congestion controller 320 includes at least one of the following: packet response datastore 1 322, packet response datastore 2 324, RTCP response router 328, RTCP reporting system 326, combinations of the same, or the like. For example, the first UDP socket address port 330 sends RTCP packets with a source IP address to the network congestion controller 320 (e.g., the RTCP response router 328 of the network congestion controller 320) as well as source IP address of new or terminated connections to the network congestion controller 320 (e.g., the RTCP reporting system of the network congestion controller 320). Also, for example, the RTCP response router 328 sends the RTCP packets for the first source (e.g., for the connection via the mobile network 336) to the packet response datastore 1 322 and the RTCP packets for the second source (e.g., for the connection via the wired/wireless fixed line network 338) to the packet response datastore 2 324. Moreover, for example, the transmission scheduler 318 sends, to the network congestion controller 320, at least one of the following: a synchronization source identifier (SSRC), a transmission timestamp (TS_{TX}), a sequence number (RTP_{SN}), a RTP packet size (RTP_{size}), combinations of the same, or the like.

In some embodiments, the client device 302 includes at least one of the following: an ultra-low latency video client application 340, a video renderer 382 (e.g., that produces a rendered video frame 384), an audio renderer 388 (e.g., that produces a rendered audio frame 390), combinations of the same, or the like. In some embodiments, the ultra-low latency video client application 340 includes at least one of the following components: a mobile modem 352, a mobile driver 354, a Wi-Fi driver 356, a Wi-Fi modem 358, a Wi-Fi management application 360, a dual network RTP receiver 342, a video decoder 380, an audio decoder 386, a controller mobile UDP socket address port 392 (e.g., connected to the second UDP socket address port 334 via the mobile network 336), a controller Wi-Fi UDP socket address port 394 (e.g., connected to the second UDP socket address 334 via the Wi-Fi network 338), a controller data transmission module 396, combinations of the same, or the like.

In some embodiments, the dual network RTP receiver includes at least one of the following: a mobile receiver instance 346, a Wi-Fi receiver instance 348, a network selector 350, an RTP demultiplexer 378, combinations of the same, or the like. In some embodiments, the mobile receiver instance 346 includes at least one of the following: a mobile UDP socket 362 (e.g., connected to the first UDP socket address port 330 via the mobile network 336); a first transmission receiver 364; a first RTP packet buffer 366 (e.g., with a size of a single RTP packet); combinations of the same; or the like. In some embodiments, the Wi-Fi receiver instance 348 includes at least one of the following: a Wi-Fi UDP socket 362 (e.g., connected to the first UDP socket address port 330 via the Wi-Fi network 338); a second transmission receiver 364; a second RTP packet buffer 366 (e.g., with a size of a single RTP packet); combinations of the same; or the like. In some embodiments, the network selector 350 includes a connection manager 374 and/or a packet sender 376 in connection with the first RTP packet buffer 366 and second RTP packet buffer 372.

For example, the mobile modem 352 sends RTP multiplexed encoded video and audio packets (e.g., received from the first UDP socket address port 330 over the mobile network 336) to the mobile UDP socket 364 of the mobile receiver instance 346. Further, for example, the mobile UDP socket 364 sends the RTP multiplexed encoded video and audio packets to the first transmission receiver 364, which then sends the packets to the first RTP packet buffer 366. In some embodiments, the first RTP packet buffer 366 sends the RTP multiplexed encoded video and audio packets to the packet sender 376. Moreover, for example, the first transmission receiver 364 reports dropped packets, late arrival packets, identified jitter, and/or identified latency to the connection manager 374 and sends RTCP packets to the mobile UDP socket 362. Additionally, for example, the RTCP packets are sent by the UDP socket 362 to the mobile modem 352 to be transmitted back to the service 300 via the mobile network 366. In some embodiments, the connection manager 374 may instantiate or terminate the mobile receiver instance 346. Even further, for example, the mobile driver 354 sends a mobile received signal strength indicator (RSSI) to the Wi-Fi management application 360.

For example, the Wi-Fi modem 358 sends RTP multiplexed encoded video and audio packets (e.g., received from the first UDP socket address port 330 over the Wi-Fi network 338) to the Wi-Fi UDP socket 368 of the Wi-Fi receiver instance 348. Further, for example, the Wi-Fi UDP socket 368 sends the RTP multiplexed encoded video and audio packets to the second transmission receiver 370, which then sends the packets to the second RTP packet buffer 372. In some embodiments, the second RTP packet buffer 372 sends the RTP multiplexed encoded video and audio packets to the packet sender 376. Moreover, for example, the second transmission receiver 370 reports dropped packets, late arrival packets, identified jitter, and/or identified latency to the connection manager 374 and sends RTCP packets to the Wi-Fi UDP socket 368. Additionally, for example, the RTCP packets are sent by the Wi-Fi UDP socket 368 to the Wi-Fi modem 358 to be transmitted back to the service 300 via the Wi-Fi network 368. In some embodiments, the connection manager 374 may instantiate or terminate the Wi-Fi receiver instance 348. Even further, for example, the Wi-Fi driver 356 sends a Wi-Fi received signal strength indicator (RSSI) to the Wi-Fi management application 360.

In some embodiments, the packet sender 376 sends the RTP multiplexed encoded video and audio packets (e.g., retrieved from the first RTP packet buffer 366 and/or the second RTP packet buffer 372) to the RTP demultiplexer 378 and receives a selected stream multiplexed bitrate from the RTP demultiplexer 378. For example, the RTP demultiplexer 378 sends an encoded video packetized elementary stream (PES) (e.g., determined from the received RTP multiplexed encoded video and audio packets) to the video decoder 380. Likewise, for example, the RTP demultiplexer 378 sends an encoded audio PES (e.g., determined from the received RTP multiplexed encoded video and audio packets) to the audio decoder 386. Further, for example, the video decoder 380 sends decoded video frames to the video renderer 382 and the audio decoder 386 sends decoded audio frames to the audio renderer 388. Moreover, for example, the video renderer 382 generates rendered video frames 284 and the audio renderer 388 generates rendered audio frames 390. In some embodiments, the packet sender 376 sends an in-sync notification and the selected stream bitrate to the connection manager 374. In some embodiments, the Wi-Fi management application 360 receives reporting from the connection manager 374 of dropped packets, late arrival packets, latency, jitter, and/or bitrate associated with packets delivered over both mobile and Wi-Fi networks. In some embodiments, the Wi-Fi management application 360 receives an optimal network request from the connection manager 374 and responds with a determined optimal network (e.g., based on the received mobile RSSI, Wi-Fi RSSI, and/or reporting from the connection manager 374). For example, the Wi-Fi management application 360 sends a network switch notification to the connection manager 374 and the connection manager 374, based on the network switch notification instantiates the mobile receiver instance 346 or the Wi-Fi receiver instance 348.

In some embodiments, the packet sender 376 monitors each of the RTP packet buffers and sends buffered RTP packets to the RTP demultiplexer 278. For example, the dual network RTP receiver 342 includes both a mobile receiver instance 346 and a Wi-Fi receiver instance 348. In such an example, if the mobile RTP packet buffer 366 receives an RTP packet corresponding to the same portion of the content as an RTP packet received by the Wi-Fi RTP packet buffer 372, the packet sender 376 will send the RTP packet that arrived earliest (e.g., based on time of arrival in the corresponding packet buffer). In some embodiments, the packet sender 376 determines that packets are being received (e.g., consistently) from both packet buffers/network connections and sends the in-sync notification to the connection manager 374. In some embodiments, a network connection identified as the connection to leave is terminated by the connection manager 374 and the connection manager 374 terminates the corresponding receiver instance.

In some embodiments, RTCP retransmit requests are only generated for dropped packets if the same packet is dropped at all active receiver instances. In one example, the dual network RTP receiver 342 includes both a mobile receiver instance 346 and a Wi-Fi receiver instance 348 and an RTP packet arrives with a skipped sequence number at the mobile receiver instance 346 but no skipped sequence number is identified at the Wi-Fi receiver instance 348. In this example, a RTCP retransmit request may be suppressed. For example, the determination of the RTP packet with the skipped sequence number at mobile receiver instance 346 and the RTP packet without the skipped sequence number at Wi-Fi receiver instance 348 is used to determine whether it is safe to transition to a second network (e.g., the mobile network 336) during a transition from a first network (e.g., the Wi-Fi network 338) to the second network. Further, for example, the packet sender 376 determines that it is not safe to transition to the second network (e.g., mobile network 336) based on the determination of the RTP packet with the skipped sequence number at mobile receiver instance 346 and the RTP packet without the skipped sequence number at Wi-Fi receiver instance 348. Moreover, for example, the packet sender 376 upon determining that it is not safe to transition to the second network sends an indication that it is not safe to transition to the second network to the connection manager 374, which may terminate the network switching process.

In some embodiments, the RTP demultiplexer 378 calculates the RTP multiplexed bitrate. For example, the RTP multiplexed bitrate is calculated based on a total packet size. Further, for example, the total packet size is based on at least one of the following: a RTP header size (e.g., 12 bytes); a payload (e.g., 1440-1460 bytes per RTP packet for payload based on IP version for standard networks); UDP header size (e.g., 8 bytes); IP header size (e.g., 20 bytes for IPv4); combinations of the same or the like. In one example, the total packet size is the sum of the RTP header size, payload size, UDP header size, and IP header size. In another example, multiple payloads are multiplexed and the payload size is the sum of individual payloads and any additional multiplexing headers or markers. In some embodiments, the RTP multiplexed bitrate is the product of the packet size (e.g., in bits) and the packet rate (e.g., in number of packets per second). In some embodiments, the RTP multiplexed bitrate changes based on changes in the requested video encoded bitrate. For example, requests for changes video encoded bitrate are made by the rate and video encoding properties controller 312 based on a change in size of the RTP packet priority queue 316.

In some embodiments, the controller input data is sent to the service 300 and the haptic data is received from the service 300 via one of a mobile controller UDP socket 392 in connection with a mobile modem and a mobile driver (e.g., mobile modem 352 and mobile driver 354, or the like) or a Wi-Fi controller UDP socket 394 in connection with a Wi-Fi modem and a Wi-Fi driver (e.g., Wi-Fi modem 358 and Wi-Fi driver 356, or the like). For example, the controller UDP socket (e.g., mobile controller UDP socket 392 or Wi-Fi controller UDP socket 394) sends received haptic data to the controller data transmission module 396, which sends the haptic data to a controller 398 (e.g., a remote controller via Bluetooth). Further, for example, the controller 398 sends controller input to the controller data transmission module 396, which sends the controller input to the controller UDP socket. In some embodiments, the controller data transmission module 396 receives an indication that a receiver instance is being terminated or has been terminated and switches to the selected network (e.g., selected by the Wi-Fi management application 360 and/or the connection manager 374). For example, the controller data transmission module 396 provides controller input data to (e.g., and receives haptic data from) the service 300 via the controller mobile UDP socket 392 over the mobile network 336. In this example, the controller data transmission module 396 receives an indication that the mobile receiver instance 346 has been terminated and switches to providing controller input data (e.g., and receiving haptic data) via the controller Wi-Fi UDP socket 394 over the Wi-Fi network 338.

In some embodiments, the first UDP socket address port 330 transmits RTP multiplexed encoded video and audio packets over the mobile network 336 to the mobile modem 352 of the client device 302. In some embodiments, the first UDP socket address port 330 receives RTCP packets with a corresponding source IP address via the mobile network 336 from the mobile modem 352 of the client device 302. In some embodiments, the first UDP socket address port 330 transmits RTP multiplexed encoded video and audio packets over the Wi-Fi network 338 to the Wi-Fi modem 358 of the client device 302. In some embodiments, the first UDP socket address port 330 receives RTCP packets with a corresponding source IP address via the Wi-Fi network 338 from the Wi-Fi modem 358 of the client device 302.

In some embodiments, the second UDP socket address port 334 transmits controller input and receives haptic data by one of: the mobile network 336 to a mobile modem (e.g., mobile modem 352 or the like) of the client device 302; the Wi-Fi network 338 to a Wi-Fi modem (e.g., Wi-Fi modem 358 or the like) of the client device 302.

FIG. 3B is a schematic example of an ultra-low latency content delivery system for performing receiver-directed network migration without a Wi-Fi Management Application (WMA), in accordance with embodiments of the disclosure.

As shown in FIG. 3B, the steps described herein may be performed using a modified ultra-low latency content delivery system 321 that does not include a Wi-Fi management application (e.g., Wi-Fi management application 360 of FIG. 3A). In some embodiments, the client device 303 may include a modified ultra-low latency video client application 341, which includes a modified dual network RTP receiver 343. In some embodiments, the modified dual network RTP receiver 343 includes a connection manager 374 that provides additional functionality and control over the network switching process. In addition to any of the functions described in connection with the connection manager 374 of FIG. 3A, the connection manager 374 may perform at least one of the following: receiving an indication of receiver instance termination from packet sender 376; receiving mobile quality reporting from mobile driver 354; receiving Wi-Fi quality reporting from Wi-Fi driver 356; reporting dropped packets with RTCP retransmit packet window requests (e.g., for each receiver instance) to packet sender 376; combinations of the same; or the like. In some embodiments, the connection manager 374 determines to instantiate or terminate a receiver instance based on at least one of: reported dropped packets, late arrival packets, identified latency, identified jitter, selected stream bitrate, mobile quality reporting, Wi-Fi quality reporting, indications of receiver instance termination, combinations of the same, or the like.

FIG. 4A is a schematic example of an ultra-low latency content delivery system for performing sender-directed network migration with a Wi-Fi Management Application (WMA), in accordance with embodiments of the disclosure.

As shown in FIG. 4A, in some embodiments, the steps described herein may be performed in connection with a modified SCReAM architecture. For example, the ultra-low latency content delivery system 411 includes a single sender device (e.g. client device 200 of FIG. 2, computing devices 1807, 1808, and 1810 of FIG. 18, computing device 1900 and 1901 of FIG. 19) transmitting both audio and video packets. In some embodiments, the sender device transmits packets including at least one of the following to a receiver device: encoded inertial measurement unit (IMU) data, encoded light detection and ranging (LiDAR)-generated visual or geometry-based point cloud data, encoded MPEG-7 and/or KLV metadata, encoded audio data, encoded visual data, combinations of the same, or the like. Further, for example, a client application running on the sender device supports transmitting such audio and video packets over multiple network connections (e.g., via mobile network 436 and/or wired/wireless fixed line network 438) associated with multiple UDP (e.g., and/or RTP) sockets/ports (e.g., UDP socket address 1 port 1 430 and UDP socket address 2 port 2 431). In some embodiments, a Wi-Fi management application 460 determines to switch networks (e.g., based on received RSSI information from both the mobile driver 454 and Wi-Fi driver 456 as well as a multiplexed bitrate from the RTP multiplexer 410.

In some embodiments, the RTP multiplexer 410 calculates the RTP multiplexed bitrate. For example, the RTP multiplexed bitrate is calculated based on a total packet size. Further, for example, the total packet size is based on at least one of the following: a RTP header size (e.g., 12 bytes); a payload (e.g., 1440-1460 bytes per RTP packet for payload based on IP version for standard networks); UDP header size (e.g., 8 bytes); IP header size (e.g., 20 bytes for IPv4); combinations of the same or the like. In one example, the total packet size is the sum of the RTP header size, payload size, UDP header size, and IP header size. In another example, multiple payloads are multiplexed and the payload size is the sum of individual payloads and any additional multiplexing headers or markers. Moreover, for example, multiplexed data may include encoded video PES packets and/or encoded audio PES packets, IMU data packets, LiDAR-generated encoded geometry-based point cloud PES packets, MPEG-7 or KLV metadata, combinations of the same, or the like. In some embodiments, the RTP multiplexed bitrate is the product of the packet size (e.g., in bits) and the packet rate (e.g., in number of packets per second). In some embodiments, the RTP multiplexed bitrate changes based on changes in the requested video encoded bitrate. For example, requests for changes of video encoded bitrate are made by the rate and video encoding properties controller 412 based on a change in size of the RTP packet priority queue 416. In one example with additional LIDAR data, the requested video encoded bitrate is altered based on setting a bitrate for the geometry-based point cloud encoder.

Moreover, for example, the client device 400 (e.g., and/or client application operating on client device 400) includes a network congestion controller 420 that includes packet response data stores (e.g., packet response data store 1 422, packet response data store 2 424), which stores data for each of the network connections (e.g., storing the last transmitted RTP packet information for each network connection). In one example, the client device 400 includes one data store for each IP address of a connection with the server device 402. In some embodiments, the network congestion controller 420 sends, to the Wi-Fi management application 460, at least one of CWND, RTT/bytes in flight, RTCP retransmit requests (e.g., for each source and/or destination address), indications of dropped/late arrival packets, connection reports, combinations of the same, or the like. In some embodiments, the Wi-Fi management application 460 determines changes in jitter and/or latency based on the received CWND and/or RTT.

In some embodiments, the Wi-Fi management application 460 determines a network switch is needed based on comparing any of the aforementioned information received by the Wi-Fi management application 460 (e.g., RSSI report from network device drivers, multiplexed bitrate from RTP multiplexer 410, jitter and/or latency reports from the network congestion controller 420, or the like) to one or more quality threshold metrics. In some embodiments, based on this determination, the Wi-Fi management application 460 sends a network switch notification to the connection manager 474. In one example, the Wi-Fi management application 460 determines to leave the Wi-Fi network 438 and the connection manager 474 sends a network connection request over the Wi-Fi network 438 to the server device 402 connection manager 475 (e.g., including an address for the first UDP socket address port 430). In another example, the Wi-Fi management application 460 determines to leave the mobile network 436 and the connection manager 474 sends a network connection request over the mobile network 436 to the server device 402 connection manager 475 (e.g., including an address for the second UDP socket address port 431).

In some embodiments, the connection manager 475 of the server device 402 (e.g., server device 202 of FIG. 2, server 1804 of FIG. 18) receives a network connection request with an address port and there is not an active receiver instance connected to the address port. In such embodiments, the connection manager 475 instantiates a new receiver instance and the transmission receiver (e.g., of the new receiver instance) will open a new socket and connect it to the requested address port. In some embodiments, the receiver instance receives RTP packets that include the expected RTP sequence number and transmits an RTCP packet marked successful to client device 400. In some embodiments, the packet sender 476 receives a packet with a sequence number that has already been received from a different receiver instance and discards the newly received packet. In some embodiments, the packet sender 476 receives a packet with a sequence number that has not been received and sends the newly received packet to the RTP demultiplexer 478.

In some embodiments, the client device 400 determines when a connection is initiated or terminated between a receiver instance on the server device 402 and any of the UDP sockets, the network congestion controller 420 instantiates or terminates a corresponding packet response data store for that connection. In one example, the packet response data store 1 422 corresponds to the mobile network 436, the UDP socket 430 determines that the connection with the server device 402 via the mobile network 436 has been terminated, and sends a message to the network congestion controller 420 to terminate packet response data store 1 422.

In some embodiments, the network congestion controller 420 includes an RTCP response router 428 and RTCP reporting system 426. For example, when an RTCP packet is received by the client device 400 for a transmitted RTP packet, the RTCP packet will be placed into a packet response data store (e.g., packet response data store 1 422 or packet response datastore 424) based on a source and/or destination IP address of the RTCP packet (e.g., and/or corresponding RTP packet). In some embodiments, the corresponding packet response data store (e.g., packet response datastore 1 422 or packet response datastore 2 424) reports a CWND and/or RTT (e.g., or bytes in flight) to the RTCP reporting system 426. In some embodiments, the RTCP reporting system 426 waits until there is a CWND and/or RTT (e.g., or bytes in flight) associated with each of the packet response datastores before sending a worst case source and/or destination IP address message (e.g., with a lowest network quality) from the two IP addresses corresponding to the two packet response datastores to the transmission scheduler 418. In some embodiments, the transmission scheduler 418 receives the worst case source and/or destination IP address message and retrieves an RTP packet from the RTP packet priority queue 416 to the transmission scheduler 418 and sends the retrieved RTP packet over the UDP sockets over both (e.g., all) networks to both (e.g., all) receiver instances (e.g., mobile receiver instance 446 and Wi-Fi receiver instance 448) of the server device 402. In some embodiments, both receiver instances receive the same quality encoding based on the worst case client (e.g., reported by the RTCP reporting system 426). In some embodiments, the RTP packet priority queue 416 reports a queue length to the rate and video encoding properties controller 412. In some embodiments, the rate and video encoding properties controller 412 adjusts the bandwidth, resolution, and/or framerate of the encoding based on the queue length and/or the worst case connection (e.g., over the network with the lowest network quality). In some embodiments, upon receipt of an RTCP request for a dropped or late arrival packet sequence number, the RTCP reporting system 426 determines whether the same packet was successfully received over a different socket connection. In some embodiments, the RTCP reporting system 426 sends a RTCP retransmission request to the transmission scheduler 418 based on the packet being dropped and/or arriving late on all connections and the transmission scheduler 418 sends the retransmit RTP packet matching the dropped/late arrival sequence number over all UDP sockets with active connections.

In some embodiments, the dual network RTP receiver 446 has an active connection over multiple networks and for each received packet, the corresponding receiver instance compares the sequence number of the received packet and the previously received packet. In some embodiments, based on a jump in packet numbers, the receiver instance transmits a RTCP retransmit request for each of the skipped packet sequence numbers. In some embodiments, for each successfully received RTP packet, a RTCP success packet is sent by each receiver instance to the client device 400 (e.g., including for packets that are discarded due to the packet sender 476 having already received a packet with the same sequence number from another receiver instance).

In some embodiments, the client device 400 (e.g., and/or client application running on the client device) includes or is associated with at least one of the following components: ultra-low latency video processing system 404 (e.g., with additional audio, IMU, LIDAR data), a dual network RTP sender 440, a mobile modem 452, a mobile driver 454, a Wi-Fi driver 456, a Wi-Fi modem 458, combinations of the same, or the like. In some embodiments, the dual network RTP sender 440 includes at least one of the following components: a video encoder 408, an optional data processor/encoder 406, an RTP multiplexer 410, a rate and video encoding properties control 412, an RTP sender 414, an RTP packet priority queue 416, a transmission scheduler 418, a network congestion controller 420, a first UDP socket address port 430, a connection manager 474, a second UDP socket address port 431, a Wi-Fi management application 460, combinations of the same, or the like. For example, the ultra-low latency client device video processing system 404 sends raw image data to the video encoder 408 and optional sensor data (e.g., audio, IMU, LIDAR, or the like) to the optional data processor/encoder 406. Further, for example, the video encoder 408 sends the encoded video packetized elementary stream (PES) to the RTP multiplexer 410. Also, for example, the optional data processor/encoder 406 sends encoded optional sensor data to the RTP multiplexer 410 and an additional data bitrate to the rate and video encoding properties control 412. Moreover, for example, the RTP multiplexer 410 sends a multiplexed bitrate to the bitrate and video encoding properties controller 412 and both UDP socket address ports. Also, for example, the RTP multiplexer 410 sends RTP multiplexed encoded video and additional data packets (e.g., including a RTP header and RTP payload) to the RTP sender 414. Additionally, for example, the rate and video encoding properties control 412 sends target encoding properties and a target bitrate to the video encoder 408. In some embodiments, the bitrate and video encoding properties control 412 receives a bitrate to encoding properties mapping.

In some embodiments, the client device 400 (e.g., and/or client application) encodes the content based on one or more encoding parameters of remote rendering bitrates (e.g., for codecs). For example, the ultra-low latency encoding is based on a resolution and/or framerate determined from a bitrate to encoding properties mapping. In some embodiments, when the bitrate changes based on network conditions, the rate and video encoding properties controller 412 adjusts the video encoder 408 to a resolution and framerate based on a codec type (e.g., high-efficiency video coding (HEVC), versatile video coding (VVC), advanced video coding (AVC)) for the client device 400 and the current bitrate. In some embodiments, to avoid inserting an IDR frame or I-frame when the video resolution changes, the client device 400 performs reference picture resampling RPR (e.g., for a VVC codec type). For example, during a network transition, the bandwidth may decrease then increase over time, creating a scenario where RPR provides the greatest value. Further, for example, RPR causes a temporary reduction of resolution (e.g., and bitrate) without requiring encoding an IDR. Moreover, for example, the network transition is expected and predictable, providing the client device 400 additional control of triggering the RPR, e.g., in video compression. In some embodiments, when using HEVC and/or AVC codec types, the client device 400 performs video pre-processing (e.g., using low-pass filtering to reduce high frequencies and signal complexities) to avoid inserting IDR frames. For example, the client device 400 performs the video pre-processing based on observing reduced bitrate of a network connection, which may trigger a change in resolution or reduction in signal complexity for video compression.

For example, the RTP sender 414 sends RTP multiplexed encoded video and additional data packets to the RTP packet priority queue 416. Moreover, for example, the transmission scheduler 418 sends RTP multiplexed encoded video and additional data packets (e.g., retrieved from the RTP packet priority queue 416) to the first UDP socket address port 430 and the second UDP socket address port 431. Also, for example, the mobile driver 454 reports a mobile RSSI to the Wi-Fi management application 460. Likewise, for example, the Wi-Fi driver 456 reports a Wi-Fi RSSI to the Wi-Fi management application 460. Even further, for example, the connection manager 474 requests an optimal network from the Wi-Fi management application 460 and the Wi-Fi management application 460 determines the optimal network (e.g., based on received mobile RSSI, Wi-Fi RSSI, multiplexed bitrate, CWND, RTT/bytes in flight, RTCP retransmit requests or the like) and reports the optimal network to the connection manager 474. In some embodiments, the Wi-Fi management application 460 sends a network switch notification to the connection manager 474.

In some embodiments, the connection manager 474 sends requests to open or close a particular UDP socket address port (e.g., UDP socket address port 1 430, UDP socket address port 2 431). In one example, the connection manager 474 sends a request to open the second UDP socket address port 431 based on receiving an indication to switch to sending packets over the Wi-Fi network 438. In some embodiments, the particular UDP socket address port responds to the connection manager 474 to indicate that the socket has been successfully opened or closed. In some embodiments, while the UDP socket address port is open, it sends RTP packets (e.g., the RTP multiplexed encoded video and additional data packets received from the transmission scheduler 418) and receives RTCP packet via the corresponding modem and network. For example, the first UDP socket address port 430 sends RTP packets and receives RTCP packet via the mobile modem 452 over the mobile network 436. Likewise, for example, the second UDP socket address port 431 sends RTP packets and receives RTCP packets via the Wi-Fi modem 458 and Wi-Fi network 438. In some embodiments, the UDP socket address ports do not send or receive any packets when it is closed (e.g., by the connection manager 474).

In some embodiments, the network congestion controller 420 includes at least one of the following: packet response datastore 1 422, packet response datastore 2 424, RTCP response router 428, RTCP reporting system 426, combinations of the same, or the like. For example, the first UDP socket address port 430 sends RTCP packets with a corresponding source and destination IP address to the network congestion controller 420 (e.g., the RTCP response router 428 of the network congestion controller 320). Likewise, for example, the second UDP socket address port 431 sends RTCP packets with a corresponding source and destination IP address to the network congestion controller 420 (e.g., the RTCP response router 428 of the network congestion controller 320). Further, for example, the connection manager 474 sends source IP address of new or terminated connections to the network congestion controller 420 (e.g., the RTCP reporting system 426 of the network congestion controller 420). Also, for example, the RTCP response router 428 sends the RTCP packets for the first source and destination (e.g., for the connection via the mobile network 436) to the packet response datastore 1 422 and the RTCP packets for the second source and destination (e.g., for the connection via the wired/wireless fixed line network 438) to the packet response datastore 2 424. Moreover, for example, the transmission scheduler 418 sends, to the network congestion controller 420 (e.g., to the corresponding packet response data store), at least one of the following: a synchronization source identifier (SSRC), a transmission timestamp (TS_{Tx}), a sequence number (RTP_{SN}), a RTP packet size (RTP_{size}), combinations of the same, or the like. Additionally, for example, the RTCP reporting system 426 sends a safe connection notification (e.g., including a destination address and source address) to the connection manager 474. Moreover, for example, the RTCP reporting system 426 reports, to the Wi-Fi management function 460 at least one of: CWND, RTT (e.g., or bytes in flight), RTCP retransmit request, combinations of the same, or the like for each source-destination pair. Even further, for example, the RTCP reporting system 426 reports, to the transmission scheduler 418 at least one of: CWND, RTT (e.g., or bytes in flight), worst case/lowest quality network information, RTCP retransmit requests, RTCP acknowledgements, combinations of the same, or the like.

In some embodiments, the connection manager 474 sends a Wi-Fi network connection request (e.g., including an address port) via the mobile modem 452 over the mobile network 436 to connection manager 475 of the server device 402. In some embodiments, the connection manager 474 sends a mobile network connection request (e.g., including an address port) via the Wi-Fi modem 458 over the Wi-Fi network 438 to connection manager 475 of the server device 402.

In some embodiments, a server device 402 operates a cloud-based ultra-low latency service 442 including at least one of the following: a dual network RTP receiver 442, an ultra-low latency video processing system (e.g., with additional data capabilities including audio, IMU, geometry-based point cloud, MPEG-7 or KLV metadata, or the like), combinations of the same, or the like.

In some embodiments, the dual network RTP receiver 442 includes at least one of the following: a mobile receiver instance 446, a Wi-Fi receiver instance 448, a connection manager 475, a packet sender 476, a RTP demultiplexer 478, a video decoder 480, an audio decoder 486, a point cloud decoder 485, combinations of the same, or the like. In some embodiments, the mobile receiver instance 446 includes at least one of the following: a mobile UDP socket 462 (e.g., connected to the first UDP socket address port 430 via the mobile network 436); a first transmission receiver 464; a first RTP packet buffer 466 (e.g., with a size of a single RTP packet); combinations of the same; or the like. In some embodiments, the Wi-Fi receiver instance 448 includes at least one of the following: a Wi-Fi UDP socket 468 (e.g., connected to the second UDP socket address port 431 via the Wi-Fi network 438); a second transmission receiver 470; a second RTP packet buffer 472 (e.g., with a size of a single RTP packet); combinations of the same; or the like.

For example, the mobile UDP socket 462 of the mobile receiver instance 446 receives RTP multiplexed encoded video and additional data packets (e.g., from the first UDP socket address port 430 over the mobile network 436). Further, for example, the mobile UDP socket 462 sends the RTP multiplexed encoded video and additional data packets to the first transmission receiver 464, which then sends the packets to the first RTP packet buffer 466. In some embodiments, the first RTP packet buffer 466 sends the RTP multiplexed encoded video and additional data packets to the packet sender 476. Moreover, for example, the first transmission receiver 464 sends RTCP packets to the mobile UDP socket 462. Additionally, for example, the RTCP packets are sent by the UDP socket 462 over the mobile network 366 to the mobile modem 452 of the client device 400. In some embodiments, the connection manager 475 receives a network connection request with an address port from the client device 400. For example, based on the address port of the network connection request, the connection manager 475 instantiates or terminates either of the receiver instances. Further, for example, the connection manager 475 sends the network connection request to the transmission receiver of the corresponding receiver instance (e.g., mobile network connection request to mobile receiver instance 446). Moreover, for example, the first transmission receiver 464 sends the network connection request to the mobile UDP socket 462 to initiate a connection over the mobile network 436 (e.g., based on the address port included in the network connection request). In some embodiments, the connection manager 475 may instantiate or terminate the mobile receiver instance 446. In some embodiments, the first transmission receiver 464 sends an indication that the receiver instance port has been disconnected (e.g., upon identification that a connection has been terminated with the first UDP socket 462).

For example, the Wi-Fi UDP socket 468 of the Wi-Fi receiver instance 448 receives RTP multiplexed encoded video and additional data packets (e.g., from the second UDP socket address port 431 over the Wi-Fi network 438). Further, for example, the Wi-Fi UDP socket 468 sends the RTP multiplexed encoded video and additional data packets to the second transmission receiver 470, which then sends the packets to the second RTP packet buffer 472. In some embodiments, the second RTP packet buffer 472 sends the RTP multiplexed encoded video PES and additional data packets to the packet sender 476. Moreover, for example, the second transmission receiver 470 sends RTCP packets to the Wi-Fi UDP socket 468. Additionally, for example, the RTCP packets are sent by the second UDP socket 468 over the Wi-Fi network 436 to the Wi-Fi modem 458 of the client device 400. In some embodiments, the connection manager 475 receives a network connection request with an address port from the client device 400. For example, based on the address port of the network connection request, the connection manager 475 instantiates or terminates either of the receiver instances. Further, for example, the connection manager 475 sends the network connection request to the transmission receiver of the corresponding receiver instance (e.g., Wi-Fi network connection request to Wi-Fi receiver instance 448). Moreover, for example, the second transmission receiver 468 sends the network connection request to the Wi-Fi UDP socket 468 to initiate a connection over the Wi-Fi network 438 (e.g., based on the address port included in the network connection request). In some embodiments, the connection manager 475 may instantiate or terminate the Wi-Fi receiver instance 448. In some embodiments, the second transmission receiver 468 sends an indication that the receiver instance port has been disconnected (e.g., upon identification that a connection has been terminated with the second UDP socket 468).

In some embodiments, the packet sender 476 sends the RTP multiplexed encoded video and additional data packets (e.g., retrieved from the first RTP packet buffer 466 and/or the second RTP packet buffer 472) to the RTP demultiplexer 478. For example, the packet sender 476 sends a mobile packet buffer RTP sequence number to the second transmission receiver 470 and a Wi-Fi packet buffer RTP sequence number to the first transmission receiver 464 (e.g., for inclusion in RTCP packets). Further, for example, the RTP demultiplexer 478 sends an encoded video packetized elementary stream (PES) (e.g., determined from the received RTP multiplexed encoded video and additional data packets) to the video decoder 480. Likewise, for example, the RTP demultiplexer 478 sends an encoded audio PES (e.g., determined from the received RTP multiplexed encoded video and additional data packets) to the audio decoder 486. Likewise, for example, the RTP demultiplexer 478 sends an encoded point cloud PES (e.g., determined from the received RTP multiplexed encoded video and additional data packets) to the point cloud decoder 485. Additionally, for example, RTP demultiplexer 478 sends IMU data and/or KLV or MPEG-7 metadata (e.g., determined from the received RTP multiplexed encoded video and additional data packets) to the ultra-low latency video processing system 482. Moreover, for example, the IMU data may include at least one of: acceleration, angular rate, inclination, speed, combinations of the same, or the like. For example, the video decoder 480 sends decoded video frames to the ultra-low latency video processing system 482 and the audio decoder 386 sends decoded audio frames to the ultra-low latency video processing system 482.

In some embodiments, the packet sender 476 monitors each of the RTP packet buffers and sends buffered RTP packets to the RTP demultiplexer 478. For example, the dual network RTP receiver 442 includes both a mobile receiver instance 446 and a Wi-Fi receiver instance 448. In such an example, if the mobile RTP packet buffer 466 receives an RTP packet corresponding to the same portion of the content as an RTP packet received by the Wi-Fi RTP packet buffer 472, the packet sender 476 will send the RTP packet that arrived earliest (e.g., based on time of arrival in the corresponding packet buffer). In some embodiments, the packet sender determines that packets are being received (e.g., consistently) from both packet buffers/network connections and sends the in-sync notification to the connection manager 374.

In some embodiments, RTCP retransmit requests are only generated for dropped packets if the same packet is dropped at all active receiver instances. In one example, the dual network RTP receiver 442 includes both a mobile receiver instance 446 and a Wi-Fi receiver instance 448 and an RTP packet arrives with a skipped sequence number at the mobile receiver instance 446 but no skipped sequence number is identified at the Wi-Fi receiver instance 448. In this example, a RTCP retransmit request may be suppressed.

In some embodiments, the first UDP socket address port 430 transmits RTP multiplexed encoded video and additional data packets over the mobile network 436 to the mobile receiver instance 446 of the server device 402. In some embodiments, the first UDP socket address port 430 receives RTCP packets with a corresponding source IP address via the mobile network 436 from the mobile receiver instance 446 of the server device 402 In some embodiments, the first UDP socket address port 430 transmits RTP multiplexed encoded video and additional data packets over the Wi-Fi network 438 to the Wi-Fi receiver instance 448 of the server device 402. In some embodiments, the first UDP socket address port 430 receives RTCP packets with a corresponding source IP address via the Wi-Fi network 438 from the Wi-Fi receiver instance 448 of the server device 402.

In some embodiments, the second UDP socket address port 431 transmits RTP multiplexed encoded video and additional data packets over the mobile network 436 to the mobile receiver instance 446 of the server device 402. In some embodiments, the second UDP socket address port 431 receives RTCP packets with a corresponding source IP address via the mobile network 436 from the mobile receiver instance 446 of the server device 402 In some embodiments, the second UDP socket address port 431 transmits RTP multiplexed encoded video and additional data packets over the Wi-Fi network 438 to the Wi-Fi receiver instance 448 of the server device 402. In some embodiments, the second UDP socket address port 431 receives RTCP packets with a corresponding source IP address via the Wi-Fi network 438 from the Wi-Fi receiver instance 448 of the server device 402.

FIG. 4B is a schematic example of an ultra-low latency content delivery system for performing sender-directed network migration without a Wi-Fi Management Application (WMA), in accordance with embodiments of the disclosure.

As shown in FIG. 4B, the steps described herein may be performed using a modified ultra-low latency content delivery system 421 that does not include a Wi-Fi management application (e.g., Wi-Fi management application 460 of FIG. 4A). In some embodiments, the client device 401 (e.g., and/or client application operating on client device 401) may include a modified dual network RTP sender 441. In some embodiments, the modified dual network RTP sender 441 includes a connection manager 474 that provides additional functionality and control over the network switching process. In addition to any of the functions described in connection with the connection manager 474 of FIG. 4A, the connection manager 474 may additionally receive mobile quality reporting from mobile driver 454 and/or receive Wi-Fi quality reporting from Wi-Fi driver 456. In some embodiments, the connection manager 374 determines to switch networks (e.g., and open or close a UDP socket) based on at least one of: RTCP reporting (e.g., CWND, RTT/bytes in flight, connection reports, or the like), multiplexed bitrate reporting, mobile quality reporting, Wi-Fi quality reporting, combinations of the same, or the like. In some embodiments, the connection manager 474 determines a quality of service (QoS) for each connection and uses a determined bandwidth, packet loss, jitter, and/or latency of each connection to determine when to switch networks.

For example, mobile quality reporting (e.g., through APIs) may include at least one of the following metrics: received signal strength indicator (RSSI), reference signal received power (RSRP), reference signal received quality (RSRQ), signal-to-interference-plus-noise ratio (SINR), combinations of the same, or the like. Further, for example, Wi-Fi quality reporting (e.g., through APIs) may include RSSI and/or SINR.

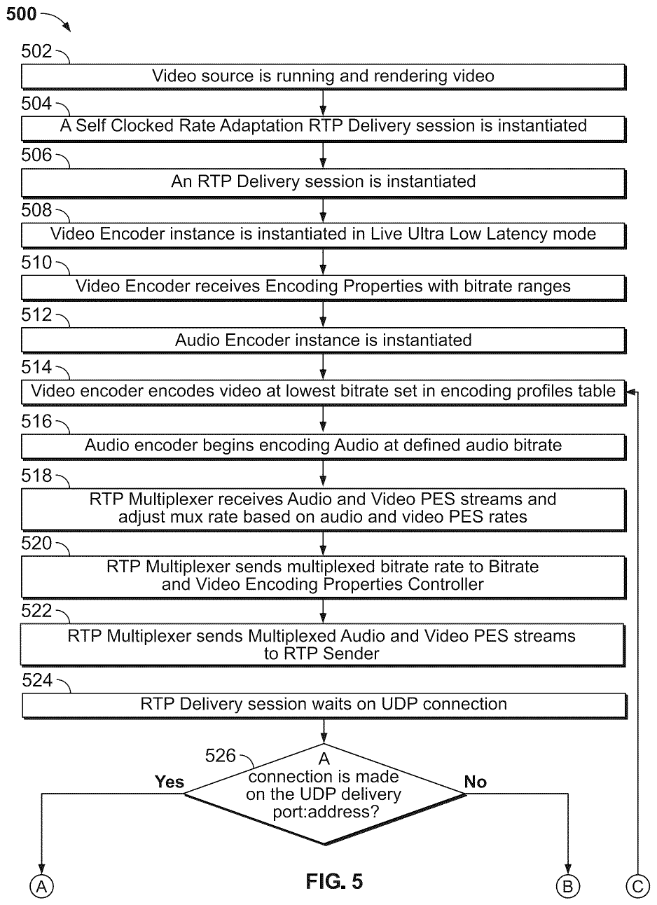

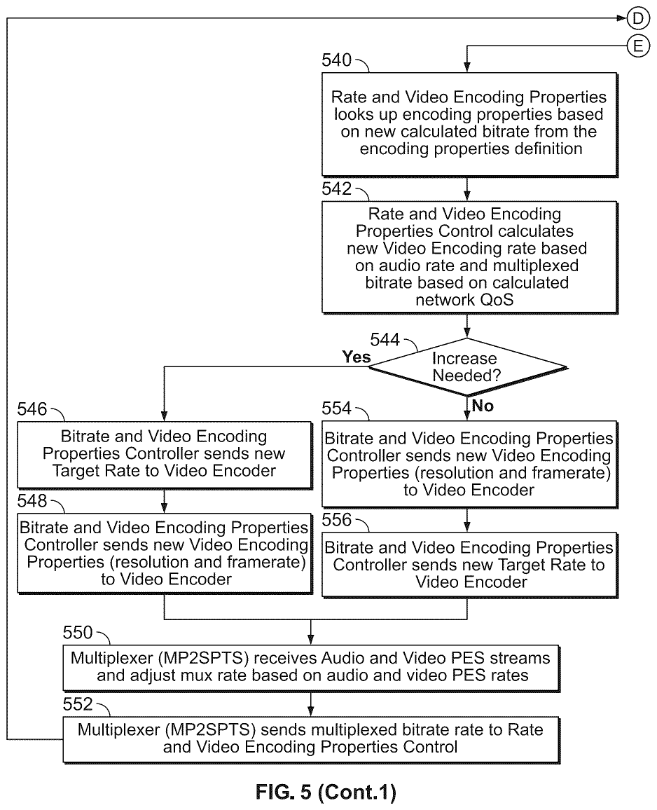

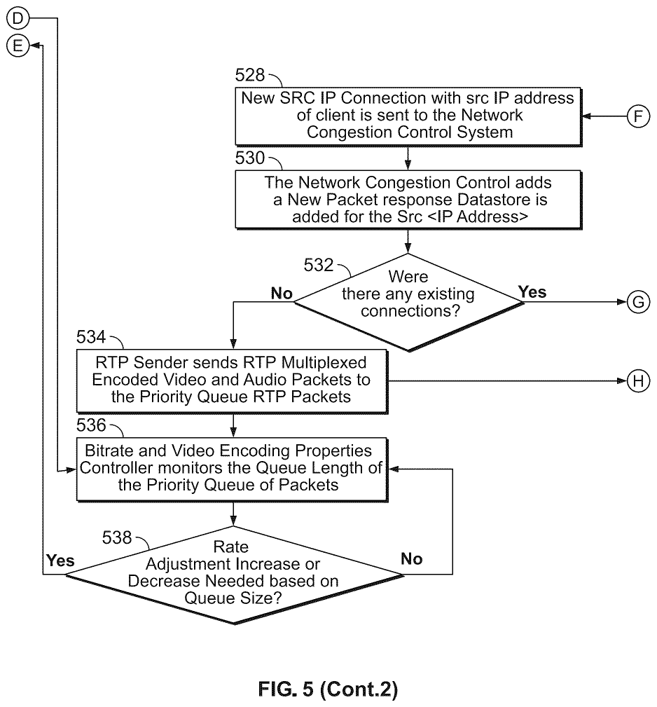

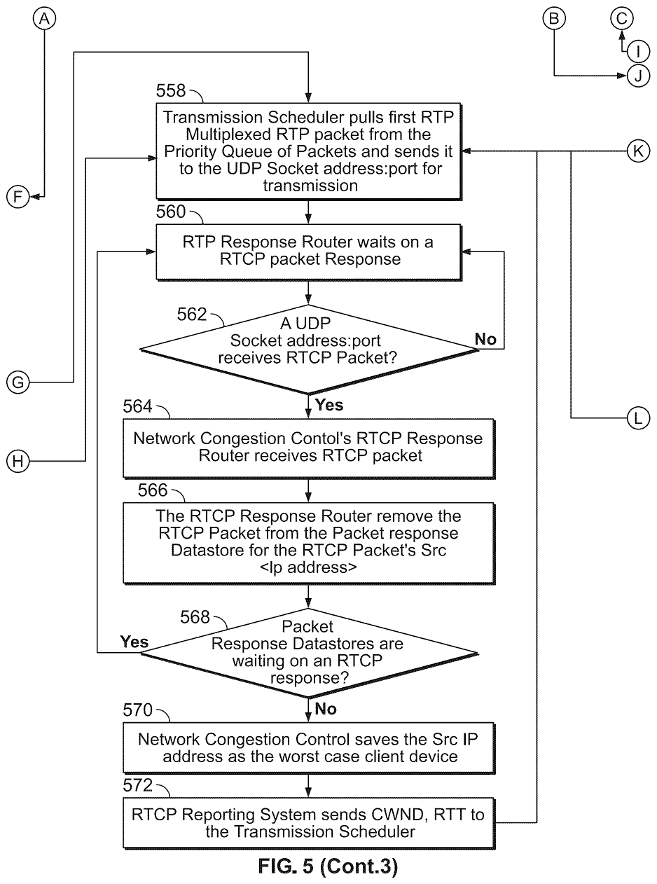

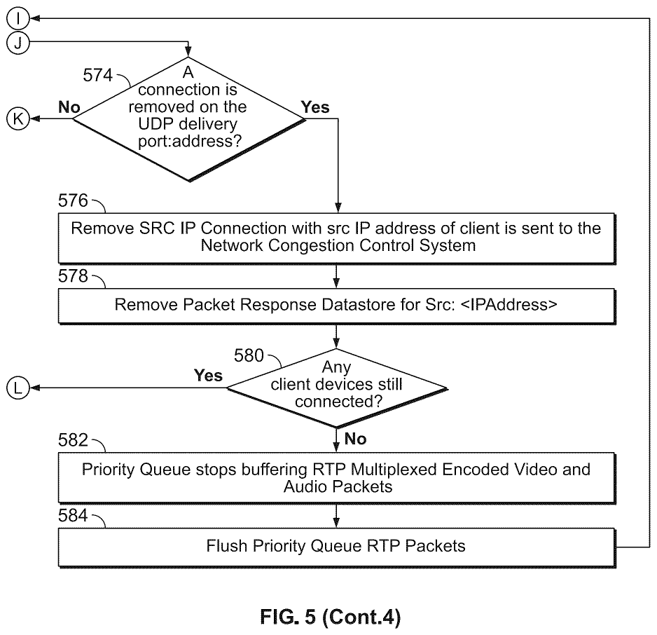

FIG. 5 is a flowchart of an illustrative process for managing multiple network connections with a client device, in accordance with some embodiments of this disclosure. In various embodiments, the individual steps of process 500 are implemented by one or more components of the devices, methods, and systems of FIGS. 1-22 and are performed in combination with any of the other processes and aspects described herein. Although the present disclosure may describe certain steps of process 500 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 502, a video source is running and rendering video (e.g., on or associated with a server device). At step 504, a self-clocked rate adaptation RTP delivery session is instantiated (e.g., on or associated with the server device). At step 506, an RTP delivery session is instantiated (e.g., on or associated with the server device). At step 508, a video encoder instance is instantiated in ultra-low latency mode (e.g., on or associated with the server device). At step 510, the video encoder receives encoding properties with bitrate ranges. At step 512, an audio encoder instance is instantiated (e.g., on or associated with the server device). At step 514, the video encoder encodes video at a lowest bitrate set by an encoding profiles table. At step 516, the audio encoder begins encoding audio at a defined audio bitrate. At step 518, a RTP multiplexer receives audio and video PES streams and adjusts a multiplexing rate based on audio and video PES rates. At step 520, the RTP multiplexer sends a multiplexed bitrate to a rate and video encoding properties controller. At step 522, the RTP multiplexer sends multiplexed audio and video PES streams to an RTP sender. At step 524, the RTP delivery session waits on a UDP connection. The process 500 then proceeds to decision block 526.

At decision block 526, if a connection is made on the UDP delivery port address, the process 500 proceeds to step 528. At decision block 526, if no connection is made on the UDP delivery port address, the process 500 proceeds to decision block 574. At step 528, a new source IP connection is established and the source IP address associated with the client device is sent to the network congestion controller. At step 530, the network congestion controller adds a new packet response datastore for the source IP address. The process then proceeds to decision block 532.

At decision block 532, if any existing connections exist, the process 500 proceeds to step 558. At decision block 532, if no existing connections exist, the process 500 proceeds to step 534. At step 534, the RTP sender sends RTP multiplexed encoded video and audio packets to the RTP packet priority queue. At step 534, the process 500 may proceed to either step 536 or step 538, or perform both steps simultaneously. At step 536, the rate and video encoding properties controller monitors the queue length of the RTP packet priority queue. The process 500 then proceeds to decision block 538.

At decision block 538, if a bitrate adjustment is needed based on queue size, the process 500 proceeds to step 540. At decision block 538, if a bitrate adjustment is not needed based on queue size, the process 500 returns to step 536. At step 540, the rate and video encoding properties controller looks up encoding properties based on a new calculated bitrate from defined encoding properties. At step 542, the rate and video encoding properties controller calculates a new video encoding bitrate based on audio rate and multiplexed bitrate based on a calculated network QoS. The process 500 then proceeds to decision block 544.

At decision block 544, if an increase in bitrate is needed, the process 500 proceeds to step 546. At decision block 544, if an increase in bitrate is not needed, the process 500 proceeds to step 554. At step 546, the rate and video encoding properties controller sends the new target bitrate to the video encoder. At step 548, the rate and video encoding properties controller sends new video encoding properties (e.g., resolution and framerate) to the video encoder. At step 550, the multiplexer receives audio and video PES streams and adjusts the multiplexing bitrate based on the audio and video PES streams. At step 552, the multiplexer sends the multiplexed bitrate to the rate and video encoding properties controller. The process 500 then returns to step 536.

At step 554, the rate and video encoding properties controller sends new video encoding properties (e.g., resolution and framerate) to the video encoder. At step 556, the rate and video encoding properties controller sends the new target bitrate to the video encoder. The process then proceeds to step 550.

At step 558, the transmission scheduler pulls a first multiplexed RTP packet from the RTP packet priority queue an sends it to the UDP socket address port for transmission. At step 560, the RTP response router waits on a RTCP packet response. The process 500 then proceeds to decision block 562.

At decision block 562, if the UDP socket address port receives an RTCP packet the process proceeds to step 564. At decision block 562, if the UDP socket does not receive an RTCP packet the process returns to step 560. At step 564, the network congestion controller RTCP response router receives the RTCP packet. At step 566, the RTCP response router removes the RTCP packet from the packet response datastore for the RTCP packet's source IP address. The process 500 then proceeds to decision block 568.

At decision block 568, if the packet response datastores are waiting on an RTCP response, the process 500 returns to step 560. At decision block 568, if the packet response datastores are not waiting on an RTCP response, the process proceeds to step 570. At step 570, the network congestion controller saves the source IP address as the worst case client device. At step 572, the RTCP reporting system sends CWND and/or RTT to the transmission scheduler. At step 572, the process 500 returns to step 558.

At decision block 574, if a connection is not removed on the UDP delivery port address, the process 500 proceeds to step 558. At decision block 574, if a connection is removed on the UDP delivery port address, the process proceeds to step 576. At step 576, the removed connection source IP address is sent to the network congestion controller. At step 578, the packet response datastore for the source IP address is removed. The process 500 then proceeds to decision block 580.

At decision block 580, if any client devices are connected, the process proceeds to step 558. At decision block 580, if no client devices are connected, the process proceeds to step 582. At step 582, the priority queue stops buffering RTP multiplexed encoded video and audio packets. At step 584, the RTP packet priority queue is flushed. The process 500 then returns to step 514.

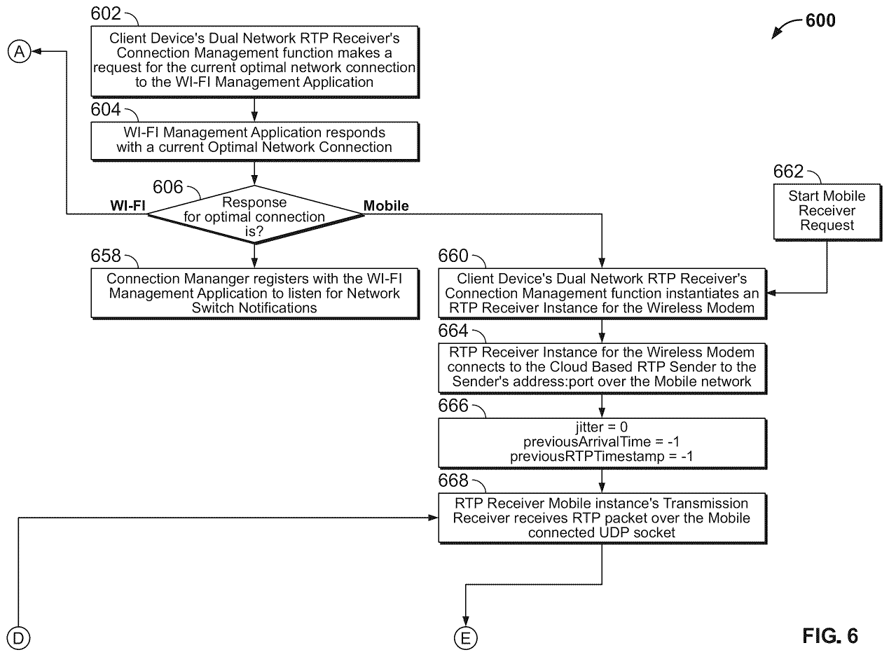

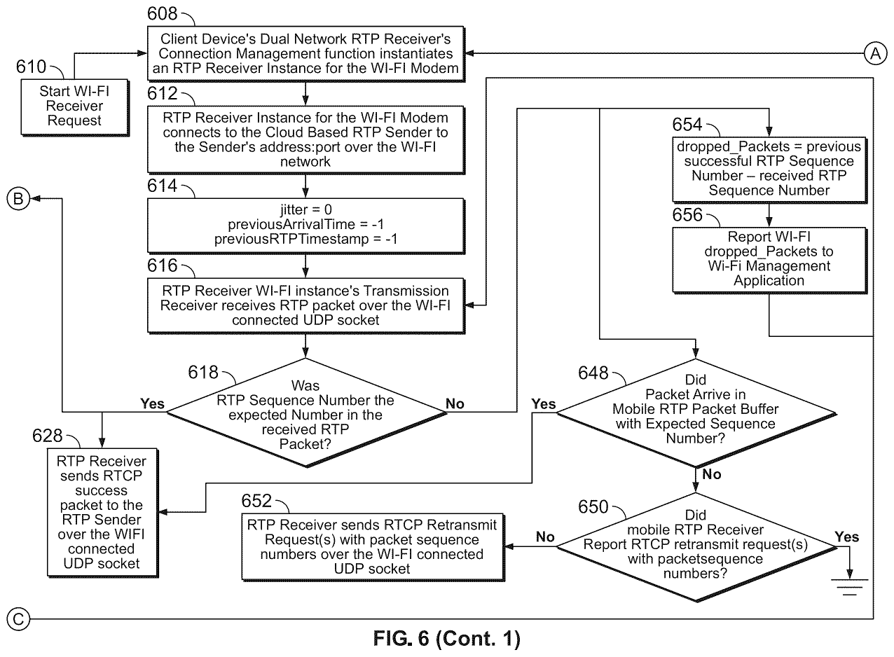

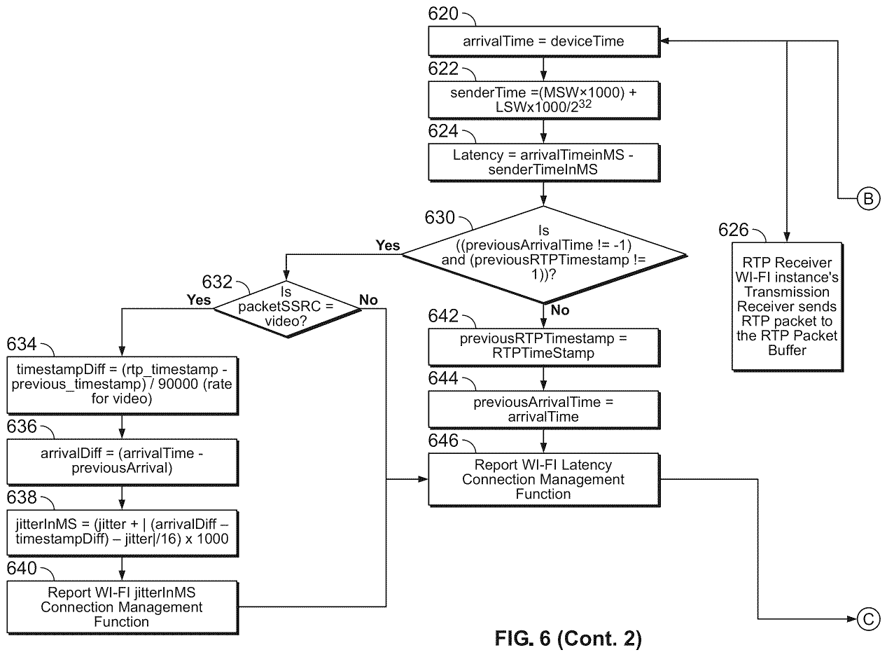

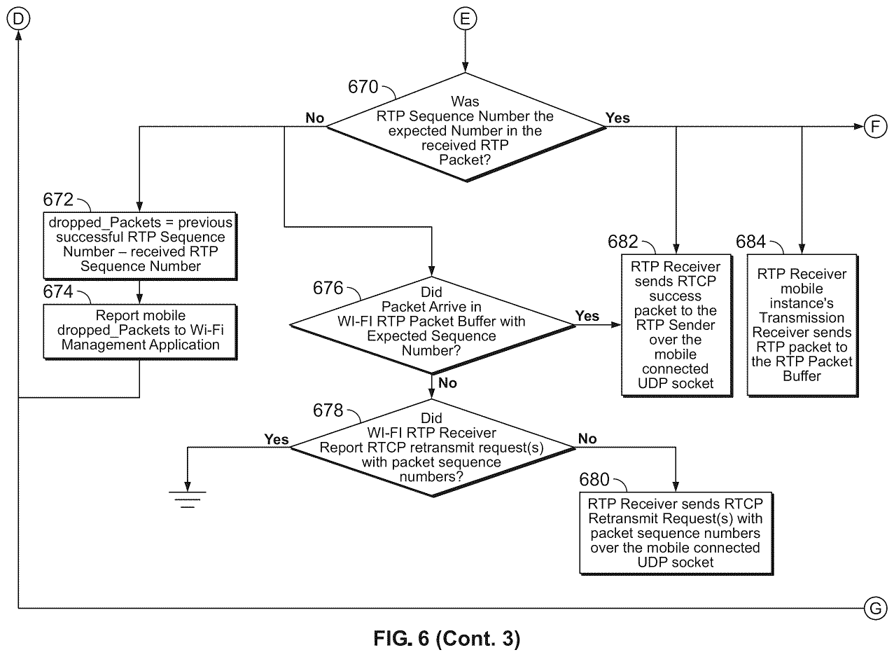

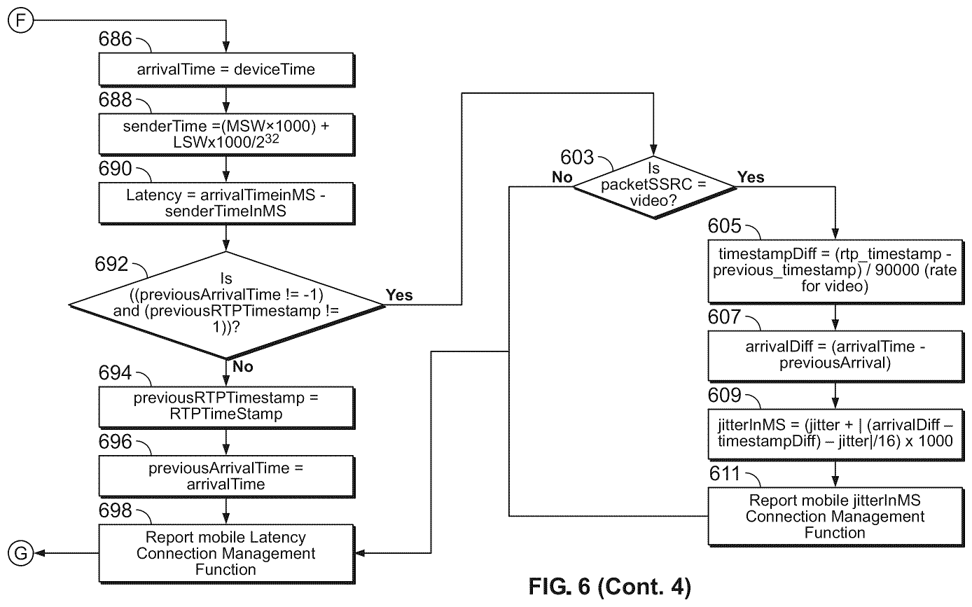

FIG. 6 is a flowchart of an illustrative process for starting up a Wi-Fi or mobile receiver instance upon startup of an ultra-low latency video session, in accordance with some embodiments of this disclosure. In various embodiments, the individual steps of process 600 are implemented by one or more components of the devices, methods, and systems of FIGS. 1-22 and are performed in combination with any of the other processes and aspects described herein. Although the present disclosure may describe certain steps of process 600 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 602, the client device's dual network RTP receiver's connection manager makes a request for the current optimal network connection to the Wi-Fi management application. At step 604, the Wi-Fi management application responds with a current optimal network connection. The process 600 then proceeds to decision block 606.

At decision block 606, if the response for the optimal connection indicates a Wi-Fi connection, the process 600 proceeds to step 608. At decision block 606, if the response for the optimal connection indicates a mobile connection, the process 600 proceeds to step 660. In some embodiments, at decision block 606, the process 600 proceeds to step 658 in addition to or instead of proceeding to either step 608 or step 660. At step 658, the connection manager registers with the Wi-Fi management application to listen for network switch notifications.

At step 608, the client device's dual network RTP receiver's connection management function instantiates an RTP receiver instance for the Wi-Fi modem. In some embodiments, step 608 is preceded by step 610. At step 610, a Wi-Fi receiver request is started. At step 612, the RTP receiver instance for the Wi-Fi modem connects to the cloud-based RTP sender's UDP address port over the Wi-Fi network. At step 614, the jitter is assigned a value of zero, the previous arrival time is assigned a value of one and the previous RTP timestamp is assigned a value of 1. At step 616, the RTP receiver Wi-Fi instance's transmission receiver receives RTP packets over the Wi-Fi connected UDP socket. The process 600 then proceeds to decision block 618.

At decision block 618, if the RTP sequence number of the received RTP packet is the expected sequence number, the process proceeds to step 620, 626, and 628. At decision block 618, if the RTP sequence number of the received RTP packet is not the expected sequence number, the process proceeds to decision block 648 and step 654. At step 620, the arrival time is assigned the value of the device time. At step 622, the sender time is calculated. For example, the sender time is calculated based on the following formula:

$$senderTime = \frac{( MSW * 1000 ) + ( LSW * 1000 )}{{2}^{32}}$$

where MSW is the most significant word and LSW is the least significant word. At step 624, a latency is calculated based on a difference between the arrival time (e.g., in milliseconds (ms)) and a sender time (e.g., in ms). The process 600 then proceeds to decision block 630.

At decision block 630, if the previous arrival time is not one and the previous RTP timestamp is not one, the process 600 proceeds to decision block 632. At decision block 630, if the previous arrival time is one or the previous RTP timestamp is one, the process 600 proceeds to step 642.

At decision block 632, if the packet SSRC identifies a video, the process proceeds to step 634. At decision block 632, if the packet SSRC does not identify a video, the process proceeds to step 646. At step 634, a timestamp difference is calculated. For example, the timestamp difference is calculated based on the following formula:

$${Timestamp}_{Diff} = \frac{{Timestamp}_{RTP} - {Timestamp}_{previous}}{{Rate}_{video}}$$

Further, for example, the video rate is 90000. At step 636, an arrival difference is calculated. For example, the arrival difference is calculated based on a difference between the arrival time of the RTP and a previous arrival time. At step 638, a jitter (e.g., in ms) is calculated. For example, the jitter is calculated based on the following formula:

$$jitterinMS = 1000 ( jitter + \frac{\vert ( {Arrival}_{Diff} - {Timestamp}_{Diff} ) - jitter \vert}{16} )$$

At step 640, Wi-Fi jitter in ms (e.g., calculated based on the aforementioned formula) is reported to the connection manager. The process proceeds to step 646.

At step 642, the previous RTP timestamp is assigned the value of the RTP timestamp. At step 644, the previous arrival time is assigned the value of the arrival time. At step 646, the Wi-Fi latency is reported to the connection management function. The process 600 then returns to step 616.

At step 626, the RTP receiver Wi-Fi instance's transmission receiver sends the RTP packet to the RTP packet buffer. At step 628, the RTP receiver sends an RTCP success packet to the RTP sender over the Wi-Fi connected UDP socket.

At decision block 648, if the packet arrived in the mobile RTP packet buffer with the expected sequence number, then the process proceeds to step 628. At decision block 648, if the packet did not arrive in the mobile RTP packet buffer with the expected sequence number, then the process proceeds to decision block 650.

At decision block 650, if the mobile RTP receiver reports an RTCP retransmit request with packet sequence numbers, the process 600 is terminated. At decision block 650, if the mobile RTP receiver does not report an RTCP retransmit request with packet sequence numbers, the process proceeds to step 652. At step 652, the RTP receiver sends a RTCP retransmit request with packet sequence numbers over the Wi-Fi connected UDP socket.

At step 654, the dropped packets are assigned the value of the difference between the previous successful RTP sequence number and the received RTP sequence number. At step 656 the dropped packets (e.g., associated with Wi-Fi) are reported to the Wi-Fi management application. The process 600 returns to step 616.

At step 660, the client device's dual network RTP receiver's connection management function instantiates a RTP receiver instance for the wireless modem. In some embodiments, prior to step 660, at step 662, a mobile receiver request is started. At step 664, the RTP receiver instance for the wireless modem connects to the cloud-based RTP sender address port over the mobile network. At step 666, the jitter is assigned a value of zero, the previous arrival time is assigned a value of 1, and the previous RTP timestamp is assigned a value of 1. At step 668, the RTP receiver mobile instance's transmission receiver receives an RTP packet over the mobile connected UDP socket. The process 600 proceeds to decision block 670.

At decision block 670, if the RTP sequence number of the received packet is the expected sequence number, the process 600 proceeds to steps 682, 684, and 686. At decision block 670, if the RTP sequence number of the received packet is not the expected sequence number, the process 600 proceeds to step 672 and decision block 676. At step 672, the dropped packets are assigned the value of the difference between the previous successful RTP sequence number and the received RTP sequence number. At step 674, the dropped packets (e.g., for mobile) are reported to the Wi-Fi management application. The process 600 then returns to step 668.

At decision block 676, if the packet arrived in the Wi-Fi RTP packet buffer with the expected sequence number, the process 600 proceeds to step 682. At decision block 676, if the packet did not arrive in the Wi-Fi RTP packet buffer with the expected sequence number, the process 600 proceeds to decision block 678.

At decision block 678, if the Wi-Fi RTP receiver reports an RTCP retransmit request with packet sequence numbers, process 600 is terminated. At decision block 678, if the Wi-Fi RTP receiver does not report the RTCP retransmit request with packet sequence numbers, the process proceeds to step 680. At step 680, the RTP receiver sends the RTCP retransmit request with packet sequence numbers over the mobile connected UDP socket.

At step 682, the RTP receiver sends a RTCP success packet to the RTP sender over the mobile connected UDP socket.

At step 684, the mobile RTP receiver instance's transmission receiver sends the RTP packet to the RTP packet buffer.

At step 686, the arrival time is assigned the value of the device time. At step 688, the sender time is calculated. For example, the sender time is calculated based on the following formula:

$$senderTime = \frac{( MSW * 1000 ) + ( LSW * 1000 )}{{2}^{32}}$$

where MSW is the most significant word and LSW is the least significant word. At step 690, a latency is calculated based on a difference between the arrival time (e.g., in ms) and a sender time (e.g., in ms). The process 600 then proceeds to decision block 692.

At decision block 692, if the previous arrival time is one and the previous RTP timestamp is 1, the process proceeds to decision block 603. At decision block 692, if the previous arrival time is not one or the previous RTP timestamp is not one, the process proceeds to step 694. At step 694, the previous RTP timestamp is assigned the value of the RTP timestamp. At step 696, the previous arrival time is assigned the value of the arrival time. At step 698, the latency (e.g., for mobile) is reported to the connection management function. The process 600 returns to step 668.

At decision block 603, if the packet SSRC indicates a video, the process 600 proceeds to step 605. At decision block 603, if the packet SSRC does not indicate a video, the process 600 proceeds to step 698. At step 605, a timestamp difference is calculated. For example, the timestamp difference is calculated based on the following formula:

$${Timestamp}_{Diff} = \frac{{Timestamp}_{RTP} - {Timestamp}_{previous}}{{Rate}_{video}}$$

Further, for example, the video rate is 90000. At step 607, an arrival difference is calculated. For example, the arrival difference is calculated based on a difference between the arrival time of the RTP and a previous arrival time. At step 609, a jitter (e.g., in ms) is calculated. For example, the jitter is calculated based on the following formula:

$$jitterinMS = 1000 ( jitter + \frac{\vert ( {Arrival}_{Diff} - {Timestamp}_{Diff} ) - jitter \vert}{16} )$$

At step 611, the jitter in ms (e.g., for mobile, calculated based on the aforementioned formula) is reported to the connection manager. The process 600 proceeds to step 698.

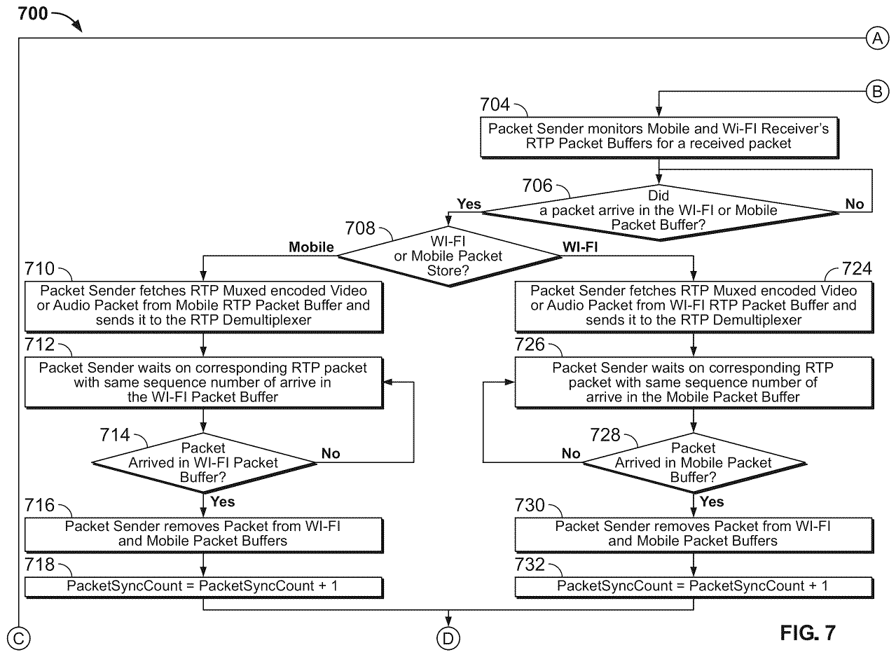

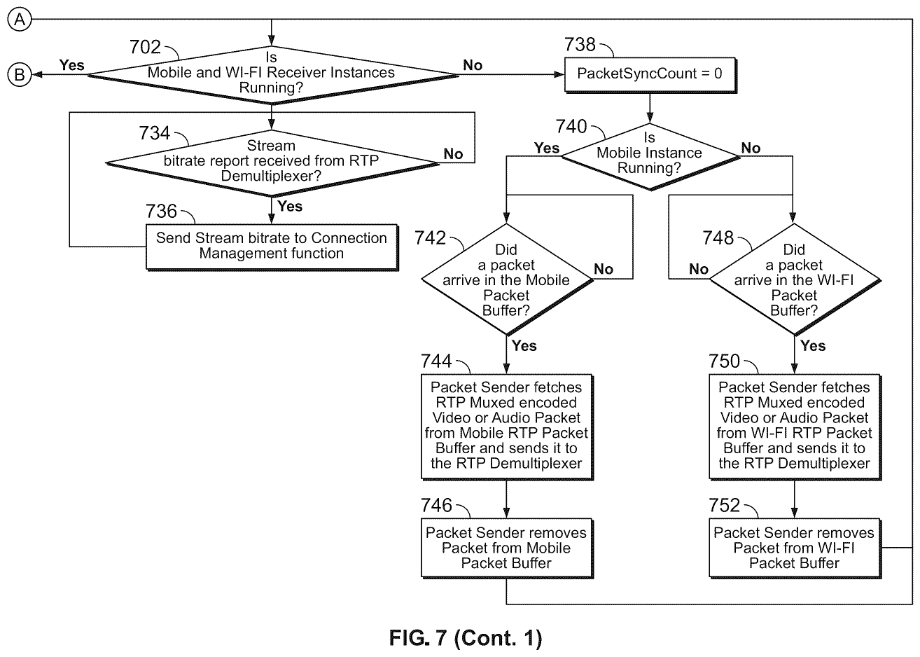

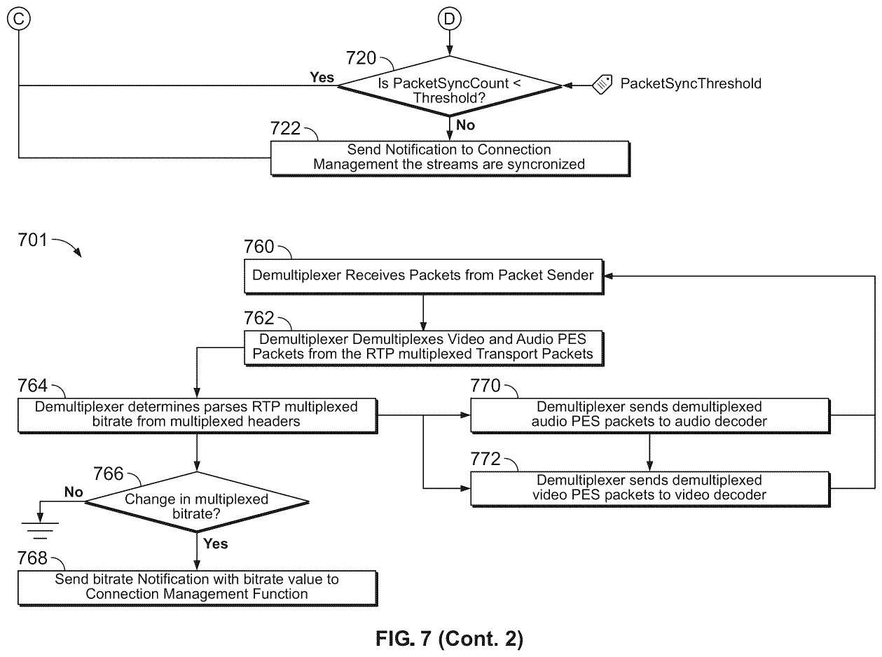

FIG. 7 is a flowchart of illustrative processes for the packet sender and demultiplexer functions, in accordance with some embodiments of this disclosure. In various embodiments, the individual steps of processes 700 and 701 are implemented by one or more components of the devices, methods, and systems of FIGS. 1-22 and are performed in combination with any of the other processes and aspects described herein. Although the present disclosure may describe certain steps of processes 700 and 701 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At decision block 702 (e.g., of packet sender process 700), if mobile and wi-fi receiver instances are running (e.g., on the client device), the process 700 proceeds to step 704. At decision block 702, if mobile and Wi-Fi receiver instances are not running, the process 700 proceeds to step 738. At step 704, the packet sender monitors mobile and Wi-Fi receiver RTP packet buffers for a received packet. The process 700 proceeds to decision block 706.

At decision block 706, if a packet arrived in the Wi-Fi or mobile packet buffers, the process 700 proceeds to step 708. At decision block 706, if no packet arrived in the Wi-Fi or mobile packet buffers, the process 700 returns to decision block 706.

At decision block 708, if the packet arrived in the mobile packet buffer, the process 700 proceeds to step 710. At decision block 708, if the packet arrived in the Wi-Fi packet buffer, the process 700 proceeds to step 724. At step 710, the packet sender fetches RTP multiplexed encoded video and/or audio packets from the mobile RTP packet buffer and sends it to the RTP demultiplexer. At step 712, the packet sender waits on a corresponding RTP packet with the same sequence number to arrive in the Wi-Fi packet buffer. The process 700 proceeds to decision block 714.

At decision block 714, if the packet arrived in the Wi-Fi packet buffer, the process 700 proceeds to step 716. At decision block 714, if the packet did not arrive in the Wi-Fi packet buffer, the process 700 returns to step 712. At step 716, the packet sender removes the packet from the Wi-Fi and mobile packet buffers. At step 718 the packet sync count is incremented by one. The process proceeds to decision block 720.

At decision block 720, if the packet sync count is less than a packet sync threshold, the process 700 returns to decision block 702. At decision block 720, if the packet sync count is not less than the packet sync threshold, the process 700 proceeds to step 722. At step 722, the packet sender sends a notification to the connection manager that the streams are synchronized. The process 700 returns to decision block 702.

At step 724, the packet sender fetches RTP multiplexed encoded video and/or audio packets from the Wi-Fi RTP packet buffer and sends it to the RTP demultiplexer. At step 726, the packet sender waits on a corresponding RTP packet with the same sequence number to arrive in the mobile packet buffer. The process 700 proceeds to decision block 728.

At decision block 728, if the packet arrived in the mobile packet buffer, the process 700 proceeds to step 730. At decision block 728, if the packet did not arrive in the mobile packet buffer, the process 700 returns to step 726. At step 730, the packet sender removes packets from the Wi-Fi and mobile packet buffers. At step 732, the packet sync count is incremented by one. The process 700 proceeds to decision block 720.

At decision block 702, the process 700 additionally, or alternatively, proceeds to decision block 734. At decision block 734, if the stream bitrate report is received from the RTP demultiplexer, the process 700 proceeds to step 736. At decision block 734, if the stream bitrate report is not received from the RTP demultiplexer, the process 700 returns to the decision block 734. At step 736, the packet sender sends the stream bitrate to the connection manager. The process 700 returns to decision block 734.

At step 738, the packet sync count is assigned a value of zero. The process 700 proceeds to decision block 740.

At decision block 740, if the mobile instance is running, the process 700 proceeds to decision block 742. At decision block 740, if the mobile instance is not running, the process 700 proceeds to decision block 748.

At decision block 742, if a packet arrived in the mobile packet buffer, the process 700 proceeds to step 744. At decision block 742, if a packet did not arrive in the mobile packet buffer, the process returns to decision block 742. At step 744, the packet sender fetches the RTP multiplexed encoded video and/or audio packet from the mobile RTP packet buffer and sends the packet to the RTP demultiplexer. At step 746, the packet sender removes the packet from the mobile packet buffer. The process 700 returns to decision block 702.

At decision block 748, if a packet arrived in the Wi-Fi packet buffer, the process 700 proceeds to step 750. At decision block 748, if a packet did not arrive in the Wi-Fi packet buffer, the process 700 returns to decision block 748. At step 750, the packet sender fetches the RTP multiplexed encoded video and/or audio packet from the Wi-Fi RTP packet buffer and sends the packet to the RTP demultiplexer. At step 752, the packet sender removes the packet from the Wi-Fi packet buffer. The process 700 returns to decision block 702.

At step 760 (e.g., of demultiplexer process 701), the demultiplexer receives packets from the packet sender. At step 762, the demultiplexer demultiplexes video and audio PES packets from the RTP multiplexed transport packets. At step 764, the demultiplexer determines a RTP multiplexed bitrate from multiplexed headers. The process 701 proceeds to decision block 766, step 770 and/or step 772.

At decision block 766, if there is a change in the multiplexed bitrate, the demultiplexer, at step 768, sends a bitrate notification with a bitrate value to the connection manager. At decision block 766, if there is no change in the multiplexed bitrate the process 701 is terminated.

At step 770, the demultiplexer sends demultiplexed audio PES packets to the audio decoder. The process 701 proceeds to step 772 or returns to step 760. At step 772, the demultiplexer sends demultiplexed video PES packets to the video decoder. The process 701 returns to step 760.

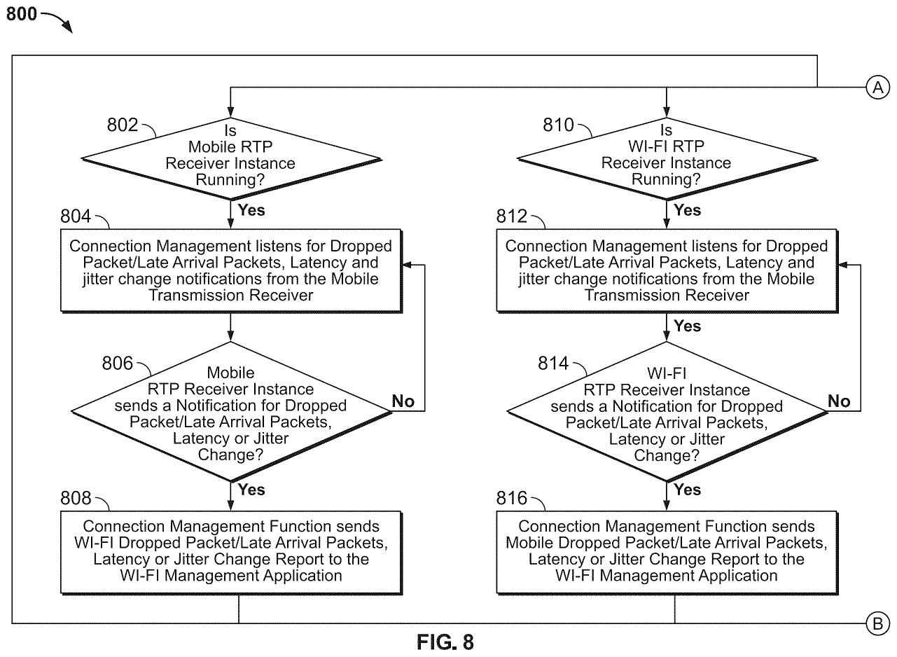

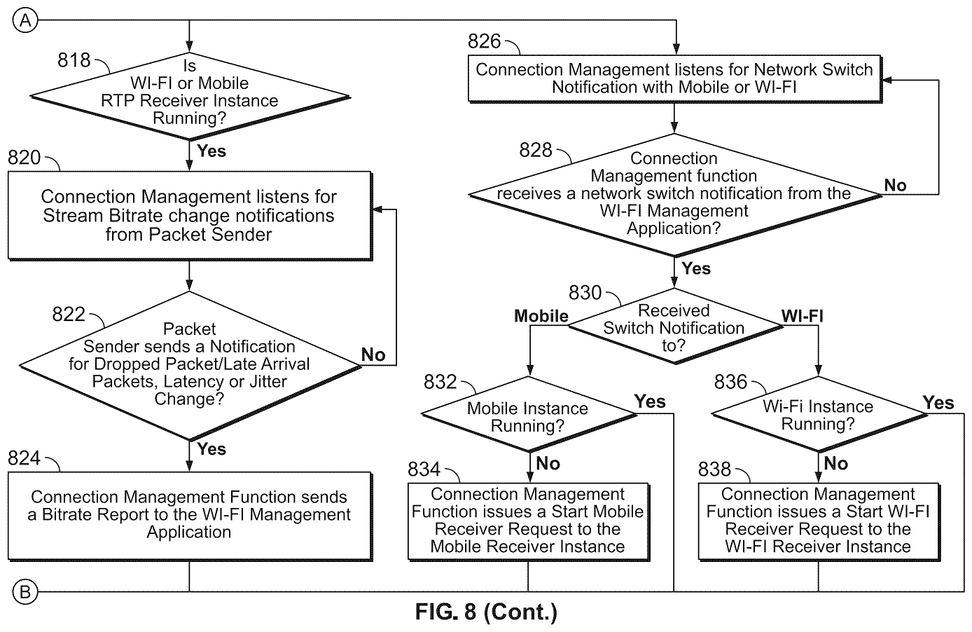

FIG. 8 is a flowchart of illustrative processes for a connection manager working with a Wi-Fi management application, in accordance with some embodiments of this disclosure. In various embodiments, the individual steps of processes 800 are implemented by one or more components of the devices, methods, and systems of FIGS. 1-22 and are performed in combination with any of the other processes and aspects described herein. Although the present disclosure may describe certain steps of processes 800 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At decision block 802, if the mobile RTP receiver instance is running, process 800 proceeds to step 804. At step 804, the connection manager listens for dropped and/or late arrival packets, or latency and/or jitter change notification from the mobile transmission receiver. The process 800 proceeds to decision block 806.

At decision block 806, if the mobile RTP receiver instance sends a notification for a dropped/late arrival packet or a latency/jitter change, the process proceeds to step 808. If the mobile RTP receiver instance does not send a notification for a dropped/late arrival packet or a latency/jitter change, the process 800 returns to step 804. At step 808, the connection manager reports dropped/late arrival packets and/or latency/jitter change to the Wi-Fi management application. The process 800 returns to decision blocks 802, 810, and 818, and step 826.

At decision block 810, if the Wi-Fi RTP receiver instance is running, the process 800 proceeds to step 812. At step 812, the connection manager listens for dropped/late arrival packets and/or jitter/latency change notification from the Wi-Fi transmission receiver. The process 800 proceeds to decision block 814.

At decision block 814, if the Wi-Fi RTP receiver instance sends a notification for a dropped/late arrival packet or a latency/jitter change, the process proceeds to step 816. If the Wi-Fi RTP receiver instance does not send a notification for a dropped/late arrival packet or a latency/jitter change, the process 800 returns to step 812. At step 816, the connection manager reports dropped/late arrival packets and/or latency/jitter change to the Wi-Fi management application. The process 800 returns to decision blocks 802, 810, and 818, and step 826.

At decision block 818, if the Wi-Fi or mobile RTP receiver instance is running, the process 800 proceeds to step 820. At step 820, the connection manager listens for stream bitrate change notification from the packet sender.

At decision block 822, if the packet sender sends a notification for dropped/late arrival packets and/or latency/jitter change, the process proceeds to step 824. If the packet sender does not send a notification for dropped/late arrival packets and/or latency/jitter change, the process 800 returns to step 818. At step 824, the connection manager reports the bitrate to the Wi-Fi management application. The process 800 returns to decision blocks 802, 810, and 818, and step 826.

At step 826, the connection manager listens for a network switch notification (e.g., for mobile or Wi-Fi). The process 800 proceeds to decision block 828.

At decision block 828, if the connection management function receives a network switch notification from the wi-fi management application, the process 800 proceeds to decision block 830. If the connection management function does not receive a network switch notification, the process 800 returns to step 826.

At decision block 830, if the notification indicates to switching to mobile, the process 800 proceeds to decision block 832. If the notification indicates to switch to Wi-Fi, the process 800 proceeds to decision block 836.

At decision block 832, if a mobile instance is not running, at step 834, the connection management function issues a start mobile receiver request to the mobile receiver instance. The process 800 returns to decision blocks 802, 810, and 818, and step 826. If the mobile instance is running, return to decision blocks 802, 810, and 818, and step 826.

At decision block 836, if the Wi-Fi instance is not running, at step 838, the connection manager issues a start Wi-Fi receiver request to the Wi-Fi receiver instance. The process 800 returns to decision blocks 802, 810, and 818, and step 826. If the Wi-Fi instance is running, the process 800 returns to decision blocks 802, 810, and 818, and step 826.

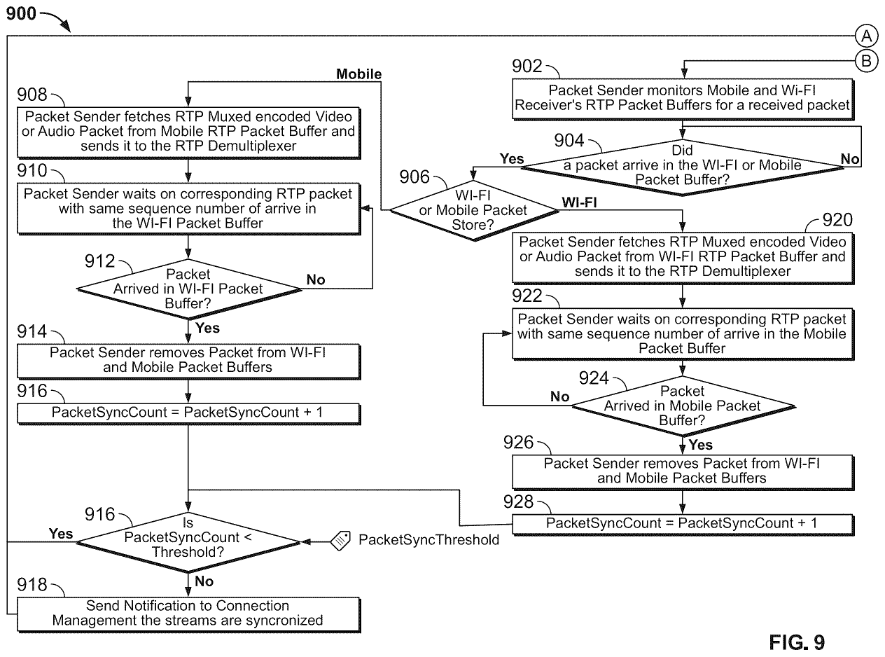

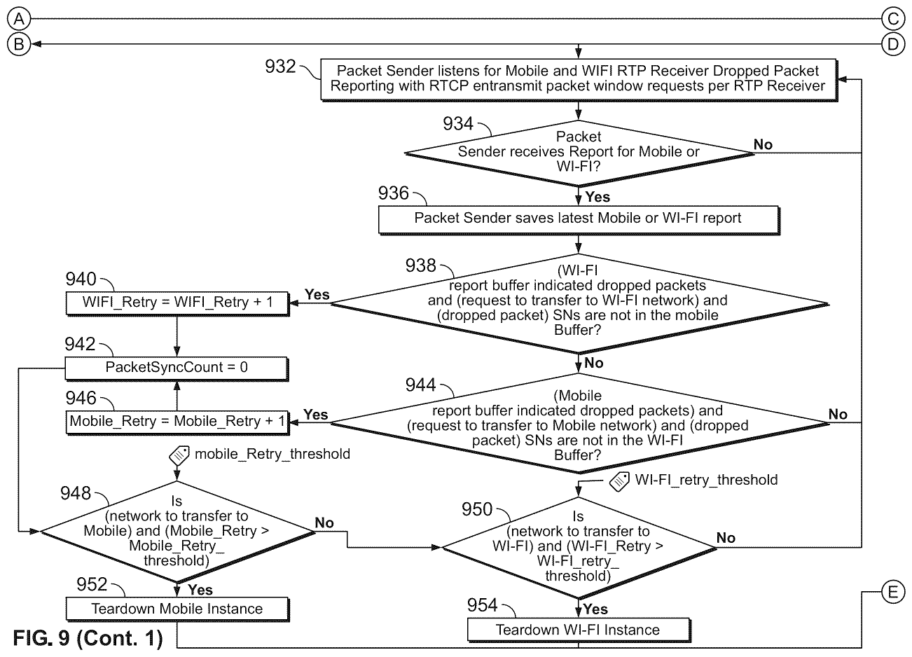

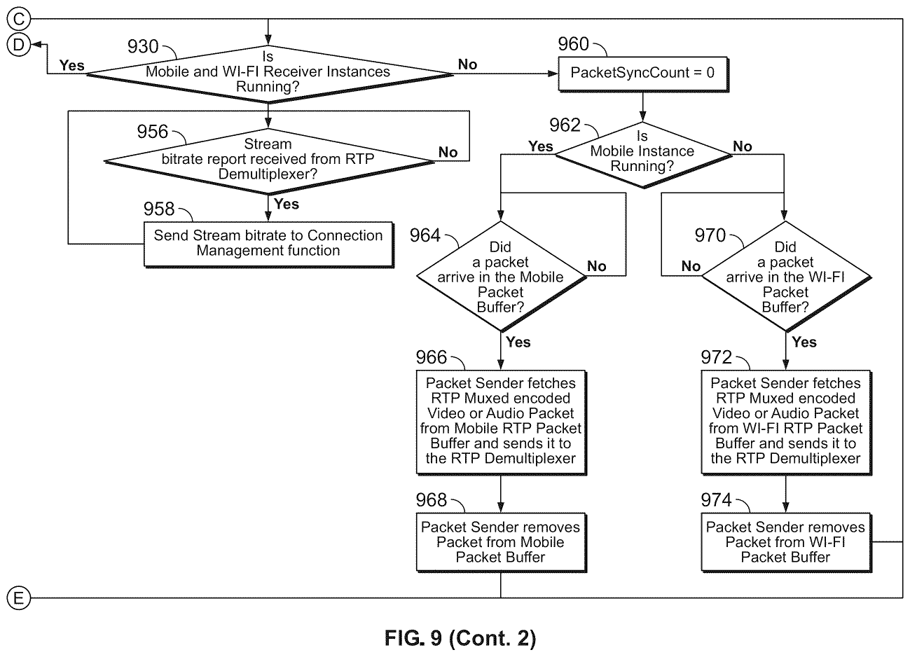

FIG. 9 is a flowchart of illustrative processes for a packet sender working without a Wi-Fi management application, in accordance with some embodiments of this disclosure. In various embodiments, the individual steps of processes 900 are implemented by one or more components of the devices, methods, and systems of FIGS. 1-22 and are performed in combination with any of the other processes and aspects described herein. Although the present disclosure may describe certain steps of processes 900 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At decision block 930, if mobile and Wi-Fi receiver instances are running, the process 900 proceeds to steps 902 and 932. If mobile and Wi-Fi receiver instances are not running, the process 900 proceeds to step 960. Additionally, or alternatively, the process 900 proceeds to decision block 956. At decision block 956, if a stream bitrate report is received from the RTP demultiplexer, at step 958, the packet sender sends the stream bitrate to the connection manager. If the stream bitrate report is not received, the process 900 remains at decision block 956.

At step 902, the packet sender monitors mobile and Wi-Fi receiver's RTP packet buffers for a received packet. The process 900 proceeds to decision block 904.

At decision block 904, if a packet arrives in the Wi-Fi or mobile packet buffer, the process 900 proceeds to 906. If a packet does not arrive in the Wi-Fi or mobile packet buffer, the process 900 remains at decision block 904.

At decision block 906, if the packet arrived in the mobile packet buffer, the process 900 proceed to step 908. If the packet arrived in the Wi-Fi packet buffer, the process 900 proceeds to step 920. At step 908, the packet sender fetches RTP multiplexed encoded video or audio packets from the mobile RTP packet buffer and sends it to the RTP demultiplexer. At step 910, the packet sender waits on a corresponding packet with the same sequence number to arrive in the Wi-Fi packet buffer. The process 900 proceeds to decision block 912.

At decision block 912, if the packet did not arrive in the Wi-Fi packet buffer, the process 900 returns to step 910. If the packet arrived in the Wi-Fi packet buffer, at step 914, the packet sender removes the packet from the Wi-Fi and mobile packet buffers. At step 916, the packet sync count is incremented by one and the process 900 proceeds to decision block 916. At decision block 916, if the packet sync count is less than the packet sync threshold, the process returns to decision block 930. If the packet sync count is not less than the packet sync threshold, at step 918, the packet sender notifies the connection manager that the streams are synchronized and the process returns to decision block 930.

At step 932, the packet sender listens for mobile and Wi-Fi RTP receiver dropped packet reporting with RTCP retransmit packet window requests for each RTP receiver. The process 900 proceeds to decision block 934.

At decision block 934, if the packet sender receives a report for mobile or Wi-Fi, at step 936, the packet sender saves the latest mobile or Wi-Fi report and proceeds to decision block 938. If the packet sender does not receive a report for mobile or Wi-Fi, the process returns to step 932.

At decision block 938, if the Wi-Fi report buffer indicates dropped packets, a request to transfer to a Wi-Fi network is identified, and the dropped packet sequence numbers are not in the mobile buffer, at 940, the Wi-Fi retry value is incremented by one and, at step 942, the packet sync count is set to zero, before proceeding to decision block 948. If the Wi-Fi report buffer does not indicate dropped packets, a request to transfer to a Wi-Fi network is not identified, or the dropped packet sequence numbers are in the mobile buffer, the process 900 proceeds to decision block 944.

At decision block 944, if the mobile report buffer indicates dropped packets, a request to transfer to a mobile network is identified, and the dropped packet sequence numbers are not in the Wi-Fi buffer, at 946, the mobile retry value is incremented by one and, at step 942, the packet sync count is set to zero, before proceeding to decision block 948. If the mobile report buffer does not indicate dropped packets, a request to transfer to a mobile network is not identified, or the dropped packet sequence numbers are in the Wi-Fi buffer, the process 900 returns to step 932.

At decision block 948, if the network will transfer to mobile and the mobile retry value is greater than a mobile retry threshold, at step 952, the mobile receiver instance is terminated and the process returns to decision block 930. If the network will not transfer to mobile or the mobile retry value is not greater than the mobile retry threshold, the process 900 proceeds to decision block 950.

At decision block 950, if the network will transfer to Wi-Fi and the Wi-Fi retry value is greater than a Wi-Fi retry threshold, at step 954, the Wi-Fi receiver instance is terminated, and the process returns to decision block 930. If the network will not transfer to Wi-Fi or the Wi-Fi retry value is not greater than the mobile retry threshold, the process 900 returns to step 932.

At step 960, the packet sync count is assigned a value of zero. The process 900 proceeds to decision block 962.

At decision block 962, if the mobile instance is running, the process 900 proceeds to decision block 964. At decision block 962, if the mobile instance is not running, the process 900 proceeds to decision block 970.

At decision block 964, if a packet arrived in the mobile packet buffer, the process 900 proceeds to step 966. At decision block 964, if a packet did not arrive in the mobile packet buffer, the process returns to decision block 964. At step 966, the packet sender fetches the RTP multiplexed encoded video and/or audio packet from the mobile RTP packet buffer and sends the packet to the RTP demultiplexer. At step 968, the packet sender removes the packet from the mobile packet buffer. The process 900 returns to decision block 930.

At decision block 970, if a packet arrived in the Wi-Fi packet buffer, the process 900 proceeds to step 972. At decision block 970, if a packet did not arrive in the Wi-Fi packet buffer, the process 900 returns to decision block 970. At step 972, the packet sender fetches the RTP multiplexed encoded video and/or audio packet from the Wi-Fi RTP packet buffer and sends the packet to the RTP demultiplexer. At step 974, the packet sender removes the packet from the Wi-Fi packet buffer. The process 900 returns to decision block 930.

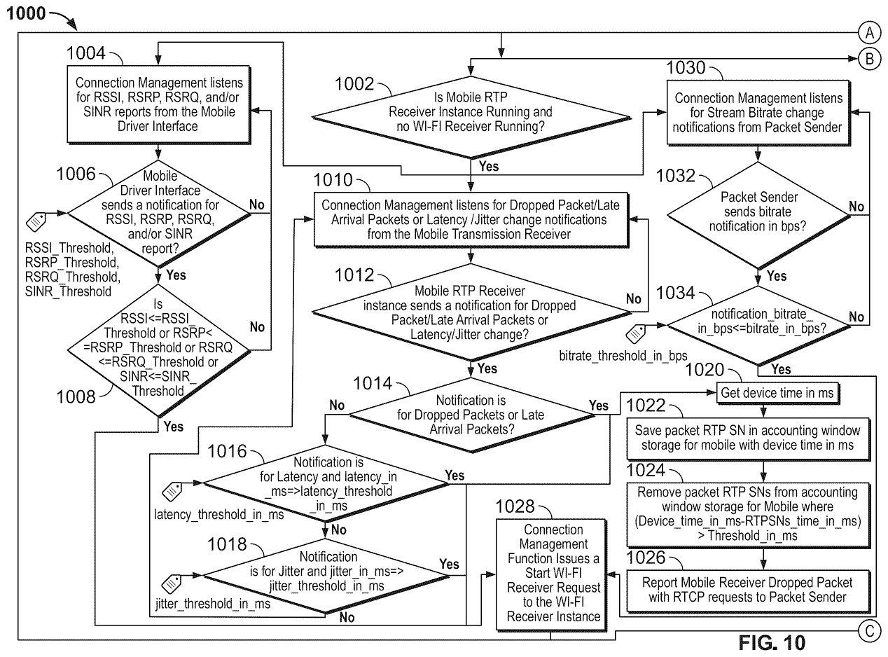

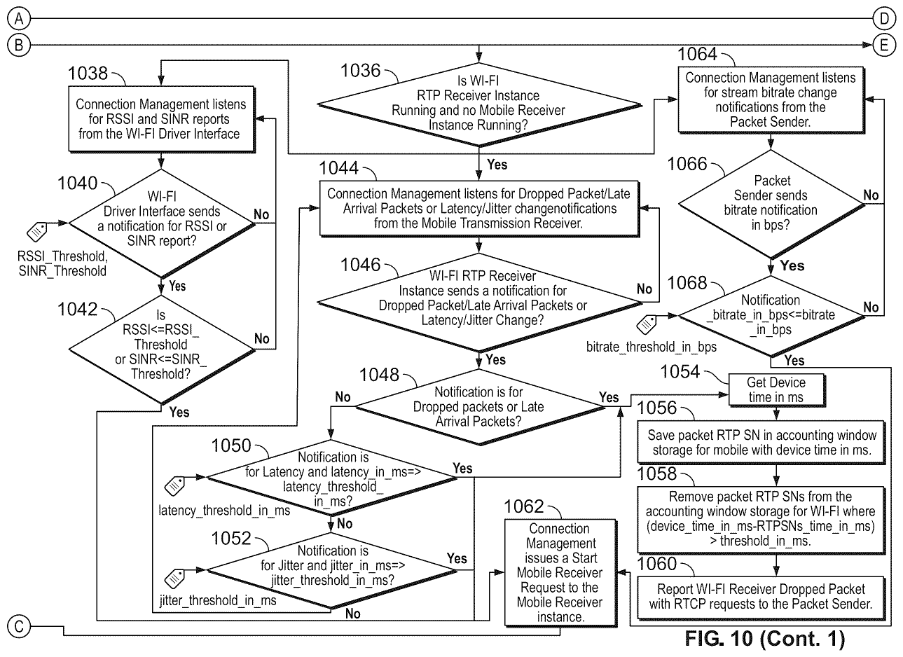

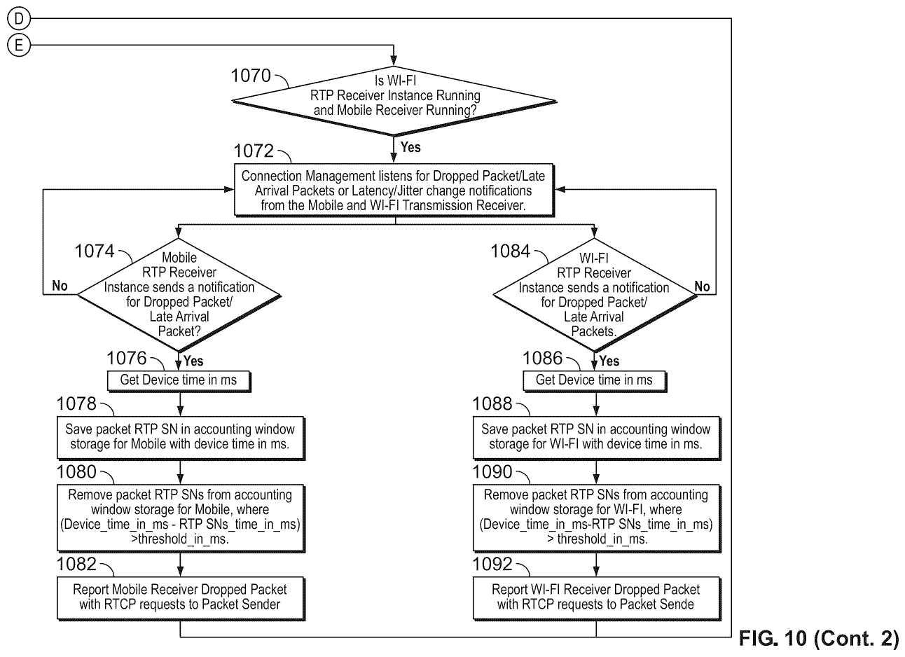

FIG. 10 is a flowchart of illustrative processes for a connection manager determining a network switch based on multiple metrics, in accordance with some embodiments of this disclosure. In various embodiments, the individual steps of processes 1000 are implemented by one or more components of the devices, methods, and systems of FIGS. 1-22 and are performed in combination with any of the other processes and aspects described herein. Although the present disclosure may describe certain steps of processes 1000 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At decision block 1002, if a mobile RTP receiver instance is running and no Wi-Fi receiver instance is running, proceed to steps 1004, 1010, and 1030. At step 1004, the connection manager listens for RSSI, RSRP, RSRQ, and/or SINR reports form the mobile driver interface. The process 1000 proceeds to decision block 1006.

At decision block 1006, if the mobile driver interface sends a notification for RSSI, RSRP, RSRQ, and/or SINR reports, the process 1000 proceeds to decision block 1008. If the mobile driver interface does not send such a notification, the process 1000 returns to step 1004.

At decision block 1008, if at least one of the metrics (e.g., RSSI, RSRP, RSRQ, SINR) are less than or equal to their corresponding threshold, the process proceeds to step 1028. If all of the metrics are greater than their corresponding thresholds, the process 1000 returns to step 1004. At step 1028, the connection manager issues a start Wi-Fi receiver request to the Wi-Fi receiver instance.

At step 1010, the connection manager listens for dropped/late arrival packets and/or latency/jitter change notifications from the mobile transmission receiver. The process 1000 proceeds to decision block 1012.

At decision block 1012, if the mobile RTP receiver instance sends a notification for dropped/late arrival packets and/or latency/jitter change, the process proceeds to decision block 1014. If no such notification is sent by the mobile RTP receiver instance, the process returns to step 1010.

At decision block 1014, if the notification is for dropped packets or late arrival packets, the process proceeds to step 1020 and/or 1028. If the notification is not for dropped packet nor late arrival packets, the process proceeds to decision block 1016.

At decision block 1016, if the notification is for latency and the latency in ms is greater than or equal to a corresponding threshold latency, the process proceeds to step 1028. If the notification is not for latency or the latency is less than the corresponding threshold latency, the process proceeds to decision block 1018.

At decision block 1018, if the notification is for jitter and the jitter in ms is greater than or equal to a corresponding threshold jitter, the process 1000 proceeds to step 1028. If the notification is not for jitter or the jitter in ms is less than the corresponding threshold jitter, the process 1000 returns to step 1010.

At step 1020, the communication manager gets the device time (e.g., in milliseconds (ms)). For example, the device time is a current device time, and the communication manager acquires the current device time using a common time synchronization protocol like network time protocol (NTP). Further, for example, the current device time is an epoch time (e.g., Unix time, portable operating system interface (POSIX) time, Unix timestamp, or the like). At step 1022, the connection manager saves the RTP packet sequence number in accounting window storage for mobile devices with the device time in ms. At step 1024, the connection manager removes RTP packet SNs from accounting window storage for mobile where the difference between the device time in ms and the RTP SN time in ms is greater than a threshold value. At step 1026, the communication manager reports to the packet sender with RTCP requests that indicate that the mobile receiver dropped packets.

At step 1030, the connection manager listens for stream bitrate and changes the notifications from the packet sender. The process 1000 proceeds to decision block 1032.

At decision block 1032, if the packet sender sends a bitrate notification in bits per second (bps), the process proceeds to decision block 1034. If the packet sender sends no such notification, the process 1000 returns to step 1030.

At decision block 1034, if the notification bitrate (e.g., in bps) is less than or equal to the bitrate threshold (e.g., in bps), the process proceeds to step 1028. If the notification bitrate is greater than the bitrate threshold, the process 1000 returns to step 1030.

At decision block 1036, if a Wi-Fi RTP receiver instance is running and no mobile receiver instance is running, proceed to steps 1038, 1044, and 1064. At step 1038, the connection manager listens for RSSI and/or SINR reports from the Wi-Fi driver interface. The process 1000 proceeds to decision block 1040.

At decision block 1040, if the Wi-Fi driver interface sends a notification for RSSI and/or SINR reports, the process 1000 proceeds to decision block 1042. If the Wi-Fi driver interface does not send such a notification, the process 1000 returns to step 1038.

At decision block 1042, if at least one of the metrics (e.g., RSSI, SINR) are less than or equal to their corresponding threshold, the process proceeds to step 1044. If all of the metrics are greater than their corresponding thresholds, the process 1000 returns to step 1038 At step 1062, the connection manager issues a start a mobile receiver request to the mobile receiver instance.

At step 1044, the connection manager listens for dropped/late arrival packets and/or latency/jitter change notifications from the Wi-Fi transmission receiver. The process 1000 proceeds to decision block 1046.

At decision block 1046, if the mobile RTP receiver instance sends a notification for dropped/late arrival packets and/or latency/jitter change, the process proceeds to decision block 1048. If no such notification is sent by the mobile RTP receiver instance, the process returns to step 1044.

At decision block 1048, if the notification is for dropped packets or late arrival packets, the process proceeds to step 1054 and/or step 1062. If the notification is not for dropped packet nor late arrival packets, the process proceeds to decision block 1050.

At decision block 1050, if the notification is for latency and the latency in ms is greater than or equal to a corresponding threshold latency, the process proceeds to step 1062. If the notification is not for latency or the latency is less than the corresponding threshold latency, the process proceeds to decision block 1052.

At decision block 1052, if the notification is for jitter and the jitter in ms is greater than or equal to a corresponding threshold jitter, the process 1000 proceeds to step 1062. If the notification is not for jitter or the jitter in ms is less than the corresponding threshold jitter, the process 1000 returns to step 1044.

At step 1054, the communication manager gets the device time in ms. At step 1056, the connection manager saves the RTP packet sequence number in accounting window storage for Wi-Fi with the device time in ms. At step 1058, the connection manager removes RTP packet SNs from accounting window storage for Wi-Fi where the difference between the device time in ms and the RTP SN time in ms is greater than a threshold value. At step 1060, the communication manager reports to the packet sender with RTCP requests that indicate that the Wi-Fi receiver dropped packets.

At step 1064, the connection manager listens for stream bitrate and changes the notifications from the packet sender. The process 1000 proceeds to decision block 1066.

At decision block 1066, if the packet sender sends a bitrate notification in bits per second (bps), the process proceeds to decision block 1068. If the packet sender sends no such notification, the process 1000 returns to step 1064.

At decision block 1068, if the notification bitrate (e.g., in bps) is less than or equal to the bitrate threshold (e.g., in bps), the process proceeds to step 1062. If the notification bitrate is greater than the bitrate threshold, the process 1000 returns to step 1064.

At decision block 1070, if the Wi-Fi RTP receiver instance and mobile receiver instance are running, the process 1000 continues to step 1072. At step 1072, the connection manager listens for dropped/late arrival packets and/or latency/jitter change notifications from the mobile and Wi-Fi transmission receivers. The process 1000 proceeds to decision blocks 1074 and 1084.

At decision block 1074, if the mobile RTP receiver instance sends a notification for dropped/late arrival packets, the process 1000 proceeds to step 1076. If the mobile RTP receiver instance sends no such notification, the process 1000 returns to step 1072. At step 1076, the connection manager gets the device time in ms. At step 1078, the connection manager saves the RTP packet SN in accounting window storage for mobile with device time in ms. At step 1080, the connection manager removes the RTP packet SNs from accounting window storage for mobile where the difference between device time (e.g., in ms) and RTP SNs time (e.g., in ms) is greater than a threshold time (e.g., in ms). At step 1082, the connection manager reports the mobile receiver dropped packets with RTCP request to the packet sender. The process 1000 returns to decision blocks 1002, 1036, and 1070.

At decision block 1084, if the Wi-Fi RTP receiver instance sends a notification for dropped/late arrival packets, the process 1000 proceeds to step 1086. If the Wi-Fi RTP receiver instance sends no such notification, the process 1000 returns to step 1072. At step 1086, the connection manager gets the device time in ms. At step 1088, the connection manager saves the RTP packet SN in accounting window storage for Wi-Fi with device time in ms. At step 1090, the connection manager removes the RTP packet SNs from accounting window storage for Wi-Fi, where the difference between device time (e.g., in ms) and RTP SNs time (e.g., in ms) is greater than a threshold time (e.g., in ms). At step 1092, the connection manager reports the Wi-Fi receiver dropped packets with RTCP request to the packet sender. The process 1000 returns to decision blocks 1002, 1036, and 1070.

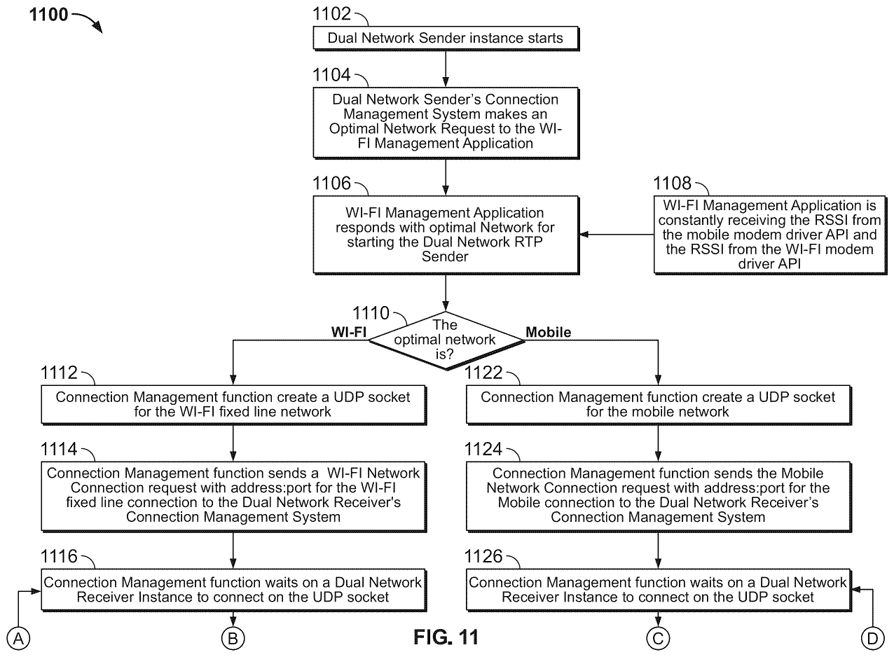

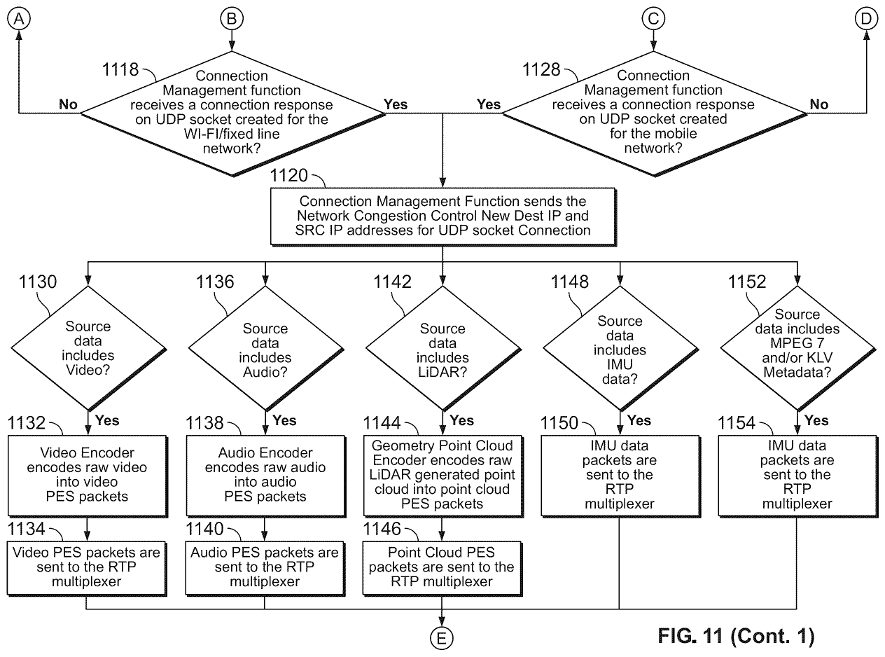

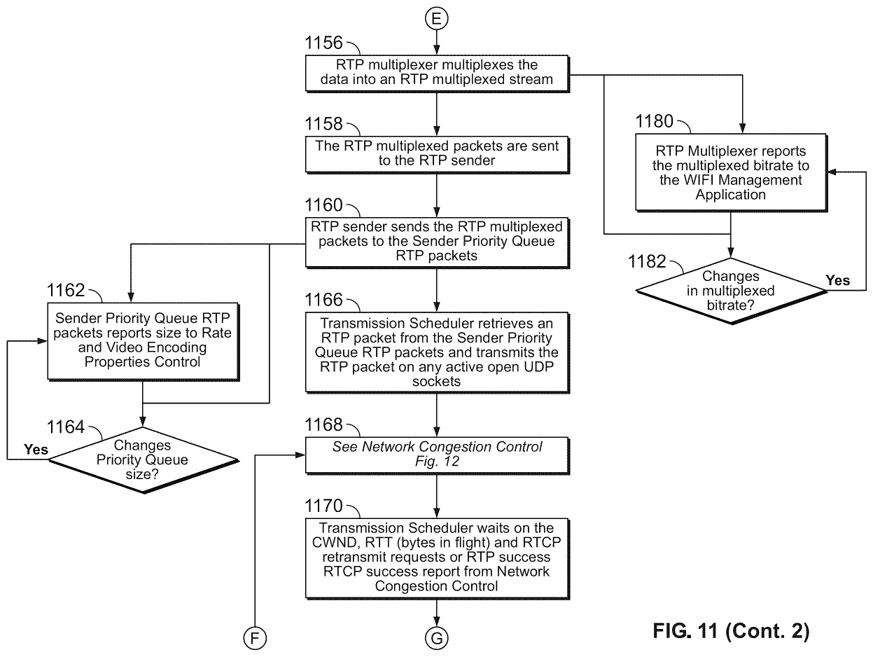

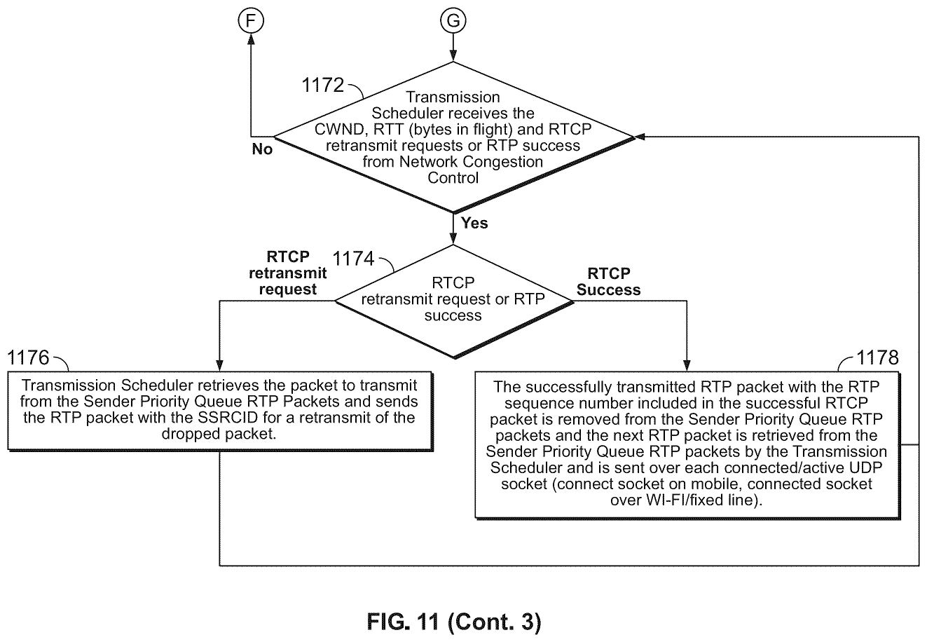

FIG. 11 is a flowchart of illustrative processes for startup and packet transmission for a dual network sender, in accordance with some embodiments of this disclosure. In various embodiments, the individual steps of processes 1100 are implemented by one or more components of the devices, methods, and systems of FIGS. 1-22 and are performed in combination with any of the other processes and aspects described herein. Although the present disclosure may describe certain steps of processes 1100 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1102, the dual network sender instance is instantiated. At step 1104, the dual network sender's connection manager makes an optimal network request to the Wi-Fi management application. At step 1106, the Wi-Fi management application responds with an optimal network for starting the dual network RTP sender. The process 1100 proceeds to decision block 1110. In some embodiments, prior to step 1106, at step 1108, the Wi-Fi management application constantly receives the RSSI from the mobile modem driver API and the Wi-Fi modem driver API.

At decisions block 1110, if the optimal network is the Wi-Fi/fixed-line network, the process 1100 proceeds to step 1112. If the optimal network is the mobile network, the process 1100 proceeds to step 1122. At step 1112, the connection manager instantiates a new UDP socket for the Wi-Fi/fixed line network. At step 1114, the connection manager sends a Wi-Fi/fixed line network connection request with an address port for the Wi-Fi/fixed line connection to the dual network receiver's connection manager. At step 1116, the connection manager waits on a dual network receiver instance to connect to the new UDP socket. The process 1100 proceeds to decision block 1118.

At decision block 1118, if the connection management function receives a connection response on the UDP socket created for the Wi-Fi/fixed-line network, at 1120, the connection manager sends the network congestion controller the new destination and source IP addresses for the UDP socket connection before the process 1100 proceeds to decision blocks 1130, 1136, 1142, 1148, and 1152. If the connection manager receives no such response, the process 1100 returns to step 1116.

At step 1122, the connection manager instantiates a new UDP socket for the mobile network. At step 1124, the connection manager sends the mobile network connection request with an address port for the mobile connection to the dual network receiver's connection manager. At step 1126, the connection manager waits on a dual network receiver instance to connect to the new UDP socket. The process 1100 proceeds to decision block 1128.

At decision block 1128, if the connection management function receives a connection response on the new UDP socket created for the mobile network, the process proceeds to step 1120. If the connection management function receives no such connection response, the process returns to step 1128.

At decision block 1130, if the source data includes video, the process proceeds to step 1132. At step 1132, the video encoder encodes raw video into video elementary stream, which is then packetized into PES packets. At step 1134, the video PES packets are sent to the RTP multiplexer. The process 1100 proceeds to step 1156.

At decision block 1136, if the source data includes audio, the process proceeds to step 1138. At step 1138, the audio encoder encodes raw audio into audio elementary stream, which is then packetized into PES packets. At step 1140, the audio PES packets are sent to the RTP multiplexer. The process 1100 proceeds to step 1156.

At decision block 1142, if the source data includes LIDAR, the process proceeds to step 1144. At step 1144, the geometry point cloud encoder encodes raw LIDAR-generated point cloud into point cloud PES packets. At step 1146, the point cloud PES packets are sent to the RTP multiplexer. The process 1100 proceeds to step 1156.

At decision block 1148, if the source data includes IMU data, the process proceeds to step 1150. At step 1150, the IMU data packets are sent to the RTP multiplexer. The process 1100 proceeds to step 1156.

At decision block 1152, if the source data includes MPEG-7 and/or KLV metadata, the process proceeds to step 1154. At step 1154, the MPEG-7 and/or KLV metadata packets are sent to the RTP multiplexer. The process 1100 proceeds to step 1156.

At step 1156, the RTP multiplexer multiplexes the data into a RTP multiplexed stream. The process 1100 proceeds to step 1158 and/or step 1180 and/or decision block 1182. At step 1158, the RTP multiplexed packets are sent to the RTP sender. At step 1180, the RTP multiplexer reports the multiplexed bitrate to the Wi-Fi management application. The process 1100 proceeds to decision block 1182.

At decision block 1182, if changes in the multiplexed bitrate are identified, the process returns to step 1180.

At step 1160, the RTP sender sends the RTP multiplexed packets to the RTP packet priority queue. The process 1100 proceeds to step 1162 and/or step 1166 and/or decision block 1164. At step 1162, the RTP packet priority queue reports a queue size to the rate and video encoding properties controller. The process 1100 proceeds to decision block 1164.

At decision block 1164, if changes in the priority queue size are identified, the process 1100 returns to step 1162.

At step 1166, the transmission scheduler retrieves a RTP packet from the RTP packet priority queue and transmits the RTP packets on any active open UDP sockets. At step 1168, the network congestion controller may perform any of the steps described herein in connection with FIG. 11 (e.g., process 1100 and/or process 1101). At step 1170, the transmission scheduler waits on the CWND, RTT/bytes in flight, RTCP retransmit requests, and/or RTP/RTCP success reports from the network congestion controller. The process 1100 proceeds to decision block 1172.

At step 1172, if the transmission scheduler receives the CWND, RTT/bytes in flight, RTCP retransmits requests, and/or the RTP/RTCP success packets from the network congestion controller, the process proceeds to decision block 1174. If the transmissions scheduler does not receive such information from the network congestion controller, the process 1110, returns to step 1168.

At step 1174, if the transmission scheduler receives an RTCP retransmit request, the process proceeds to step 1176. If the transmission scheduler receives an RTP/RTCP success packet, the process proceeds to step 1178. At step 1176, the transmission scheduler retrieves the packet to transmit from the RTP packet priority queue and transmits the RTP packet with the SSRC ID for a retransmit of the dropped packet. At step 1178, the successfully transmitted RTP packet (e.g., indicated in the RTCP success packet) is removed from the RTP packet priority queue and the next RTP packet is retrieved from the RTP packet priority queue by the transmission scheduler and is sent over each connected/active UDP socket (e.g., both Wi-Fi/fixed line and mobile). The process 1110 returns to decision block 1172.

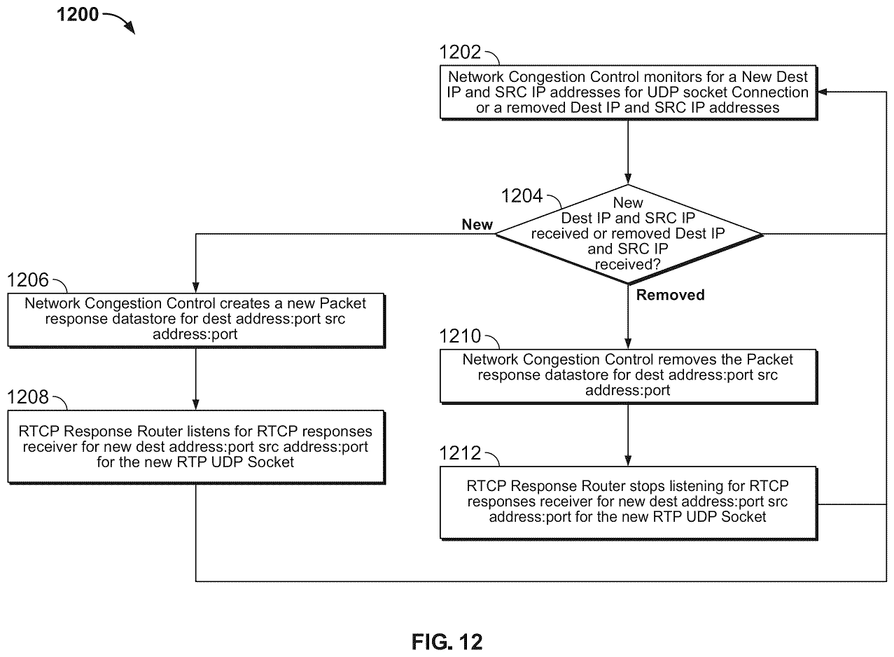

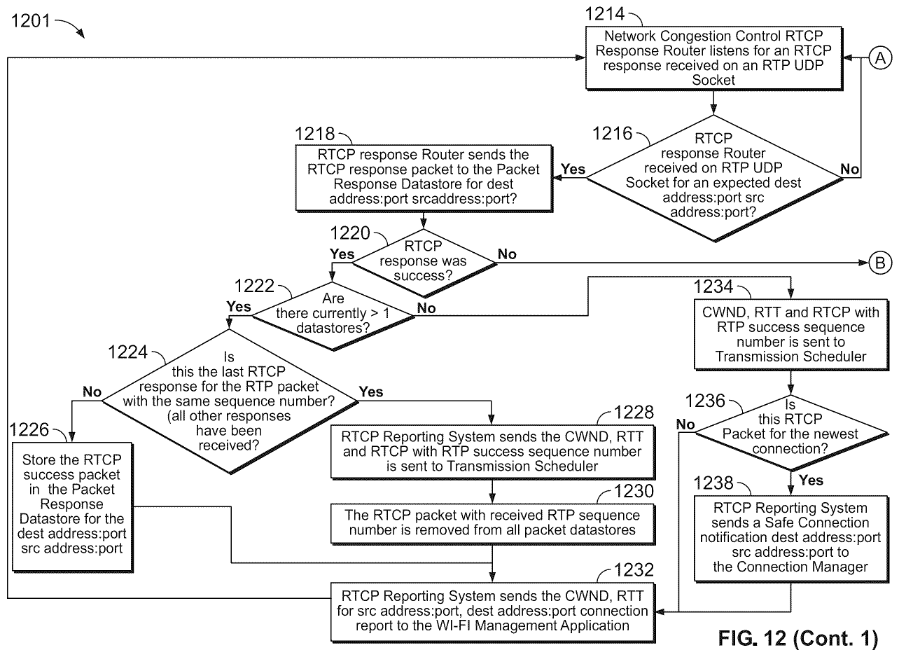

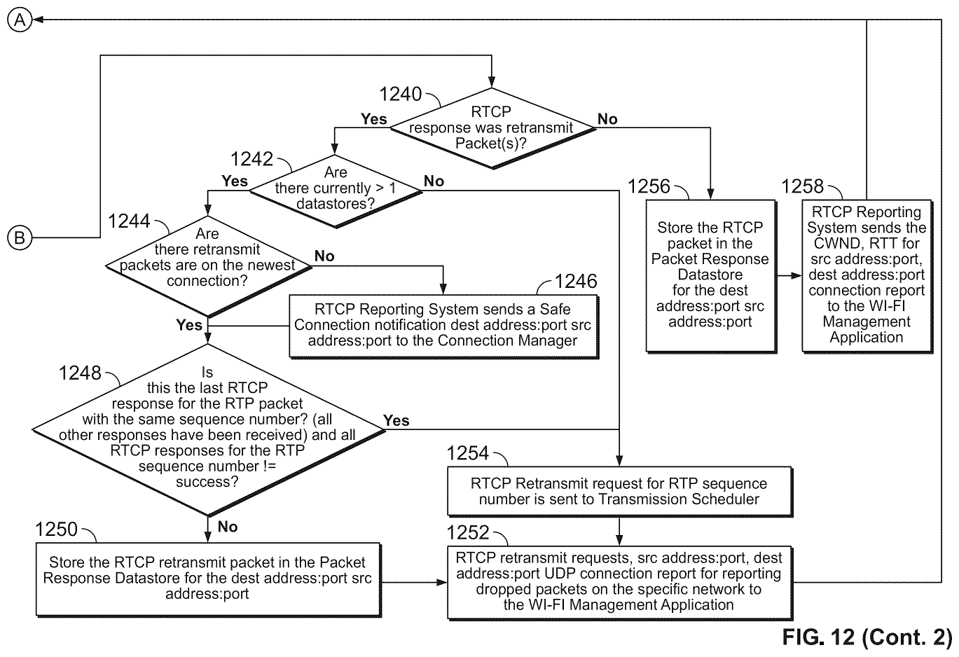

FIG. 12 is a flowchart of illustrative processes of a dual network sender network congestion controller for addition and removal of connections (e.g., based on determination of a network congestion QoS and/or during connection transfer), in accordance with some embodiments of this disclosure. In various embodiments, the individual steps of processes 1200 and 1201 are implemented by one or more components of the devices, methods, and systems of FIGS. 1-22 and are performed in combination with any of the other processes and aspects described herein. Although the present disclosure may describe certain steps of processes 1200 and 1201 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1202 (e.g., of process 1200), the network congestion controller monitors for new destination and/or source IP addresses for UDP socket connections or removed destination and/or source IP addresses, and the process 1200 proceeds to decision block 1204. For example, removed destination and/or source IP addresses indicate that a connection for an address port has been lost (e.g., due to a UDP socket disconnect) and RTCP packets no longer need to be monitored for the given connection.

At decision block 1204, if new destination and/or source IP addresses are received, the process 1200 proceeds to step 1206. If destination and/or source IP address are removed, the process 1200 proceeds to step 1210. If destination and/or source IP address are neither received nor removed, the process 1200 returns to step 1202.

At step 1206, the network congestion controller creates a new packet response datastore for the destination address and/or source address. At step 1208, the RTCP response router listens for RTCP responses for new destination address and/or source addresses for the new RTP UDP socket. The process 1200 returns to step 1202.

At step 1210, the network congestion controller removes the packet response datastore for the destination address and/or source address. At step 1212, the RTCP response router stops listening for RTCP responses for new destination addresses and/or source addresses for the new RTP UDP socket. The process 1200 returns to step 1202.

At step 1214 (e.g., of process 1201), the network congestion controller RTCP response router listens for an RTCP response received on an RTP UDP socket. The process 1201 proceeds to decision block 1216.

At decision block 1216, if the RTCP response router receives an RTCP response packet from an RTP UDP socket for an expected destination and/or source address, the process proceeds to step 1218. If the RTCP response router receives no such RTCP response packet, the process 1201 returns to step 1214.

At step 1218, the RTCP response router sends the RTCP response packet to the packet response datastore for the destination address and/or source address. The process 1201 proceeds to decision block 1220.

At decision block 1220, if the RTCP response was a success, the process 1201 proceeds to decision block 1222. If the RTCP response was not a success, the process 1201 proceeds to decision block 1240.

At decision block 1222, if there are currently more than one data stores, the process proceeds to decision block 1224. If there are not currently more than one data stores, at step 1234, the CWND, RTT, and RTCP packet with RTP success sequence number is sent to the transmission scheduler before the process 1201 proceeds to decision block 1236.

At decision block 1224, if the RTCP success packet is the last RTCP response packet for its sequence number (e.g., all responses for the RTP packet with the sequence number have been received), at step 1226, the RTCP success packet is stored in the packet response datastore for the destination and/or source address and the process 1201 proceeds to step 1232. At step 1232, the RTCP reporting system sends the CWND and/or RTT for the source and/or destination address via a connection report to the Wi-Fi management application. The process 1201 returns to step 1214.

At step 1228, the RTCP reporting system sends the CWND, RTT, and/or RTCP packet with RTP success sequence number to the transmission scheduler. At step 1230, the RTCP packet with received RTP sequence number is removed from all packet databases. The process 1201 proceeds to step 1232.

At decision block 1236, if the RTCP packet is received from the newest connection, at step 1238, the RTCP reporting system sends a safe connection notification for the destination and/or source address to the connection manager, and the process 1201 proceeds to step 1232. If the RTCP packet is not received from the newest connection, the process 1201 proceeds directly to step 1232.

At decision block 1240, if the RTCP response packet is a retransmit packet, the process 1201 proceeds to decision block 1242. If the RTCP response packet is not a retransmit packet, at step 1256, the RTCP packet is stored in the packet response datastore for the destination and/or source address and, at step 1258, the RTCP reporting system sends the CWND and/or RTT for the source and/or destination address via a connection report to the Wi-Fi management application. The process 1201 returns to step 1214.

At decision block 1242, if there are currently more than one datastores in the network congestion controller, the process proceeds to decision block 1244. If there is currently less than two datastores in the network congestion controller, at step 1254, the RTCP retransmit request for the RTP sequence number is sent to the transmission scheduler, and, at step 1252, the RTCP retransmission request source and/or destination address UDP connection report is sent to the Wi-Fi management application to report dropped packets on a particular network. The process 1201 returns to step 1214.

At decision block 1244, if there are retransmit packets on the newest connection, the process 1201 proceeds directly to decision block 1248. If there are not retransmit packets on the newest connection, at step 1246, the RTCP reporting system sends a safe connection notification for the destination and/or source address to the connection manager, and the process 1201 proceeds to decision block 1248.

At decision block 1248, if the RTCP response packet is the last RTCP response for the particular sequence number (e.g., all other responses have been received for a particular RTP sequence number) and all other RTCP responses for the RTP sequence numbers do not indicate success, the process proceeds to step 1254. If the RTCP response packet is not the last RTCP response for the particular sequence number or any of the other RTCP responses for the RTP sequence number indicate success, at step 1250, the RTCP retransmit packet is stored in the packet response datastore for the destination and/or source address, and the process proceeds to step 1252.

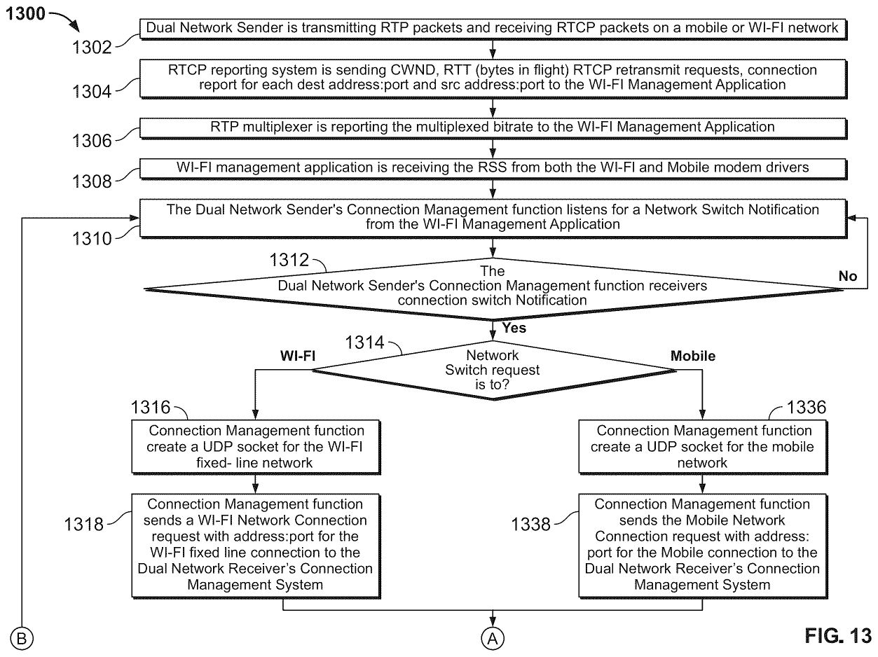

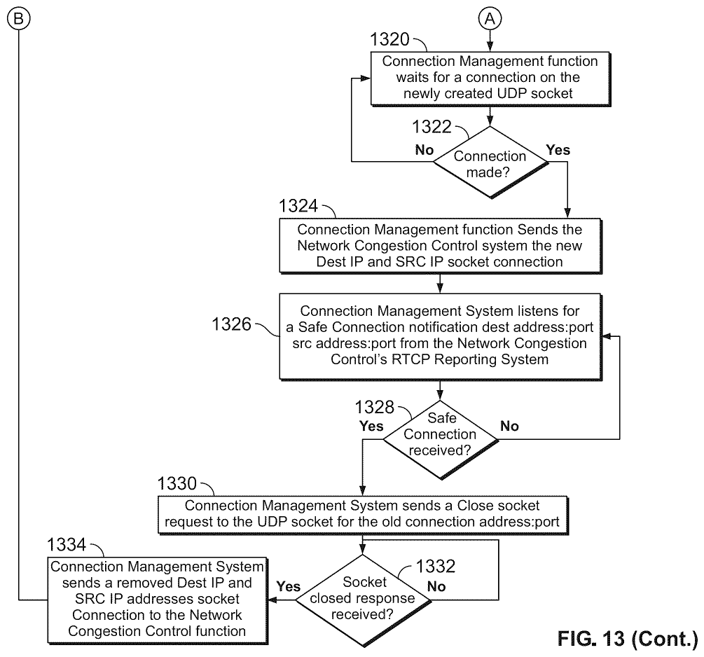

FIG. 13 is a flowchart of illustrative processes of a dual sender connection manage working with a Wi-Fi management application, in accordance with some embodiments of this disclosure. In various embodiments, the individual steps of processes 1300 are implemented by one or more components of the devices, methods, and systems of FIGS. 1-22 and are performed in combination with any of the other processes and aspects described herein. Although the present disclosure may describe certain steps of processes 1300 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1302, the dual network sender is transmitting RTP packets and receiving RTCP packets on a mobile or Wi-Fi network. At step 1304, the RTCP reporting system is sending CWND, RTT/bytes in flight, RTCP retransmit requests, and/or connection reports for each destination and/or source address to the Wi-Fi management application. At step 1306, the RTP multiplexer is reporting the multiplexed bitrate to the Wi-Fi management application. At step 1308, the Wi-Fi management application is receiving the RSSI from both the Wi-Fi and mobile modem drivers. At step 1310, the dual network sender connection manager listens for a network switch notification from the Wi-Fi management application. The process 1300 proceeds to decision block 1312.

At decision block 1312, if the dual network sender connection manager receives a connection switch notification, the process 1300 proceeds to decision block 1314. If the connection manager does not receive a connection switch notification, the process 1300 returns to step 1310.

At decision block 1314, if the network switch request is to the Wi-Fi/fixed line network, at step 1316, the connection manager creates a UDP socket for the Wi-Fi/fixed line network, and, at step 1318, the connection manager sends a Wi-Fi network connection request with an address port for the Wi-Fi/fixed line connection to dual network receiver connection manager. The process 1300 proceeds to step 1320. At step 1320, the connection manager waits for a connection on the newly created UDP socket. The process 1300 proceeds to decision block 1322

At decision block 1314, if the network switch request is to the mobile network, at step 1336, the connection manager creates a UDP socket for the mobile network, and, at step 1338, the connection manager sends a mobile network connection request with an address port for the mobile connection to the dual network receiver connection manager. The process 1300 proceeds to step 1320 and then to decision block 1322.

At decision block 1322, if a connection is made, at step 1324, the connection manager sends the network congestion controller the new destination and/or source IP address for the UDP socket connection, and, at step 1326, the connection manager listens for a safe connection notification from the network congestion controller RTCP reporting system. The process 1300 proceeds to decision block 1328. At decision block 1322, if a connection is not made, the process 1300 returns to step 1320.

At decision block 1328, if the safe connection notification has been received, at step 1330, the connection manager sends a close socket request to the UDP socket for the old connection address port and the process 1300 proceeds to decision block 1332. At decision block 1328, if the safe connection notification has not been received, the process 1300 returns to step 1326.

At decision block 1332, if the socket close response has been received, at step 1334, the connection manager sends the removed destination and/or source IP addresses for the UDP socket connection to the network congestion controller. The process 1300 returns to step 1310. At decision block 1332, if the socket close response has not been received, the process 1300 remains at decision block 1332.

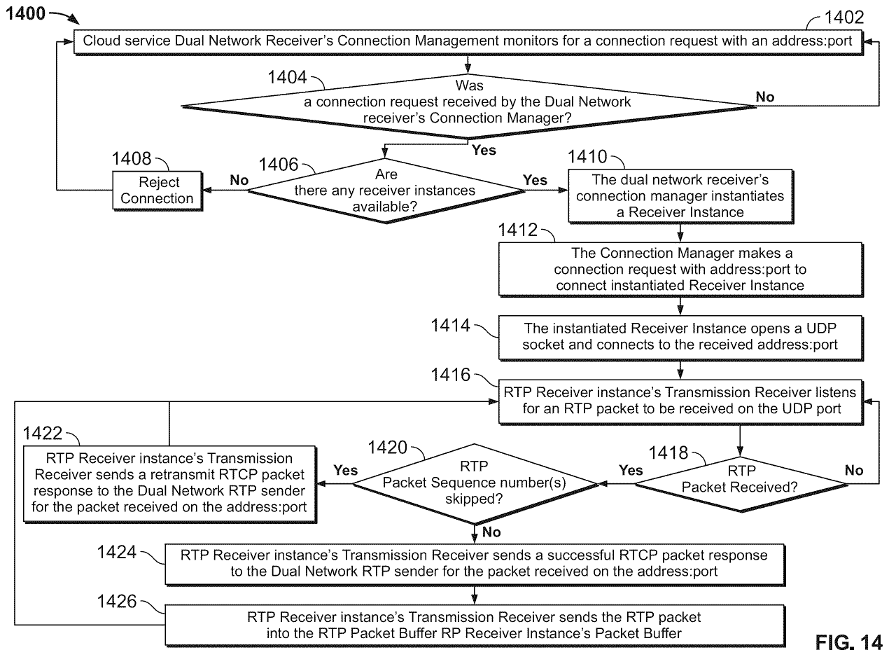

FIG. 14 is a flowchart of illustrative processes for cloud ultra-low latency cloud dual network receiver connection, in accordance with some embodiments of this disclosure. In various embodiments, the individual steps of processes 1400 are implemented by one or more components of the devices, methods, and systems of FIGS. 1-22 and are performed in combination with any of the other processes and aspects described herein. Although the present disclosure may describe certain steps of processes 1400 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1402, the cloud service dual network receiver's connection manager monitors for a connection request with an address port. The process 1400 proceeds to decision block 1404.

At decision block 1404, if a connection request was received by the network receiver connection manager, the process 1400 proceeds to decision block 1406. If the connection request was not received, the process 1400 returns to step 1402.

At decision block 1406, if there are any receiver instances available, the process 1400 proceeds to step 1410. If there are no receiver instance available, at step 1408, the connection is rejected, and the process 1400 returns to step 1402. At step 1410, the dual network receiver connection manager instantiates a receiver instance. At step 1412, the connection manager makes a connection request with the address port to connect the instantiated receiver instance. At step 1414, the instantiated receiver instance opens a UDP socket and connects to the received address port. At step 1416, the RTP receiver instance transmission receiver listens for an RTP packet to be received on the UDP port. The process 1400 proceeds to decision block 1418.

At decision block 1418, if the RTP packet is received, the process 1400 proceeds to decision block 1420. If the RTP packet is not received, the process 1400 returns to step 1416.

At decision block 1420, if the RTP packet sequence number is skipped, at step 1422, the RTP receiver instance transmission receiver sends a retransmit RTCP packet response to the dual network RTP sender for the packet received on the address port, and the process 1400 returns to step 1416.

At decision block 1420, if the RTP packet sequence number is not skipped, at step 1424, the RTP receiver instance transmission receiver sends an RTCP success packet to the dual network RTP sender for the packet received on the address port, and, at step 1424, the RTP receiver instance transmission receiver sends the RTP packet into the RTP receiver instance packet buffer. The process 1400 returns to step 1416.

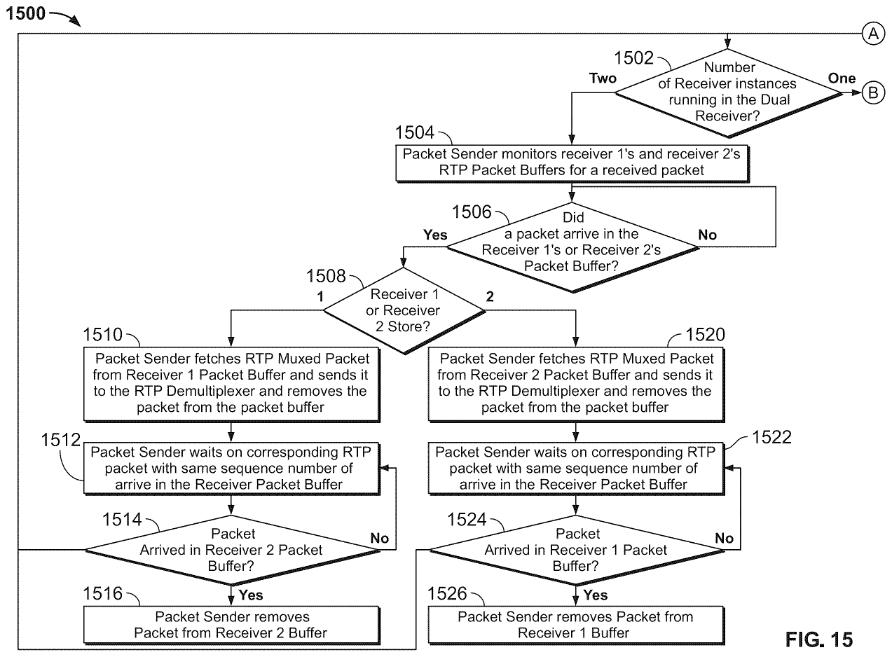

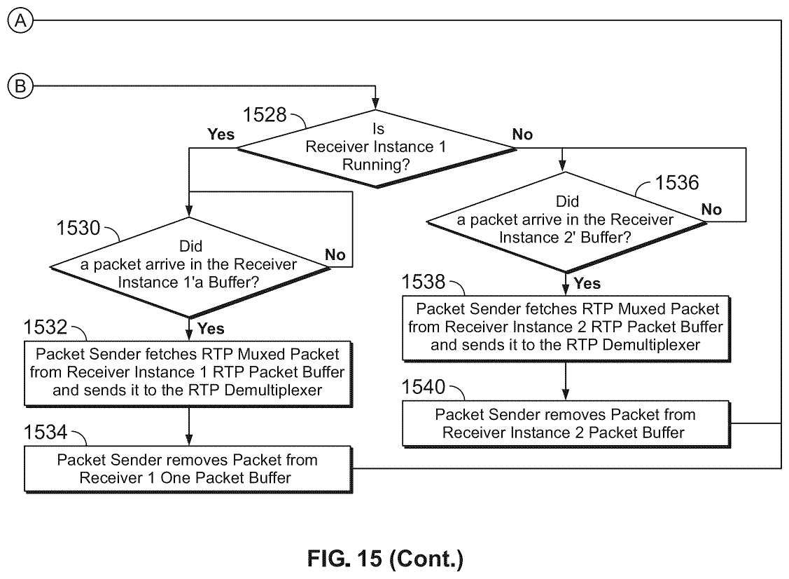

FIG. 15 is a flowchart of illustrative processes for a packet sender running in a cloud service, in accordance with some embodiments of this disclosure. In various embodiments, the individual steps of processes 1500 are implemented by one or more components of the devices, methods, and systems of FIGS. 1-22 and are performed in combination with any of the other processes and aspects described herein. Although the present disclosure may describe certain steps of processes 1500 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At decision block 1502, if the number of receiver instances running in the dual receiver is two, at step 1504, the packet sender monitors the packet buffer of both receivers for a received packet and proceeds to decision block 1506. At decision block 1502, if the number of receiver instances running in the dual receiver is one, the process proceeds to decision block 1528.

At decision block 1506, if a packet has arrived in either packet buffer the process 1500 proceeds to decision block 1508. If no packet has arrived in either packet buffer, the process 1500 remains at decision block 1508.

At decision block 1508, if the packet arrived in the packet buffer of receiver 1, at step 1510, the packet sender fetches the RTP multiplexed packet from the receiver 1 packet buffer, sends the packet to the RTP demultiplexer, and removes the packet from the packet buffer. At step 1512, the packet sender waits on the corresponding RTP packet with the same sequence number to arrive in the receiver 2 packet buffer. The process 1500 proceeds to decision block 1514.

At decision block 1514, if the corresponding RTP packet has arrived in the receiver 2 packet buffer, at step 1516, the packet sender removes the corresponding RTP packet from the receiver 2 packet buffer. If the corresponding RTP packet has not arrived in the receiver 2 packet buffer, the process 1500 returns to step 1502.

At decision block 1508, if the packet arrived in the packet buffer of receiver 2, at step 1520, the packet sender fetches the RTP multiplexed packet from the receiver 2 packet buffer, sends the packet to the RTP demultiplexer, and removes the packet from the packet buffer. At step 1522, the packet sender waits on the corresponding RTP packet with the same sequence number to arrive in the receiver 1 packet buffer. The process 1500 proceeds to decision block 1524.

At decision block 1524, if the corresponding RTP packet has arrived in the receiver 1 packet buffer, at step 1526, the packet sender removes the corresponding RTP packet from the receiver 1 packet buffer. If the corresponding RTP packet has not arrived in the receiver 1 packet buffer, the process 1500 returns to step 1502.

At decision block 1528, if receiver instance 1 is running, the process 1530 proceeds to decision block 1530. If receiver instance 2 is running, the process 1500 proceeds to decision block 1536.

At decision block 1530, if a packet has arrived in the receiver instance 1 packet buffer, at step 1532, the packet sender fetches the RTP multiplexed packet from the receiver instance 1 RTP packet buffer and sends it to the RTP demultiplexer. At step 1534, the packet sender removes the packet from the receiver instance 1 packet buffer. The process 1500 returns to step 1502.

At decision block 1536, if a packet has arrived in the receiver instance 2 packet buffer, at step 1538, the packet sender fetches the RTP multiplexed packet from the receiver instance 2 RTP packet buffer and sends it to the RTP demultiplexer. At step 1540, the packet sender removes the packet from the receiver instance 2 packet buffer. The process 1500 returns to step 1502.

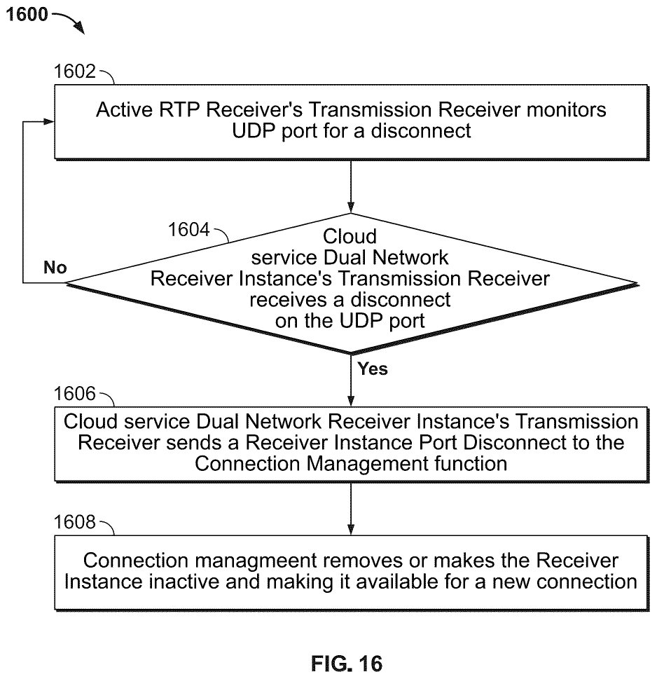

FIG. 16 is a flowchart of illustrative processes for cloud ultra-low latency dual network receiver disconnection, in accordance with some embodiments of this disclosure. In various embodiments, the individual steps of processes 1600 are implemented by one or more components of the devices, methods, and systems of FIGS. 1-22 and are performed in combination with any of the other processes and aspects described herein. Although the present disclosure may describe certain steps of processes 1600 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1602, the active RTP receiver instance transmission receiver monitors the UDP port for a disconnect. The process 1600 proceeds to decision block 1604.

At decision block 1604, if the cloud service dual network receiver instance transmission receiver receives a disconnection on the UDP port, the process 1600 proceeds to step 1606. If the transmission receiver does not receive a disconnection on the UDP port, the process 1600 returns to step 1602.

At step 1606, the cloud service dual network receiver instance transmission receiver sends a receiver instance port disconnect to the connection manager. At step 1608, the connection manager terminates and/or deactivates the receiver instance, making it available for a new connection.

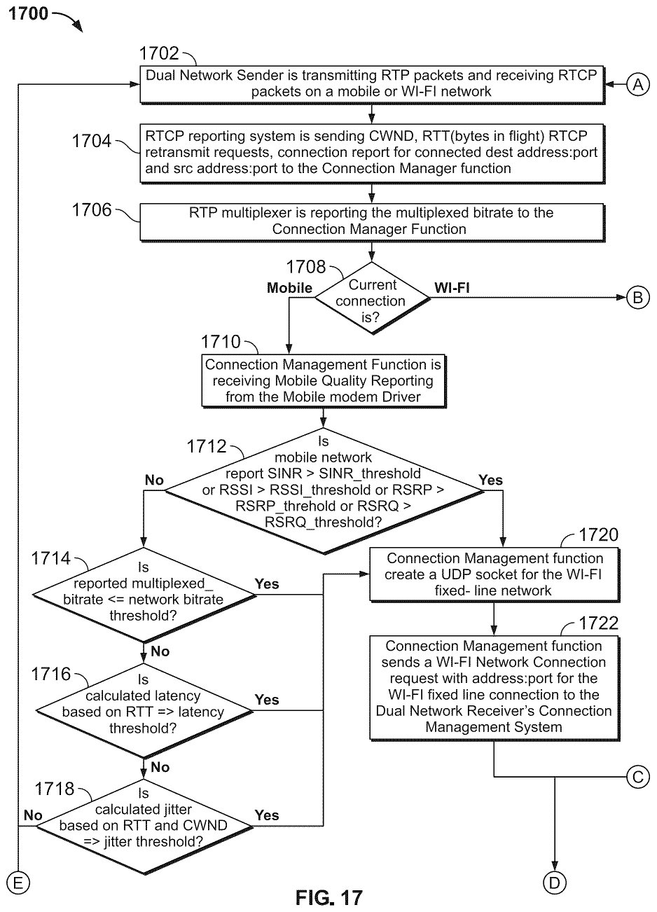

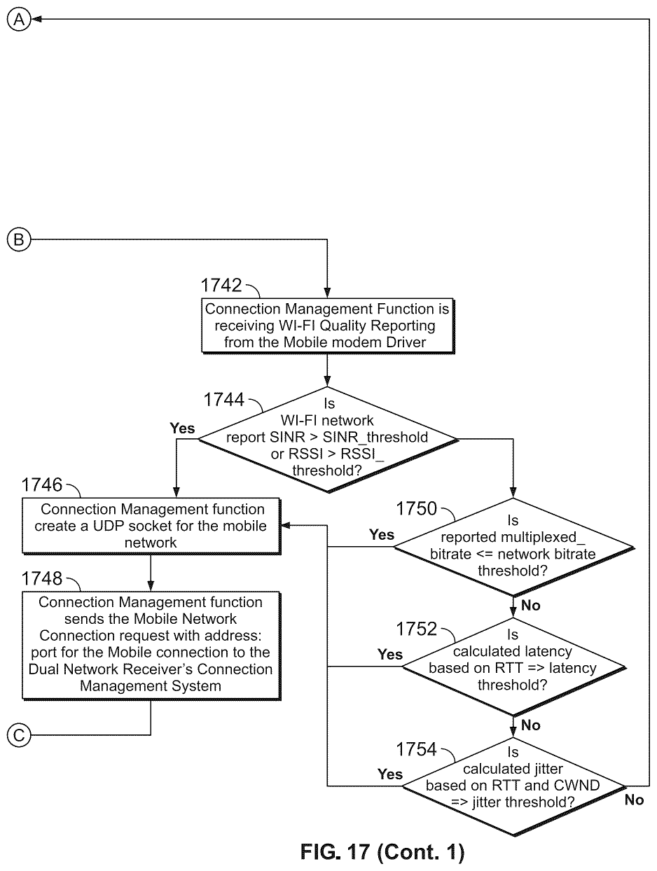

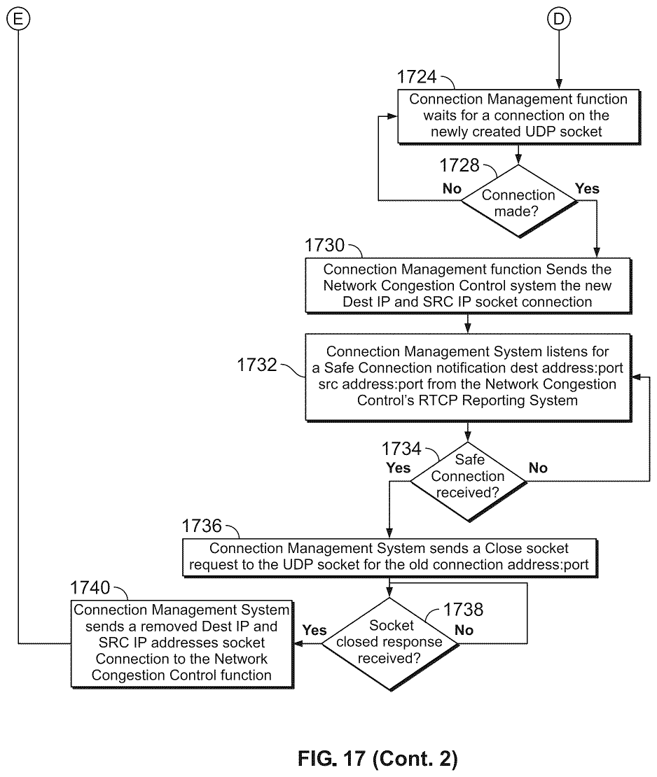

FIG. 17 is a flowchart of illustrative processes for a dual network sender connection manager operating with a Wi-Fi management application, in accordance with some embodiments of this disclosure. In various embodiments, the individual steps of processes 1700 are implemented by one or more components of the devices, methods, and systems of FIGS. 1-22 and are performed in combination with any of the other processes and aspects described herein. Although the present disclosure may describe certain steps of processes 1700 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead.

At step 1702, the dual network sender is transmitting RTP packets and receiving RTCP packets on a mobile or Wi-Fi network. At step 1704, the RTCP reporting system is sending CWND, RTT/bytes in flight, RTCP retransmit request, and/or connection reports for connected destination and/or source addresses to the connection manager. At step 1706, the RTP multiplexer is reporting the multiplexed bitrate to the connection manager. The process 1700 proceeds to decision block 1708.

At decision block 1708, if the current connection is a mobile connection, at step 1710, the connection manager receives mobile quality reporting from the mobile modem and/or driver. The process 1700 proceeds to decision block 1712.

At decision block 1712, if the mobile network reports at least one metric (e.g., SINR, RSSI, RSRP, RSRQ) as being greater than a corresponding threshold, the process 1700 proceeds to step 1720. If the mobile network reports all metrics as being less than their corresponding thresholds, the process 1700 proceeds to decision block 1714.

At decision block 1714, if the reported multiplexed bitrate is less than or equal to the network bitrate threshold, the process 1700 proceeds to step 1720. If the reported multiplexed bitrate is greater than the network bitrate threshold, the process 1700 proceeds to decision block 1716.

At decision block 1716, if the calculated latency based on RTT is greater than or equal to a latency threshold, the process 1700 proceeds to step 1720. If the calculated latency based on RTT is less than the latency threshold, the process 1700 proceeds to decision block 1718.

At decision block 1718, if the calculated jitter based on RTT and CWND is greater than or equal to a jitter threshold, the process 1700 proceeds to step 1720. If the calculated jitter is less than the jitter threshold, the process 1700 returns to step 1702.

At step 1720, the connection manager creates a UDP socket for the Wi-Fi/fixed line network. At step 1722, the connection manager sends a Wi-Fi/fixed line network connection request with an address port for the Wi-Fi/fixed line connection to the dual network receiver connection manager. At step 1724, the connection manager waits for a new connection on the newly created UDP socket. The process 1700 proceeds to decision block 1728.

At decision block 1708, if the current network connection is Wi-Fi/fixed line network, at step 1742, the connection manager receives Wi-Fi/fixed line network quality reporting from the Wi-Fi/fixed line modem and/or driver. The process proceeds to decision block 1744.

At decision block 1744, if the Wi-Fi/fixed line network reports a SINR greater than the SINR threshold or a RSSI greater than the RSSI threshold, at step 1746, the connection manager creates a UDP socket for the mobile network. At step 1748, the connection manager sends the mobile network connection request with an address port for the mobile connection to the dual network receiver connection manager. The process 1700 proceeds to step 1724.

At decision block 1744, if the Wi-Fi/fixed line network reports SINR less than or equal to the SINR threshold, and RSSI less than or equal to the RSSI threshold, the process 1700 proceeds to decision block 1750.

At decision block 1750, if the reported multiplexed bitrate is less than or equal to the network bitrate threshold, the process 1700 proceeds to step 1746. If the reported multiplexed bitrate is greater than the network bitrate threshold, the process 1700 proceeds to decision block 1752.

At decision block 1752, if the calculated latency based on RTT is greater than or equal to the latency threshold, the process 1700 proceeds to step 1746. If the calculated latency is less than the latency threshold, the process 1700 proceeds to decision block 1754. If the calculated jitter based on RTT and CWND is greater than or equal to the jitter threshold, the process 1700 proceeds to step 1746. If the calculated jitter is less than the jitter threshold, the process 1700 returns to step 1702.

At decision block 1728, if a connection was made to the newly created UDP socket, the process 1700 proceeds to step 1730. If no connection was made, the process 1700 returns to step 1724. At step 1730, the connection manager sends the network congestion controller the new destination and/or source IP address for the UDP socket connection. At step 1732, the connection manager listens for a safe connection notification for the destination and/or source address from the network congestion controller RTCP reporting system. The process 1700 proceeds to decision block 1734.

At decision block 1734, if a safe connection notification is received, at step 1736, the connection manager sends a close socket request to the UDP socket for the old connection address port, and the process 1700 proceeds to decision block 1738. If no safe connection notification is received, the process 1700 returns to step 1732.

At decision block 1738, if a socket close response is received, at step 1740, the connection manager sends a removed destination and/or source IP address for the UDP socket connection to the network congestion controller, and the process 1700 returns to step 1702. If the socket close response is not received, the process 1700 remains at decision block 1738.

FIGS. 18-19 show illustrative devices, systems, servers, and related hardware for generating a multi-layer image, in accordance with some embodiments of this disclosure. FIG. 18 is a diagram of an illustrative system 1800, in accordance with some embodiments of this disclosure. Computing devices 1807, 1808, 1810 (which may correspond to, e.g., computing device 1900 or 1901 of FIG. 19) may be coupled to communication network 1809. Communication network 1809 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1809) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 18 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 302-11x, etc.), or other short-range communication via wired or wireless paths. The computing devices may also communicate with each other directly through an indirect path via communication network 1809.

System 1800 may comprise media content source 1802, one or more servers 1804, and/or one or more edge computing devices. In some embodiments, system or application may be executed at one or more of control circuitry 1811 of server 1804 (and/or control circuitry of computing devices 1807, 1808, 1810 and/or control circuitry of one or more edge computing devices). In some embodiments, the media content source and/or server 1804 may be configured to host or otherwise facilitate video communication sessions between computing devices 1807, 1808, 1810 and/or any other suitable computing devices, and/or host or otherwise be in communication (e.g., over network 1809) with one or more social network services.

In some embodiments, server 1804 may include control circuitry 1811 and storage 1814 (e.g., RAM, ROM, Hard Disk, Removable Disk, etc.). Storage 1814 may store one or more databases. Storage 1814 may store in a non-transitory memory, instructions for the AV application. Server 1804 may also include an input/output path 1812. I/O path 1812 may include or correspond to input circuitry and/or output circuitry. I/O path 1812 may be used to send and receive commands, requests, and other suitable data. I/O path 1812 may provide content (e.g., content items), machine learning model inputs and/or outputs, device information, or other data, over a local area network (LAN) or wide area network (WAN), and/or other content and data to control circuitry 1811, which may include processing circuitry, and storage 1814. Control circuitry 1811 may be used to send and receive commands, requests, and other suitable data using I/O path 1812, which may comprise I/O circuitry. I/O path 1812 may connect control circuitry 1811 (and specifically control circuitry) to one or more communications paths. In some embodiments, I/O circuitry includes one or more sockets and/or ports (e.g., UDP sockets, RTP sockets, UDP socket ports, RTP socket ports, or the like). For example, a UDP socket instance (e.g., UDP socket 330 of FIGS. 3A-3B) corresponds to multiple physical UDP sockets within the I/O circuitry.

Control circuitry 1811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1811 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1811 executes instructions for an emulation system application stored in memory (e.g., the storage 1814). Memory may be an electronic storage device provided as storage 1814 that is part of control circuitry 1811.

FIG. 19 shows generalized embodiments of illustrative computing devices 1900 and 1901, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 1901 may be a user television equipment system or device.

User television equipment device 1901 may include set-top box 1915. Set-top box 1915 may be communicatively connected to microphone 1916, Audio output equipment (e.g., speaker or headphones 1914), and display 1912. In some embodiments, microphone 1916 may receive audio corresponding to a voice of a user providing input. In some embodiments, display 1912 may be a television display or a computer display. In some embodiments, set-top box 1915 may be communicatively connected to user input interface 1910. In some embodiments, user input interface 1910 may be a remote control device. Set-top box 1915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 18. In some embodiments, computing device 1900 may comprise any suitable number of sensors (e.g., gyroscope or accelerometer, etc.), and/or a GPS module (e.g., in communication with one or more servers and/or cell towers and/or satellites) to ascertain a position of computing device 1900. In some embodiments, computing device 1900 comprises a rechargeable battery that is configured to provide power to the components of the device.

Each one of computing device 1900 and computing device 1901 may receive content and data via input/output (I/O) path 1902. I/O path 1902 may provide content (e.g., broadcast programming, on-demand programming, Internet content, content available over a local area network (LAN) or wide area network (WAN), and/or other content) and data to control circuitry 1904, which may comprise processing circuitry 1906 and storage 1908. Control circuitry 1904 may be used to send and receive commands, requests, and other suitable data using I/O path 1902, which may comprise I/O circuitry. I/O path 1902 may connect control circuitry 1904 (and specifically processing circuitry 1906) to one or more communications paths (described below). I/O functions may be provided by one or more of these communications paths, but are shown as a single path in FIG. 18 to avoid overcomplicating the drawing. While set-top box 1915 is shown in FIG. 9 for illustration, any suitable computing device having processing circuitry, control circuitry, and storage may be used in accordance with the present disclosure. For example, set-top box 1915 may be replaced by, or complemented by, a personal computer (e.g., a notebook, a laptop, a desktop), a smartphone (e.g., computing device 1900), an XR device; a tablet; a network-based server hosting a user-accessible client device; a non-user-owned device; any other suitable device; or any combination thereof.

Control circuitry 1904 may be based on any suitable control circuitry such as processing circuitry 1906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1904 executes instructions for the system or application stored in memory (e.g., storage 1908). Specifically, control circuitry 1904 may be instructed by the system or application to perform the functions discussed above and below. In some implementations, processing or actions performed by control circuitry 1904 may be based on instructions received from the system or application.

In client/server-based embodiments, control circuitry 1904 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 1908, and executed by control circuitry 1904 of a computing device 1900.

In some embodiments, the system or application may be a client/server application where only the client application resides on device 1900 (e.g., computing device 182), and a server application resides on an external server (e.g., server 1804). For example, the system or application may be implemented partially as a client application on control circuitry 1904 of device 1900 and partially on server 1804 as a server application running on control circuitry 1811. Server 1804 may be a part of a local area network with one or more of computing devices 1900, 1901 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1804 and/or an edge computing device), referred to as “the cloud.” Device 1900 may be a cloud client that relies on the cloud computing capabilities from server 1804 to determine whether processing should be offloaded from the mobile device, and facilitate such offloading. When executed by control circuitry of server 1804, the system or application may instruct control circuitry 1811 to perform processing tasks for the client device and facilitate the analysis of content items. The client application may instruct control circuitry 1904 to determine whether processing should be offloaded.

Control circuitry 1904 may include communications circuitry suitable for communicating with a server, edge computing systems and devices, a table or database server, or other networks or servers The instructions for carrying out the above-mentioned functionality may be stored on a server (which is described in more detail in connection with FIG. 18. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 18). In addition, communications circuitry may include circuitry that enables peer-to-peer communication of computing devices, or communication of computing devices in positions remote from each other (described in more detail below).

Memory may be an electronic storage device provided as storage 1908 that is part of control circuitry 1904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1908 may be used to store various types of content described herein as well as the system or application data described above. Storage 1908 may store in non-transitory memory instructions for AV application. Nonvolatile memory may also be used (e.g., to launch a boot-up routine and other instructions). Cloud-based storage, described in more detail in relation to FIG. 18, may be used to supplement storage 1908 or instead of storage 1908.

Control circuitry 1904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1904 may also include scaler circuitry for upconverting and downconverting content into the preferred output format of computing device 1900. Control circuitry 1904 may also include digital-to-analog converter circuitry and analog-to-digital converter circuitry for converting between digital and analog signals. The tuning and encoding circuitry may be used by computing device 1900, 1901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1908 is provided as a separate device from computing device 1900, the tuning encoding circuitry (including multiple tuners) may be associated with storage 1908.

Control circuitry 1904 may receive instruction from a user by way of user input interface 1910. User input interface 1910 may be any suitable user interface, such as a remote control, mouse, trackball, keypad, keyboard, touch screen, touchpad, stylus input, joystick, voice recognition interface, or other user input interfaces. Display 1912 may be provided as a stand-alone device or integrated with other elements of each one of computing device 1900 and computing device 1901. For example, display 1912 may be a touchscreen or touch-sensitive display. In such circumstances, user input interface 1910 may be integrated with or combined with display 1912. In some embodiments, user input interface 1910 includes a remote-control device having one or more microphones, buttons, keypads, any other components configured to receive user input or combinations thereof. For example, user input interface 1910 may include a handheld remote-control device having an alphanumeric keypad and option buttons. In a further example, user input interface 1910 may include a handheld remote-control device having a microphone and control circuitry configured to receive and identify voice commands and transmit information to set-top box 1915.

Audio output equipment 1914 may be integrated with or combined with display 1912. Display 1912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1912. Audio output equipment 1914 may be provided as integrated with other elements of each one of computing device 1900 and computing device 1901 or may be stand-alone units. An audio component of videos and other content displayed on display 1912 may be played through speakers (or headphones) of audio output equipment 1914. In some embodiments, audio may be distributed to a receiver (not shown), which processes and outputs the audio via speakers of audio output equipment 1914. In some embodiments, for example, control circuitry 1904 is configured to provide audio cues to a user, or other audio feedback to a user, using speakers of audio output equipment 1914. There may be a separate microphone 1916 or audio output equipment 1914 may include a microphone configured to receive audio input such as voice commands or speech. For example, a user may speak letters, words, terms, or numbers that are received by the microphone and converted to text by control circuitry 1904. In a further example, a user may voice commands that are received by a microphone and recognized by control circuitry 1904. Camera 1918 may be any suitable video camera integrated with the equipment or externally connected. Camera 1918 may be a digital camera comprising a charge-coupled device (CCD) and/or a complementary metal-oxide semiconductor (CMOS) image sensor. Camera 1918 may be an analog camera that converts to digital images via a video card.

The system or application may be implemented using any suitable architecture. For example, it may be a stand-alone application wholly-implemented on each one of computing device 1900 and computing device 1901. In such an approach, instructions of the application may be stored locally (e.g., in storage 1908), and data for use by the application is downloaded on a periodic basis (e.g., from an out-of-band feed, from an Internet resource, or using another suitable approach). Control circuitry 1904 may retrieve instructions of the application from storage 1908 and process the instructions to provide the functionality, and generate any of the displays, discussed herein. Based on the processed instructions, control circuitry 1904 may determine what action to perform when input is received from user input interface 1910. For example, movement of a cursor on a display up/down may be indicated by the processed instructions when user input interface 1910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1904 may allow a user to provide user profile information or may automatically compile user profile information. For example, control circuitry 1904 may access and monitor network data, video data, audio data, computing data, historical interactions by the user, and/or any other suitable data. Control circuitry 1904 may obtain all or part of other user profiles that are related to a particular user (e.g., via social media networks), and/or obtain information about the user from other sources that control circuitry 1904 may access. As a result, a user can be provided with a unified experience across the user's different devices.

In some embodiments, the system or application is a client/server-based application. Data for use by a thick or thin client implemented on each one of computing device 1900 and computing device 1901 may be retrieved on-demand by issuing requests to a server remote to each one of computing device 1900 and computing device 1901. For example, the remote server may store the instructions for the application in a storage device. The remote server may process the stored instructions using circuitry (e.g., control circuitry 1904) and generate the displays discussed above and below. The client device may receive the displays generated by the remote server and may display the content of the displays locally on computing device 1900. This way, the processing of the instructions is performed remotely by the server while the resulting displays (e.g., that may include text, a keyboard, or other visuals) are provided locally on computing device 1900. Computing device 1900 may receive inputs from the user via input interface 1910 and transmit those inputs to the remote server for processing and generating the corresponding displays. For example, computing device 1900 may transmit a communication to the remote server indicating that an up/down button was selected via input interface 1910. The remote server may process instructions in accordance with that input and generate a display of the application corresponding to the input (e.g., a display that moves a cursor up/down). The generated display is then transmitted to computing device 1900 for presentation to the user.

In some embodiments, the system or application may be downloaded and interpreted or otherwise run by an interpreter or virtual machine (run by control circuitry 1904). In some embodiments, system or application may be encoded in the ETV Binary Interchange Format (EBIF), received by control circuitry 1904 as part of a suitable feed, and interpreted by a user agent running on control circuitry 1904. For example, the system or application may be an EBIF application. In some embodiments, the system or application may be defined by a series of JAVA-based files that are received and run by a local virtual machine or other suitable middleware executed by control circuitry 1904. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

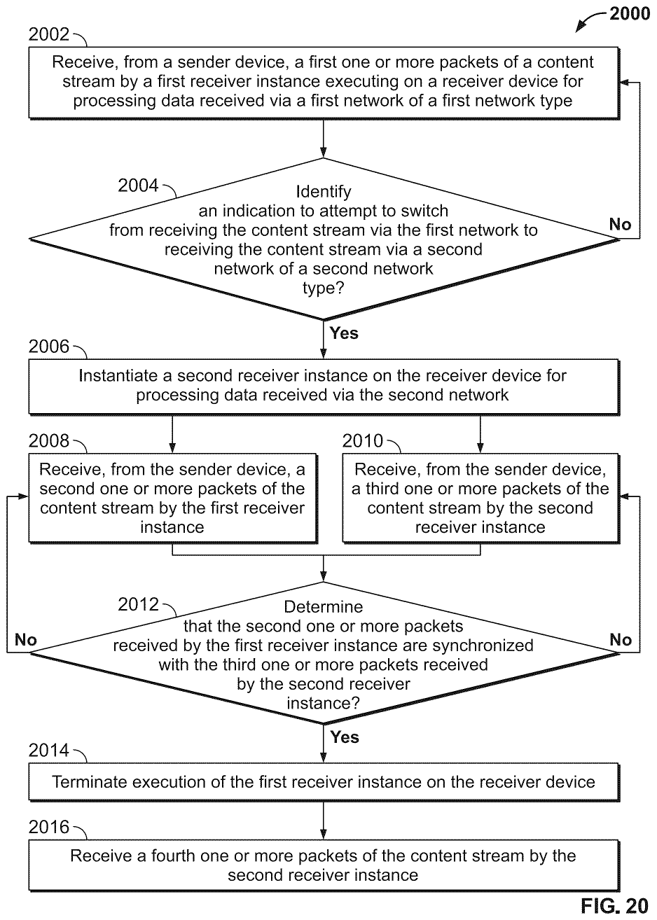

FIG. 20 is a flowchart of a detailed illustrative process for receiver-directed network switching with minimal packet loss, in accordance with some embodiments of this disclosure. In various embodiments, the individual steps of process 2000 are implemented by one or more components of the devices, methods, and systems of FIGS. 1-22 and are performed in combination with any of the other processes and aspects described herein. Although the present disclosure may describe certain steps of process 2000 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead. In some embodiments, the steps of process 2000 are implemented by any combination of the following: control circuitry (e.g., control circuitry 1811 of FIG. 18, control circuitry 1904 of FIG. 19) of a receiver device (e.g., client device 102 of FIG. 1, client device 302 and 303 of FIGS. 3A-3B, computing devices 1807, 1808, and 1810 of FIG. 18, computing devices 1900 and 1901 of FIG. 19); control circuitry of a sender device (e.g., server device 100 of FIG. 1, server device 300 of FIGS. 3A-3B, computing devices 1807, 1808, and 1810 of FIG. 18, computing devices 1900 and 1901 of FIG. 19); I/O circuitry (e.g., of I/O path 1812 of FIG. 18, of I/O path 1902 of FIG. 19) of a receiver device; I/O circuitry of a sender device; or the like.

At step 2002, I/O circuitry of a receiver device receives, from I/O circuitry of a sender device a first one or more packets (e.g., data packet 1 108 of FIG. 1, data packet 1 208 of FIG. 2) of a content stream by a first receiver instance (e.g., receiver instance 110 of FIG. 1, receiver instance 210 of FIG. 2) executing on the receiver device for processing data received via a first network (e.g., communication network 1809 of FIG. 18) of a first network type. For example, the first network type corresponds to any one of. Wi-Fi network types (e.g., associated with Wi-Fi network 104 of FIGS. 1 and 204 of FIG. 2); cellular network types (e.g., associated with cellular network 106 of FIGS. 1 and 204 of FIG. 2); wired and/or wireless fixed line network types; combinations of the same; or the like. The process 2000 proceeds to decision block 2004.

At decision block 2004, if the control circuitry of the receiver device identifies an indication to attempt to switch from receiving the content stream via the first network to receiving the content stream via a second network of a second network type, the process 2000 proceeds to step 2006. For example, the second network type corresponds to any one of: Wi-Fi network types (e.g., associated with Wi-Fi network 104 of FIGS. 1 and 204 of FIG. 2); cellular network types (e.g., associated with cellular network 106 of FIGS. 1 and 204 of FIG. 2); wired and/or wireless fixed line network types; combinations of the same; or the like. At decision block 2004, if the control circuitry of the receiver device does not identify an indication to attempt to switch from receiving the content stream via the first network to receiving the content stream via the second network of the second network type, the process 2000 returns to step 2002.

At step 2006 (e.g., based at least in part on the identifying the indication), the control circuitry of the receiver device instantiates a second receiver instance (e.g., receiver instance 112 of FIG. 1, receiver instance 212 of FIG. 2) on the receiver device for processing data received via the second network. The process 2000 proceeds to steps 2008 and 2010.

At step 2008, the I/O circuitry of the receiver device receives, from the I/O circuitry of the sender device, a second one or more packets (e.g., data packet 3 122 of FIG. 1, data packet 3 222 of FIG. 2) of the content stream by the first receiver instance. The process 2000 proceeds to decision block 2012.

At step 2010, the I/O circuitry of the receiver device receives, from the I/O circuitry of the sender device, a third one or more packets (e.g., data packet 2 120 of FIG. 1, data packet 2 220 of FIG. 2) of the content stream by the second receiver instance. In some embodiments, the second one or more packets and the third one or more packets represent the same data of a portion of the content stream. The process 2000 proceeds to decision block 2012.

At decision block 2012, if the control circuitry of the receiver device determines that the second one or more packets received by the first receiver instance are synchronized with the third one or more packets received by the second receiver instance, the process 200 proceeds to step 2014: At decision block 2012, if the control circuitry of the receiver device does not determine that the second one or more packets received by the first receiver instance are synchronized with the third one or more packets received by the second receiver instance, the process 200 returns to steps 2008 and 2010:

At step 2014, (e.g., based on the determining) the control circuitry of the receiver device terminates execution of the first receiver instance on the receiver device.

At step 2016, the I/O circuitry of the receiver device receives, from the I/O circuitry of the sender device, a fourth one or more packets (e.g., data packet 4 124 of FIG. 1, data packet 4 224 of FIG. 2) of the content stream by the second receiver instance.

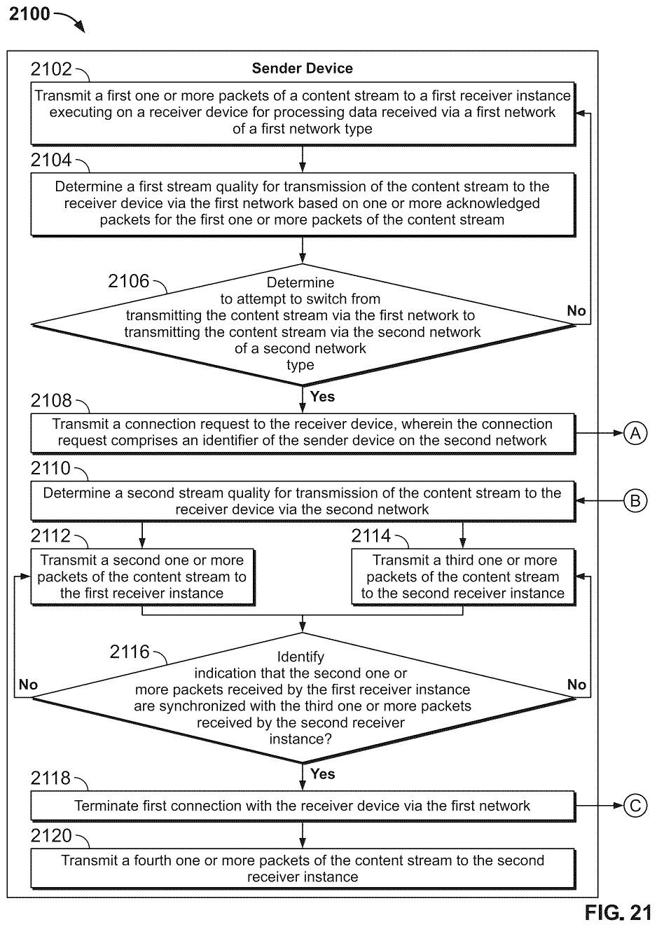

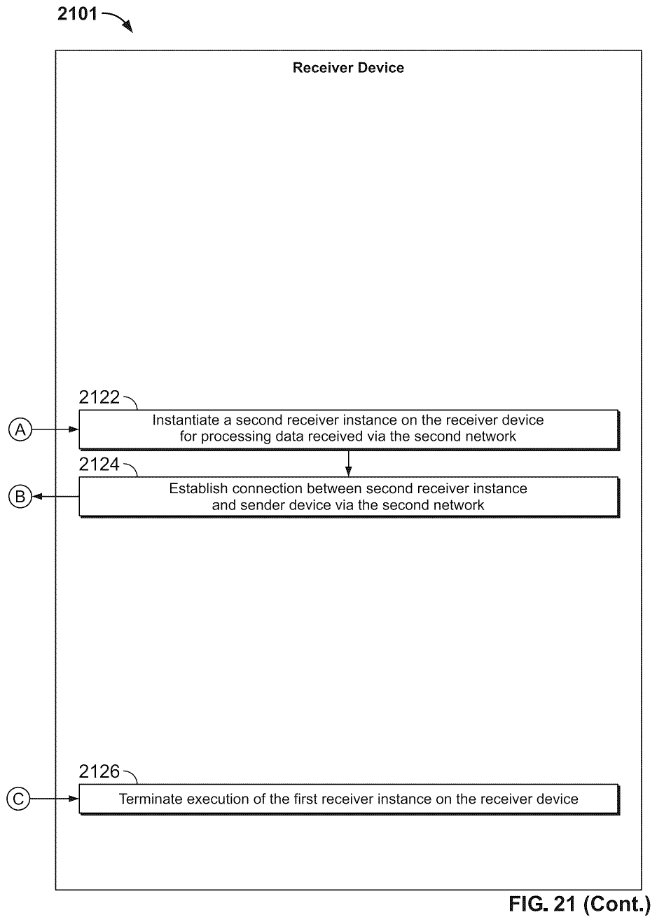

FIG. 21 is a flowchart of a detailed illustrative process for sender-directed network switching with minimal packet loss, in accordance with some embodiments of this disclosure. In various embodiments, the individual steps of processes 2100 and 2101 are implemented by one or more components of the devices, methods, and systems of FIGS. 1-22 and are performed in combination with any of the other processes and aspects described herein. Although the present disclosure may describe certain steps of processes 2100 and 2101 (and of other processes described herein) as being implemented by certain components of the devices, methods, and systems of FIGS. 1-22, this is for purposes of illustration only, and it should be understood that other components of the devices, methods, and systems of FIGS. 1-22 may implement those steps instead. In some embodiments, the steps of process 2100 are implemented by any combination of the following: control circuitry (e.g., control circuitry 1811 of FIG. 18, control circuitry 1904 of FIG. 19) of a receiver device (e.g., server device 202 of FIG. 2, server device 402 of FIGS. 4A-4B, computing devices 1807, 1808, and 1810 of FIG. 18, computing devices 1900 and 1901 of FIG. 19); control circuitry of a sender device (e.g., client device 200 of FIG. 2, client device 400 and 401 of FIGS. 4A-4B, computing devices 1807, 1808, and 1810 of FIG. 18, computing devices 1900 and 1901 of FIG. 19); I/O circuitry (e.g., of I/O path 1812 of FIG. 18, of I/O path 1902 of FIG. 19) of a receiver device; I/O circuitry of a sender device; or the like.

At step 2102, the I/O circuitry of the sender device transmits a first one or more packets (e.g., data packet 1 108 of FIG. 1, data packet 1 208 of FIG. 2) of a content stream via a first connection to a first receiver instance (e.g., receiver instance 110 of FIG. 1, receiver instance 210 of FIG. 2) executing on (e.g., I/O circuitry and/or control circuitry of) a receiver device for processing data received via a first network (e.g., communication network 1809 of FIG. 18) of a first network type. For example, the first network type corresponds to any one of: Wi-Fi network types (e.g., associated with Wi-Fi network 104 of FIGS. 1 and 204 of FIG. 2); cellular network types (e.g., associated with cellular network 106 of FIGS. 1 and 204 of FIG. 2); wired and/or wireless fixed line network types; combinations of the same; or the like.

At step 2102, the control circuitry of the sender device determines a first stream quality (e.g., stream quality 116 of FIG. 1, stream quality 216 of FIG. 2) for transmission of the content stream to the receiver device via the first network based on one or more acknowledged packets (e.g., RTCP packets) for the first one or more packets of the content stream. The process 2100 proceeds to decision block 2106.

At decision block 2106, if the control circuitry of the sender device determines to attempt to switch from transmitting the content stream via the first network to transmitting the content stream via a second network of a second network type, the process 2100 proceeds to step 2108. At decision block 2106, if the control circuitry of the sender device determines not to attempt to switch from transmitting the content stream via the first network to transmitting the content stream via a second network of a second network type, the process 2100 returns to step 2102.

At step 2108, (e.g., based on the determining) the I/O circuitry of the sender device transmits a connection request to (e.g., I/O circuitry of) the receiver device. In some embodiments, the connection request comprises an identifier of the sender device on the second network. In some embodiments, the step 2108 of receiver process 2100 triggers step 2122 of receiver device process 2101.

At step 2122 (e.g., of receiver device process 2101), the control circuitry of the receiver device instantiates (e.g., based at least in part on the connection request) a second receiver instance on the receiver device for processing data received via the second network.

At step 2124, the control circuitry of the receiver device establishes a second connection between the second receiver instance and the sender device via the second network (e.g., based on the identifier). In some embodiments, step 2124 of receiver device process 2101 triggers step 2110 of sender device process 2100.

At step 2110, the control circuitry of the sender device determines a second stream quality (e.g., stream quality 114 of FIG. 1, stream quality 214 of FIG. 2) for transmission of the content stream to the receiver device via the second network. The process 2100 proceeds to steps 2112 and 2114.

At step 2112, the I/O circuitry of the sender device transmits to the (e.g., I/O circuitry of the) receiver device a second one or more packets (e.g., data packet 3 122 of FIG. 1, data packet 3 222 of FIG. 2) of the content stream to the first receiver instance

At step 2114, the I/O circuitry of the sender device transmits a third one or more packets (e.g., data packet 2 120 of FIG. 1, data packet 2 220 of FIG. 2) of the content stream to the second receiver instance (e.g., operating on I/O circuitry and/or control circuitry of the receiver device). In some embodiments, the second one or more packets and the third one or more packets represent the same data of a portion of the content stream. In some embodiments, the second one or more packets of the content stream and the third one or more packets of the content stream are transmitted by the I/O circuitry of the sender device in a lower of the first stream quality and the second stream quality (e.g., stream quality 118 of FIG. 1, stream quality 218 of FIG. 2). The process 2100 proceeds to decision block 2116.

At decision block 2116, if the control circuitry and/or I/O circuitry of the sender device identifies an indication that the second one or more packets received by the first receiver instance are synchronized with the third one or more packets received by the second receiver instance, the process proceeds to step 2118. At decision block 2116, if the control circuitry and/or I/O circuitry of the sender device does not identify an indication that the second one or more packets received by the first receiver instance are synchronized with the third one or more packets received by the second receiver instance, the process returns to steps 2112 and 2114.

At step 2118, (e.g., based on the identifying) the control circuitry and/or I/O circuitry of the sender device terminates the first connection with the (e.g., control circuitry and/or I/O circuitry of the) receiver device via the first network. The process 2100 proceeds to step 2120, and, in some embodiments, step 2118 of sender device process 2100 triggers step 2126 of receiver device process 2101.

At step 2126, the control circuitry of the receiver device terminates execution of the first receiver instance on the receiver device.

At step 2120, the I/O circuitry of the sender device transmits a fourth one or more packets (e.g., data packet 4 124 of FIG. 1, data packet 4 224 of FIG. 2) of the content stream to the second receiver instance (e.g., operating on control circuitry and/or I/O circuitry of the receiver device).

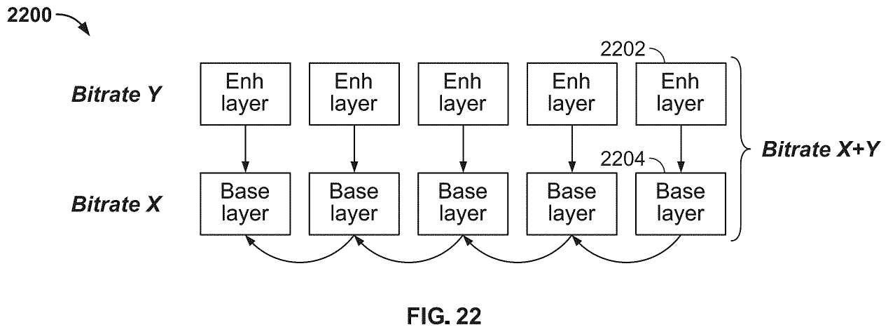

FIG. 22 is a schematic example of using scalable encoding to accommodate transitions between networks, in accordance with some embodiments of this disclosure.

As shown in FIG. 22, in some embodiments, a sender device transitions from transmitting content over one network to another and changes a bitrate at which the content is being transmitted. In some embodiments, the encoding and/or decoding system 2200 of the sender and/or receiver device includes multiple layers. For example, a first layer 2204 is a base layer and corresponds to a bitrate X, which is the lower bitrate (e.g., common denominator bitrate) of the two connections (e.g., bitrate of Wi-Fi network 116 and 216 of FIGS. 1-2). Further, for example, one of the connections supports a bitrate of X+Y, where Y is the difference between the higher bitrate of the two connections (e.g., bitrate of cellular network 114 and 214 of FIGS. 1-2) and the base layer bitrate X. Moreover, for example, a second layer 2202 is an enhancement layer and corresponds to a bitrate Y. In some embodiments, encoding the content with both the enhancement layer and the base layer results in a bitrate of X+Y. In some embodiments, if the sender device determines to transition from the higher bitrate (e.g., X+Y) to the lower bitrate (e.g., X), the encoder may choose to drop the enhancement layer (e.g., with bitrate Y) and encode only the base layer (e.g., with bitrate X). In some embodiments, the enhancement layer encoding does not affect or change the base layer encoding. For example, a receiver device equipped with the multilayer encoding and/or decoding system 2200 successfully decodes packets of both the base layer and the enhancement layer. Further, for example, a receiver device not equipped with the multilayer encoding and/or decoding successfully decodes packets of only the base layer.

In some embodiments, the multilayer encoding and/or decoding system 2200 enables support for transitioning between different resolutions without requiring an IDR frame. In one example, the multilayer encoding and/or decoding system 2200 supports different bitrates at multiple (e.g., two) different resolutions without requiring an IDR frame. In some embodiments, the transition (e.g., dropping the enhancement layer) is performed at any time. In some embodiments, the enhancement layer is introduced at any time. In some embodiments, the bitrates X and Y are adjusted based on updated estimates of network bandwidths. In one example, the network determines a lower stream bitrate of two networks and determines to move from a higher quality encoding (e.g., cellular network quality 114 and 1164 of FIGS. 1-2) to a lower quality encoding (e.g., lowest stream quality 118 and 218 of FIGS. 1-2). In this example, the sender device may determine the higher quality encoding may correspond to encoding with both an enhancement layer 2202 and base layer 2200 while the lower quality encoding may correspond to encoding the packets with only the base layer 2200. In some embodiments, transmitting data packets (e.g., data packets 120, 122, 220, and 222 of FIGS. 1-2) with the lower stream quality includes encoding with a base layer 2204 and determining whether to additionally encode with an enhancement layer 2202.

1. A method comprising:
receiving, from a sender device, a first one or more packets of a content stream by a first receiver instance executing on a receiver device for processing data received via a first network of a first network type;
identifying an indication to attempt to switch from receiving the content stream via the first network to receiving the content stream via a second network of a second network type;
based at least in part on the identifying the indication:
instantiating a second receiver instance on the receiver device for processing data received via the second network;
receiving, from the sender device:
a second one or more packets of the content stream by the first receiver instance;
a third one or more packets of the content stream by the second receiver instance, wherein the second one or more packets and the third one or more packets represent the same data of a portion of the content stream;
based at least in part on determining that the second one or more packets received by the first receiver instance are synchronized with the third one or more packets received by the second receiver instance:
terminating execution of the first receiver instance on the receiver device; and
receiving a fourth one or more packets of the content stream by the second receiver instance.

2. The method of claim 1, wherein the sender device is configured to:
determine a first stream quality for transmission of the content stream to the receiver device via the first network;
determine a second stream quality for transmission of the content stream to the receiver device via the second network; and
transmit the second one or more packets of the content stream and the third one or more packets of the content stream in a lower of the first stream quality and the second stream quality.

3. The method of claim 1, wherein the identifying the indication to attempt to switch from receiving the content stream via the first network to receiving the content stream via the second network is based at least in part on at least one of:
detecting that a transmission quality of the first network has decreased;
identifying that a status of the first one or more packets indicates a late arrival;
identifying one or more dropped packets of the content stream; or
analyzing at least one of jitter, bandwidth, or latency of the first one or more packets.

4. The method of claim 1, wherein the sender device is further configured to determine the second one or more packets and the third one or more packets by:
identifying one or more real-time protocol transport (RTP) packets of the content stream from a RTP packet priority queue;
wrapping each of the one or more RTP packets in a first user datagram protocol (UDP) wrapper to generate the second one or more packets; and
wrapping each of the one or more RTP packets in a second UDP wrapper to generate the third one or more packets.

5. The method of claim 1, wherein the sender device is further configured to:
store a first real time transport control protocol (RTCP) packet received via the first network in a first data store on the sender device;
identify a connection with the receiver device via the second network;
based at least in part on the identifying, instantiate a second data store on the sender device; and
store a second RTCP packet received via the second network in the second data store.

6. The method of claim 5, wherein the sender device is further configured to:
identify that the connection with the receiver device via the first network has been terminated; and
based at least in part on the identifying, terminate the first data store on the sender device.

7. The method of claim 1, wherein:
the first receiver instance comprises a first packet buffer;
the second receiver instance comprises a second packet buffer; and
determining that the second one or more packets received by the first receiver instance are synchronized with the third one or more packets received by the second receiver instance comprises:
identifying that the second one or more packets has been received at the first packet buffer at a first time of arrival;
identifying that the third one or more packets has been received at the second packet buffer at a second time of arrival; and
determining that the second one or more packets received by the first receiver instance are synchronized with the third one or more packets received by the second receiver instance based at least in part on analyzing both the first time of arrival and the second time of arrival.

8. The method of claim 2, wherein:
the second one or more packets and the third one or more packets comprise data encoded by an encoder associated with the sender device based on the data of the portion of the content stream; and
the method further comprises decoding either the second one or more packets or the third one or more packets via a decoder of the receiver device based at least in part on an order in which the second one or more packets and the third one or more packets were received by the receiver device.

9. The method of claim 8, wherein the sender device is configured to transmit the second one or more packets of the content stream and the third one or more packets of the content stream in the lower of the first stream quality and the second stream quality by at least one of:
refraining from transmitting a first enhancement layer data for the portion of the content stream via the first network; or
refraining from transmitting a second enhancement layer data for the portion of the content stream via the second network.

10. The method of claim 1, wherein the first network type is a Wi-Fi network type, and the second network type is a cellular network type.

11. The method of claim 1, wherein the sender device is further configured to encode the data for the second one or more packets of the content stream and the third one or more packets of the content stream by resampling at least one of reference pictures of the content stream or non-reference pictures of the content stream.

12. A system comprising:
input/output circuitry, wherein the input/output circuitry is configured to:
receive, from a sender device, a first one or more packets of a content stream by a first receiver instance executing on a receiver device for processing data received via a first network of a first network type; and
control circuitry, wherein the control circuitry is configured to:
identify an indication to attempt to switch from receiving the content stream via the first network to receiving the content stream via a second network of a second network type;
based at least in part on the identifying the indication:
instantiate a second receiver instance on the receiver device for processing data received via the second network; and
wherein the input/output circuitry is further configured to:
receive, from the sender device:
a second one or more packets of the content stream by the first receiver instance;
a third one or more packets of the content stream by the second receiver instance, wherein the second one or more packets and the third one or more packets represent the same data of a portion of the content stream; and
wherein the control circuitry is further configured to:
based at least in part on determining that the second one or more packets received by the first receiver instance are synchronized with the third one or more packets received by the second receiver instance:
terminate execution of the first receiver instance on the receiver device; and
wherein the input/output circuitry is further configured to:
receive a fourth one or more packets of the content stream by the second receiver instance.

13. The system of claim 12, wherein:
the control circuitry at the sender device is configured to:
determine a first stream quality for transmission of the content stream to the receiver device via the first network;
determine a second stream quality for transmission of the content stream to the receiver device via the second network; and
the input/output circuitry at the sender device is configured to:
transmit the second one or more packets of the content stream and the third one or more packets of the content stream in a lower of the first stream quality and the second stream quality.

14. The system of claim 12, wherein the control circuitry is configured to identify the indication to attempt to switch from receiving the content stream via the first network to receiving the content stream via the second network based at least in part on at least one of:
detecting that a transmission quality of the first network has decreased;
identifying that a status of the first one or more packets indicates a late arrival;
identifying one or more dropped packets of the content stream; or
analyzing at least one of jitter, bandwidth, or latency of the first one or more packets.

15. The system of claim 12, wherein the control circuitry at the sender device is further configured to determine the second one or more packets and the third one or more packets by:
identifying one or more real-time protocol transport (RTP) packets of the content stream from a RTP packet priority queue;
wrapping each of the one or more RTP packets in a first user datagram protocol (UDP) wrapper to generate the second one or more packets; and
wrapping each of the one or more RTP packets in a second UDP wrapper to generate the third one or more packets.

16. The system of claim 12, wherein the control circuitry at the sender device is further configured to:
store a first real time transport control protocol (RTCP) packet received via the first network in a first data store on the sender device;
identify a connection with the receiver device via the second network;
based at least in part on the identifying, instantiate a second data store on the sender device; and
store a second RTCP packet received via the second network in the second data store.

17. The system of claim 16, wherein the control circuitry at the sender device is further configured to:
identify that the connection with the receiver device via the first network has been terminated; and
based at least in part on the identifying, terminate the first data store on the sender device.

18. The system of claim 12, wherein:
the first receiver instance comprises a first packet buffer;
the second receiver instance comprises a second packet buffer; and
the control circuitry is configured to determine that the second one or more packets received by the first receiver instance are synchronized with the third one or more packets received by the second receiver instance by:
identifying that the second one or more packets has been received at the first packet buffer at a first time of arrival;
identifying that the third one or more packets has been received at the second packet buffer at a second time of arrival; and
determining that the second one or more packets received by the first receiver instance are synchronized with the third one or more packets received by the second receiver instance based at least in part on analyzing both the first time of arrival and the second time of arrival.

19. The system of claim 13, wherein:
the second one or more packets and the third one or more packets comprise data encoded by an encoder associated with the sender device based on the data of the portion of the content stream; and
the control circuitry is further configured to decode either the second one or more packets or the third one or more packets via a decoder of the receiver device based at least in part on an order in which the second one or more packets and the third one or more packets were received by the receiver device.

20. The system of claim 19, wherein the input/output circuitry at the sender device is configured to transmit the second one or more packets of the content stream and the third one or more packets of the content stream in the lower of the first stream quality and the second stream quality by at least one of:
refraining from transmitting a first enhancement layer data for the portion of the content stream via the first network; or
refraining from transmitting a second enhancement layer data for the portion of the content stream via the second network.

21-55. (canceled)
